(19) United States
(12) Patent Application Publication
(10) Pub. No.: US 2025/0256816 A1
(43) Pub. Date: Aug. 14, 2025

(54) ROLL STABILIZATION AND RELATED APPARATUSES

(71) Applicant: Dometic Marine Canada Inc., Richmond (CA)

(72) Inventors: Derry William LAPPIN, Vancouver (CA); Mark Isaac Dyck, Delta (CA); Trevor Daniel Boleac, Langley (CA); Noam Dean Davidson, Vancouver (CA); Kevin Sean Stopp, Richmond (CA); Mackenzie Douglas Hart, Vancouver (CA); Ray Tat Lung Wong, Richmond (CA)

(21) Appl. No.: 19/052,196

(22) Filed: Feb. 12, 2025

Related U.S. Application Data
(63) Continuation-in-part of application No. 18/680,517, filed on May 31, 2024.
Application No. 18/680,517 is a continuation-in-part of application No. 18/713,331, filed on May 24, 2024.
(60) Provisional application No. 63/283,181, filed on Nov. 24, 2021.

(51) Int. Cl. B63B 39/04; F16C 35/04; F16F 15/00; F16F 15/30; F16F 15/31; F16F 15/315; H02K 7/02

(52) U.S. Cl. CPC B63B 39/04; F16C 35/04; F16F 15/002; F16F 15/302; F16F 15/31; F16F 15/3156; H02K 7/02; F16C 2361/55; F16F 2222/08; F16F 2230/0005; F16F 2230/08; F16F 2230/10; F16F 2230/18; F16F 2230/22; F16F 2230/30; F16F 2232/02; F16F 2236/08

(57) ABSTRACT

This disclosure relates generally to roll stabilization and related apparatuses.

### CROSS-REFERENCE TO RELATED APPLICATION

This application is a continuation-in-part of U.S. patent application Ser. No. 18/680,517 filed May 31, 2024, which is a continuation-in-part of U.S. patent application Ser. No. 18/713,331 filed May 24, 2024, which is the United States national stage of PCT international patent application no. PCT/CA2022/051725 filed Nov. 23, 2022, which claims the benefit of, and priority to, U.S. provisional patent application No. 63/283,181 filed Nov. 24, 2021. The entire contents of U.S. provisional patent application No. 63/283,181, of PCT international patent application no. PCT/CA2022/051725, and of U.S. patent application Ser. No. 18/680,517 are incorporated by reference herein.

### FIELD

This disclosure relates generally to roll stabilization and related apparatuses.

### RELATED ART

A marine vessel may include a roll-stabilization apparatus. However, some known roll-stabilization apparatuses have some disadvantages.

### SUMMARY

According to at least one embodiment, a roll-stabilizer apparatus comprises: a flywheel-support body comprising a rotation-support body; a flywheel body surrounding at least a portion of the rotation-support body, wherein the rotation-support body supports the flywheel body for rotation relative to the flywheel-support body around at least one axis of rotation comprising a spin axis of rotation of the flywheel body and a central-rotation axis of the flywheel-support body; and a mounting body supporting the flywheel-support body and permitting rotation of the flywheel-support body relative to the mounting body around a precession axis non-parallel to the at least one axis of rotation.

According to at least one embodiment, a roll-stabilizer apparatus comprises: a flywheel body having a spin axis of rotation; a flywheel-support body having a central-rotation axis and comprising at least one magnetic bearing operable to support the flywheel body, the flywheel-support body permitting rotation of the flywheel body relative to the flywheel-support body around the spin axis of rotation at least when the spin axis of rotation is colinear with the central-rotation axis of the flywheel-support body; and a mounting body supporting the flywheel-support body and permitting rotation of the flywheel-support body relative to the mounting body around a precession axis non-parallel to the central-rotation axis of the flywheel-support body.

According to at least one embodiment, a roll-stabilizer apparatus comprises: a flywheel body; a flywheel-support body supporting the flywheel body and permitting rotation of the flywheel body relative to the flywheel-support body around at least one axis of rotation comprising a spin axis of rotation of the flywheel body and a central-rotation axis of the flywheel-support body; a mounting body supporting the flywheel-support body and permitting rotation of the flywheel-support body relative to the mounting body around a precession axis non-parallel to the at least one axis of rotation; and at least one precession-control device operable to control rotation of the flywheel-support body relative to the mounting body. The at least one precession-control device comprises: at least one actuator rotatably attached to the mounting body; and a first force-transfer body and a second force-transfer body, the first force-transfer body rotatably attached to each of the flywheel-support body, the at least one actuator, and the second force-transfer body, and the second force-transfer body further rotatably attached to the mounting body. The first force-transfer body is operable to transfer force at least between the at least one actuator and the flywheel-support body.

According to at least one embodiment, a roll-stabilizer apparatus comprises: a flywheel body; a flywheel-support body supporting the flywheel body and permitting rotation of the flywheel body relative to the flywheel-support body around at least one axis of rotation comprising a spin axis of rotation of the flywheel body and a central-rotation axis of the flywheel-support body; a mounting body supporting the flywheel-support body and permitting rotation of the flywheel-support body relative to the mounting body around a precession axis non-parallel to the at least one axis of rotation; and at least one precession-control device operable to control rotation of the flywheel-support body relative to the mounting body. The at least one precession-control device comprises: at least one actuator rotatably attached to the mounting body; and a first force-transfer body and a second force-transfer body, the first force-transfer body rotatably attached each of the mounting body, the at least one actuator, and the second force-transfer body, and the second force-transfer body further rotatably attached to the flywheel-support body. The first force-transfer body and the second force-transfer body are operable to transfer force at least between the at least one actuator and the flywheel-support body.

According to at least one embodiment, a roll-stabilizer apparatus comprises: a flywheel body; a flywheel-support body supporting the flywheel body and permitting rotation of the flywheel body relative to the flywheel-support body around at least one axis of rotation comprising a spin axis of rotation of the flywheel body and a central-rotation axis of the flywheel-support body; a mounting body supporting the flywheel-support body and permitting rotation of the flywheel-support body relative to the mounting body around a precession axis non-parallel to the at least one axis of rotation; at least one precession bearing operable to support the flywheel-support body for rotation relative to the mounting body around the precession axis; and at least one precession-control device operable to control rotation of the flywheel-support body relative to the mounting body and operable to apply a force at least partly overlapping a dimension of the at least one precession bearing along the precession axis.

According to at least one embodiment, a roll-stabilizer apparatus comprises: a flywheel body; a flywheel-support body supporting the flywheel body and permitting rotation of the flywheel body relative to the flywheel-support body around at least one axis of rotation comprising a spin axis of rotation of the flywheel body and a central-rotation axis of the flywheel-support body; a mounting body supporting the flywheel-support body and permitting rotation of the flywheel-support body relative to the mounting body around a precession axis non-parallel to the at least one axis of rotation; and at least one precession bearing operable to support the flywheel-support body for rotation relative to the mounting body around the precession axis, the at least one precession bearing comprising an outer precession body surrounding an inner precession body, the outer precession body rotatable relative to the inner precession body and relative to the mounting body.

According to at least one embodiment, a flywheel apparatus comprises a flywheel body rotatable around a spin axis of rotation and comprises a peripheral surface spaced apart from the spin axis of rotation, wherein the flywheel body defines a groove recessed in the peripheral surface.

According to at least one embodiment, a flywheel apparatus comprises a flywheel body rotatable around a central-rotation axis of the flywheel body, the flywheel body comprising: a central portion; a wheel portion spaced apart from the central portion radially relative to the central-rotation axis of the flywheel body; and at least one radial portion coupling the wheel portion to the central portion; wherein the wheel portion has a maximum radial thickness relative to the central-rotation axis of the flywheel body, the wheel portion extends to a maximum radius from the central-rotation axis of the flywheel body, and a ratio of the maximum radial thickness to the maximum radius is less than 0.27.

According to at least one embodiment, a flywheel apparatus comprises a flywheel body rotatable around a central-rotation axis of the flywheel body, the flywheel body comprising: a central portion; a wheel portion spaced apart from the central portion radially relative to the central-rotation axis of the flywheel body; and at least one radial portion coupling the wheel portion to the central portion; wherein the wheel portion has a maximum radial thickness relative to the central-rotation axis of the flywheel body and a maximum height along the central-rotation axis of the flywheel body, and a ratio of the maximum radial thickness to the maximum height is less than 0.23.

According to at least one embodiment, an axial-magnetic-bearing apparatus comprises: an annular bearing body; and a plurality of electromagnets, each one of the plurality of electromagnets comprising a respective different electrical conductor, each one of the plurality of electromagnets positioned on the annular bearing body in a respective different annular sector of a plurality of annular sectors of the annular bearing body, the plurality of annular sectors surrounding a central-rotation axis of the annular bearing body. The electrical conductor of each one of the plurality of electromagnets extends transversely to the central-rotation axis of the annular bearing body such that each one of the plurality of electromagnets becomes magnetized in a direction along the central-rotation axis of the annular bearing body in response to, at least, an electrical current through the electrical conductor.

According to at least one embodiment, a roll-stabilizer controller apparatus is programmed to, at least, cause at least one precession-control device to apply a torque to a flywheel-support body relative to a mounting body, the flywheel-support body supporting a flywheel body and permitting rotation of the flywheel body relative to the flywheel-support body around at least one axis of rotation comprising a spin axis of rotation of the flywheel body and a central-rotation axis of the flywheel-support body.

According to at least one embodiment, a roll-stabilizer apparatus comprises: a flywheel body; a flywheel-support body supporting the flywheel body and permitting rotation of the flywheel body relative to the flywheel-support body around at least one axis of rotation comprising a spin axis of rotation of the flywheel body and a central-rotation axis of the flywheel-support body; a mounting body supporting the flywheel-support body and permitting rotation of the flywheel-support body relative to the mounting body around a precession axis non-parallel to the at least one axis of rotation; at least one precession-control device operable to control rotation of the flywheel-support body relative to the mounting body; and a roll-stabilizer controller programmed to, at least, cause the at least one precession-control device to apply the torque to the flywheel-support body relative to the mounting body.

According to at least one embodiment, a marine vessel comprises: at least one hull; and the apparatus, wherein the mounting body is attached to the at least one hull.

According to at least one embodiment, there is described a roll-stabilizer apparatus comprising: a flywheel body; a flywheel-support body supporting the flywheel body and permitting rotation of the flywheel body relative to the flywheel-support body around at least one axis of rotation comprising a spin axis of rotation of the flywheel body and a central-rotation axis of the flywheel-support body; a mounting body supporting the flywheel-support body and permitting rotation of the flywheel-support body relative to the mounting body around a precession axis non-parallel to the at least one axis of rotation; and one or more mounting feet removably attached to the mounting body, the one or more mounting feet operable to mount the mounting body to a vessel.

According to at least one embodiment, there is described a roll-stabilizer apparatus comprising: a flywheel body; a flywheel-support body supporting the flywheel body and permitting rotation of the flywheel body relative to the flywheel-support body around at least one axis of rotation comprising a spin axis of rotation of the flywheel body and a central-rotation axis of the flywheel-support body; a mounting body supporting the flywheel-support body and permitting rotation of the flywheel-support body relative to the mounting body around a precession axis non-parallel to the at least one axis of rotation; and an outer housing attached to the mounting body, the outer housing surrounding at least a portion of the flywheel-support body and permitting rotation of the flywheel-support body relative to the mounting body around the precession axis.

According to at least one embodiment, there is described a roll-stabilizer apparatus comprising: a flywheel body; a flywheel-support body supporting the flywheel body and permitting rotation of the flywheel body relative to the flywheel-support body around at least one axis of rotation comprising a spin axis of rotation of the flywheel body and a central-rotation axis of the flywheel-support body; a mounting body supporting the flywheel-support body and permitting rotation of the flywheel-support body relative to the mounting body around a precession axis non-parallel to the at least one axis of rotation; at least one precession-control device operable to control rotation of the flywheel-support body relative to the mounting body, the at least one precession-control device comprising at least one bearing.

According to at least one embodiment, there is described a roll-stabilizer apparatus comprising: a flywheel body; a flywheel-support body supporting the flywheel body and permitting rotation of the flywheel body relative to the flywheel-support body around at least one axis of rotation comprising a spin axis of rotation of the flywheel body and a central-rotation axis of the flywheel-support body, the flywheel-support body defining at least one flywheel-support-body fluid channel comprising a first flywheel-support-body opening and a second flywheel-support-body opening, the at least one flywheel-support-body fluid channel operable to convey a fluid through at least some of the flywheel-support body between the first flywheel-support-body opening and the second flywheel-support-body opening; and a mounting body supporting the flywheel-support body and permitting rotation of the flywheel-support body relative to the mounting body around a precession axis non-parallel to the at least one axis of rotation, the mounting body defining at least a first mounting-body fluid channel and a second mounting-body fluid channel, the first mounting-body fluid channel comprising a first mounting-body opening and a second mounting-body opening and operable to convey the fluid through at least some of the mounting body between the first mounting-body opening and the second mounting-body opening, the second mounting-body fluid channel comprising a third mounting-body opening and a fourth mounting-body opening and operable to convey the fluid through at least some of the mounting body between the third mounting-body opening and the fourth mounting-body opening; wherein the second mounting-body opening is in fluid communication with the first flywheel-support-body opening, and wherein the second flywheel-support-body opening is in fluid communication with the third mounting-body opening.

According to at least one embodiment, there is described a flywheel apparatus comprising: a flywheel body; a flywheel-support body supporting the flywheel body and permitting rotation of the flywheel body relative to the flywheel-support body around at least one axis of rotation comprising a spin axis of rotation of the flywheel body and a central-rotation axis of the flywheel-support body; at least one plurality of bearings operable to support the flywheel body for rotation relative to the flywheel-support body around the at least one axis of rotation; and at least one resilient body configured to resiliently urge together, along the central-rotation axis of the flywheel-support body, the individual bearings of the at least one plurality of bearings.

Other aspects and features will become apparent to those ordinarily skilled in the art upon review of the following description of illustrative embodiments in conjunction with the accompanying figures.

### BRIEF DESCRIPTION OF THE DRAWINGS

FIG. 1 is a schematic illustration of a marine vessel according to one embodiment.

FIG. 2 is a perspective view of a roll-stabilizer apparatus of a roll-stabilizer assembly of the marine vessel of FIG. 1.

FIG. 3 is a cross-sectional view of the roll-stabilizer apparatus of FIG. 2, taken along the line labeled FIG. 3 in FIG. 2.

FIG. 4 is a perspective view of a mounting body of the roll-stabilizer apparatus of FIG. 2.

FIG. 5 is an exploded perspective view of a flywheel assembly of the roll-stabilizer apparatus of FIG. 2.

FIG. 6 is a cross-sectional view of a flywheel body of the flywheel assembly of FIG. 5.

FIG. 7 is an exploded perspective view of a flywheel-support body of the roll-stabilizer apparatus of FIG. 2.

FIG. 8 is an exploded perspective view of a radial active magnetic bearing including a rotor of the flywheel assembly of FIG. 5 and a stator of the flywheel-support body of FIG. 7.

FIG. 9 is a cross-sectional view of the radial active magnetic bearing of FIG. 8, taken along the line labeled FIG. 9 in FIG. 10 and in FIG. 11.

FIG. 10 is another cross-sectional view of the radial active magnetic bearing of FIG. 8, taken along the line labeled FIG. 10 in FIG. 9.

FIG. 11 is another cross-sectional view of the radial active magnetic bearing of FIG. 8, taken along the line labeled FIG. 11 in FIG. 9.

FIG. 12 is a perspective view of an electric coil of the radial active magnetic bearing of FIG. 8.

FIG. 13 is an exploded perspective view of a radial active magnetic bearing according to another embodiment.

FIG. 14 is a cross-sectional view of the radial active magnetic bearing of FIG. 13, taken along the line labeled FIG. 14 in FIG. 15.

FIG. 15 is another cross-sectional view of the radial active magnetic bearing of FIG. 13, taken along the line labeled FIG. 15 in FIG. 14.

FIG. 16 is a perspective view of an annular-sector stator body of the radial active magnetic bearing of FIG. 13.

FIG. 17 is an exploded perspective view of an axial active magnetic bearing of the flywheel-support body of FIG. 7.

FIG. 18 is a plan view of an assembled annular-sector body of the axial active magnetic bearing of FIG. 17, including the annular-sector body of FIG. 19.

FIG. 19 is a cross-sectional view of the axial active magnetic bearing of FIG. 17, taken along the line labeled FIG. 19 in FIG. 17.

FIG. 20 is a perspective view of an annular-sector body of the axial active magnetic bearing of FIG. 17.

FIG. 21 is an enlarged fragmentary view of FIG. 19.

FIG. 22 is the fragmentary view of FIG. 21, with the axial active magnetic bearing of FIG. 17 positioned in a groove of the flywheel body of FIG. 6.

FIG. 23 illustrates an example of changes over time in magnetic field experienced by a point on the flywheel body of FIG. 6.

FIG. 24 illustrates use of negative stiffness according to one embodiment.

FIG. 25 is a perspective view of a roll-stabilizer apparatus according to another embodiment.

FIG. 26 is an exploded perspective view of the roll-stabilizer apparatus of FIG. 25.

FIG. 27 is a cross-sectional view of a flywheel body and a flywheel-support body of the roll-stabilizer apparatus of FIG. 25, taken along the line labelled FIG. 27 in FIG. 25.

FIG. 28 is an enlarged fragmentary view of a bearing of the flywheel-support body of FIG. 27.

FIG. 29 is a fragmentary perspective view of a housing body of the flywheel-support body of FIG. 27 and a precession bearing of the roll-stabilizer apparatus of FIG. 25.

FIG. 30 is an enlarged fragmentary view of a portion of the flywheel-support body of FIG. 27 and another precession bearing of the roll-stabilizer apparatus of FIG. 25.

FIG. 31 is an exploded perspective view of a precession-control device of the roll-stabilizer apparatus of FIG. 25.

FIG. 32 is an exploded perspective view of another precession-control device of the roll-stabilizer apparatus of FIG. 25.

FIG. 33 is a side view of the roll-stabilizer apparatus of FIG. 25 with the precession-control device of FIG. 32 in an intermediate position.

FIG. 34 is a side view of the roll-stabilizer apparatus of FIG. 25 with the precession-control device of FIG. 32 in an extended position.

FIG. 35 is a side view of the roll-stabilizer apparatus of FIG. 25 with the precession-control device of FIG. 32 in a contracted position.

FIG. 36 is a circuit diagram of a braking circuit for an electric motor/generator of the roll-stabilizer apparatus of FIG. 25.

FIG. 37 is a circuit diagram of a damping circuit for an actuator motor of the roll-stabilizer apparatus of FIG. 25.

FIG. 38 is a perspective view of a roll-stabilizer apparatus according to another embodiment.

FIG. 39 is an exploded perspective view of a precession-control device of the roll-stabilizer apparatus of FIG. 38.

FIG. 40 schematically illustrates an example of identifying dynamic vessel characteristics according to one embodiment.

FIG. 41 illustrates roll dynamic mobility of a marine vessel as a function of experienced torque frequency in one embodiment.

In FIG. 42 illustrates a phase difference between motion of a marine vessel and net torque applied to a marine vessel in one embodiment.

FIG. 43 illustrates schematically adjustment of phase of motion of a marine vessel according to at least one or more properties of the marine vessel in one embodiment.

FIG. 44 illustrates schematically estimation of wave torque according to one embodiment.

FIG. 45 illustrates schematically phase-corrected control according to one embodiment.

FIG. 46 illustrates implementation of phase-shift control to align anti-roll torque with wave torque in one embodiment.

FIGS. 47 and 48 illustrate a marine vessel including stabilizing fins according to one embodiment.

FIGS. 49 and 50 illustrate stabilization of roll of a marine vessel according to some embodiments.

FIGS. 51 and 52 illustrate examples of operation according to the example of FIG. 49.

FIG. 53 illustrates schematically a possible embodiment of roll stabilization using stabilizing fins.

FIGS. 54 and 55 are partial cross-sectional views of flywheel bodies according to some embodiments.

FIG. 56 is a perspective view of a roll-stabilizer assembly according to one embodiment.

FIG. 57 is a side view of a flywheel-support body and a portion of a mounting body according to one embodiment.

FIG. 58 is a front view of the flywheel-support body of FIG. 57.

FIG. 59 is a top view of the flywheel-support body and the mounting body of FIG. 57.

FIG. 60 illustrates a cooling system for a roll-stabilizer apparatus according to one embodiment.

FIGS. 61 and 62 are partial cross-sectional views of roll-stabilizer apparatuses according to other embodiments.

FIGS. 63 to 65 are cross-sectional views of rotation-support bodies according to different embodiments.

FIG. 66 is a partial cross-sectional view of a rotation-support body according to another embodiment.

FIG. 67 is a partial cross-sectional view of the rotation-support body of FIG. 63.

FIG. 68 is a perspective view of a compressible body of the rotation-support body of FIG. 67.

FIGS. 69 to 73 schematically illustrate power management according to some embodiments.

FIG. 74 illustrates stabilization of roll of a marine vessel according to one embodiment.

FIG. 75 illustrates marine vessel and wave angles according to one embodiment.

FIG. 76 illustrates stabilization of roll of a marine vessel according to one embodiment.

FIG. 77 is a cross-sectional view of a flywheel apparatus according to one embodiment.

FIG. 78 schematically illustrates the flywheel apparatus of FIG. 77.

FIG. 79 is a cross-sectional view of a flywheel apparatus according to another embodiment.

FIG. 80 is an exploded top view of a roll stabilizer apparatus according to one embodiment.

FIG. 81 is a perspective view of a flywheel-support body of the roll stabilizer apparatus of FIG. 80.

FIG. 82 is a perspective view of a mounting body of the roll stabilizer apparatus of FIG. 80.

FIG. 83 is cross-sectional top view of a portion of the roll stabilizer apparatus of FIG. 80.

FIG. 84 is a cross-sectional view of a precession linkage of a roll stabilizer apparatus according to one embodiment.

FIG. 85 is a side view of the precession linkage of FIG. 84.

FIG. 86 is a top view of a mounting body of a roll stabilizer apparatus according to one embodiment.

FIG. 87 is a top view of the mounting body of FIG. 86 with mounting feet in an alternative orientation.

FIG. 88 is a perspective view of a mounting foot of FIG. 86.

FIG. 89 is a top view of a mounting foot as installed to the mounting body of FIG. 86.

FIG. 90 is a top view of a mounting foot as installed to the mounting body of FIG. 87.

FIG. 91 is a perspective view of a roll-stabilizer apparatus according to one embodiment.

FIG. 92 is a cross-sectional view of tool-free mounting of the roll-stabilizer apparatus of FIG. 91.

FIG. 93 is a side view of the roll-stabilizer apparatus of FIG. 91.

FIG. 94 is a cross-sectional view of a retained fastener of the roll-stabilizer apparatus of FIG. 91.

### DETAILED DESCRIPTION

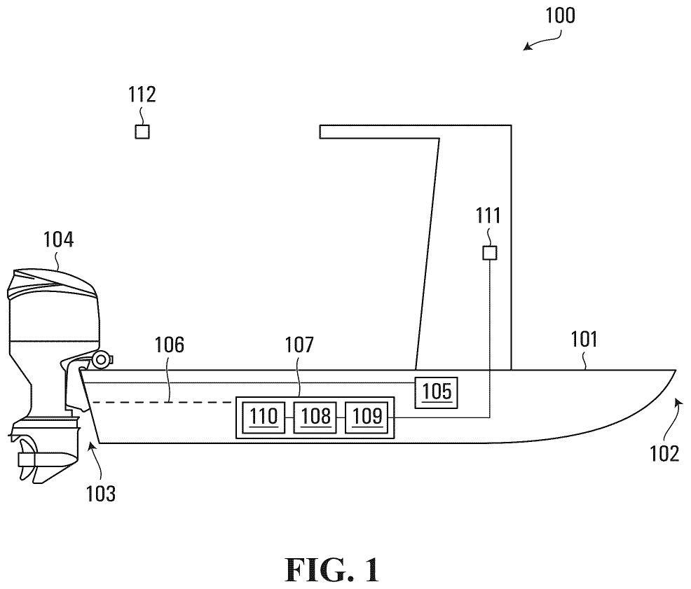

Referring to FIG. 1, a marine vessel according to one embodiment is shown generally at 100. The marine vessel 100 includes a hull 101 having a bow shown generally at 102. The hull 101 also has a stern shown generally at 103 and opposite the bow 102. At the stern 103, the marine vessel 100 includes a marine engine 104 operable to apply a thrust to the hull 101. The marine engine 104 in the embodiment shown is an outboard motor, but alternative embodiments may vary and may, for example, include one or more motors that may not necessarily be outboard motors. The marine vessel 100 also includes a main energy-storage device 105 that may be electrically connected to a starter motor of the marine engine 104 to power the starter motor, or that may be electrically connected to one or more other electrical devices of the marine vessel 100. The marine engine 104 may include an alternator to charge the main energy-storage device 105, or one or more other sources of electric current may charge the main energy-storage device 105. However, in alternative embodiments, the marine engine 104 may include an electric motor operable to apply a thrust to the hull 101, and the main energy-storage device 105 may be electrically connected to the electric motor to power the electric motor.

Herein, “electrically connected” may refer to any direct or indirect connection that permits a transfer of electrical energy, such as a direct electrical connection or an electrical connection involving inductive power transfer or other wired or wireless energy transfer, for example.

Also herein, “energy-storage device” may refer to one or more electrochemical cells, one or more batteries, one or more fuel cells, or one or more other devices operable to store electrical energy or other energy as described herein, or a combination of two or more thereof.

The marine vessel 100 has a longitudinal axis 106 extending between the bow 102 and the stern 103 of the hull 101. In general, “roll” herein may refer to movement that includes rotation of the hull 101 around the longitudinal axis 106.

The marine vessel 100 is an example only, and alternative embodiments may differ. For example, alternative embodiments are not limited to marine vessels and may not necessarily include marine vessels, and “roll” may refer to other types of movement of marine vessels or of other types of bodies. Some alternative embodiments may include more than one hull.

### Roll-Stabilizer Assembly

The marine vessel 100 also includes a roll-stabilizer assembly 107 including a roll-stabilizer apparatus 108, a roll-stabilizer controller 109, and a roll-stabilizer energy-storage device 110 distinct from the main energy-storage device 105. An alternator of the marine engine 104, one or more other sources of electric current, or both may charge the roll-stabilizer energy-storage device 110. The roll-stabilizer energy-storage device 110 may additionally or alternatively be charged as described below.

In some embodiments, some or all of the roll-stabilizer apparatus 108, the roll-stabilizer controller 109, and the roll-stabilizer energy-storage device 110 may be integrated into a single unit that may be attached directly or indirectly to the hull 101. Such an integrated unit may, in some embodiments, simplify installation, for example because such an integrated unit may require fewer electrical connections with other components of the marine vessel 100, or such an integrated unit may require less assembly. Further, such an integrated unit may, in some embodiments, allow transmission of electrical energy between the roll-stabilizer apparatus 108 and the roll-stabilizer energy-storage device 110 with shorter electrical conductors, and thus less wasted energy, when compared to other roll-stabilizer assemblies that involve external sources of electrical energy for a roll-stabilizer apparatus and longer electrical conductors. Further, such an integrated unit including the roll-stabilizer apparatus 108 and the roll-stabilizer energy-storage device 110 may, in some embodiments, reduce or avoid electrical energy required from external sources of electrical energy, and may continue to function despite a failure of an external source of electrical energy.

The marine vessel 100 also includes an inertial measurement unit 111 in communication with the roll-stabilizer controller 109 and operable to provide, to the roll-stabilizer controller 109, one or more signals indicating measurements, relative to an inertial frame of reference or another frame of reference, of linear acceleration, of rotational acceleration, of orientation, or a combination of two or more thereof of the hull 101 or of one or more other locations on the marine vessel 100 that may move with the hull 101. For example, the inertial measurement unit 111 may include one or more gyroscopes, one or more accelerometers, one or more other devices operable to measure linear acceleration, rotational acceleration, orientation, or a combination of two or more thereof of the hull 101 relative to an inertial frame of reference or another frame of reference. The inertial measurement unit 111 may be positioned at any location on the marine vessel 100. For example, in some embodiments, the inertial measurement unit 111 may be positioned on one or both of housing bodies 136 and 137 described below, or on one or both of housing bodies 244 and 245 described below. Further, in some embodiments, the inertial measurement unit 111 may include more than one device at one or more locations. However, alternative embodiments may omit the inertial measurement unit 111 or include one or more alternatives to the inertial measurement unit 111.

The roll-stabilizer controller 109 may include one or more processor circuits that may include one or more central processing unit (CPUs) or microprocessors, one or more machine learning chips, discrete logic circuits, or one or more application-specific integrated circuit (ASICs), or combinations of two or more thereof, for example, and that may include one or more of the same or different computer-readable storage media, which in various embodiments may include one or more of a read-only memory (ROM), a random access memory (RAM), a hard disc drive (HDD), a solid-state drive (SSD), and other computer-readable and/or computer-writable storage media. For example, one or more such computer-readable storage media may store program codes that, when executed, cause one or more processor circuits of the roll-stabilizer controller 109 to implement functions as described herein, for example, in which case the roll-stabilizer controller 109 may be programmed, configured, or operable to implement such functions. Of course the roll-stabilizer controller 109 may be configured or otherwise operable to implement other functions and to implement functions in other ways. For example, the roll-stabilizer controller 109 may be a single device or may include more than one device. In general, any apparatus, controller, or other device may include one or more processor circuits that may be programmed, configured, or operable as described above.

The roll-stabilizer controller 109 may include a wireless transmitter, a wireless receiver, a wireless transceiver, or two or more thereof to allow the roll-stabilizer controller 109 to receive one or more wireless signals directly or indirectly from, or transmit one or more wireless signals directly or indirectly to, a remote device 112. The remote device 112 may be a smartphone, a tablet computer, a smart watch, or smart glasses, for example. In the embodiment shown, the remote device 112 is detached from the marine vessel 100 and usable from outside of the marine vessel 100 and is therefore remote from the marine vessel 100. However, alternative embodiments may differ. For example, alternative embodiments may include one or more wired or other connections between the remote device 112 and the roll-stabilizer controller 109, and alternative embodiments may include devices on or integrated into the marine vessel 100 instead of the remote device 112.

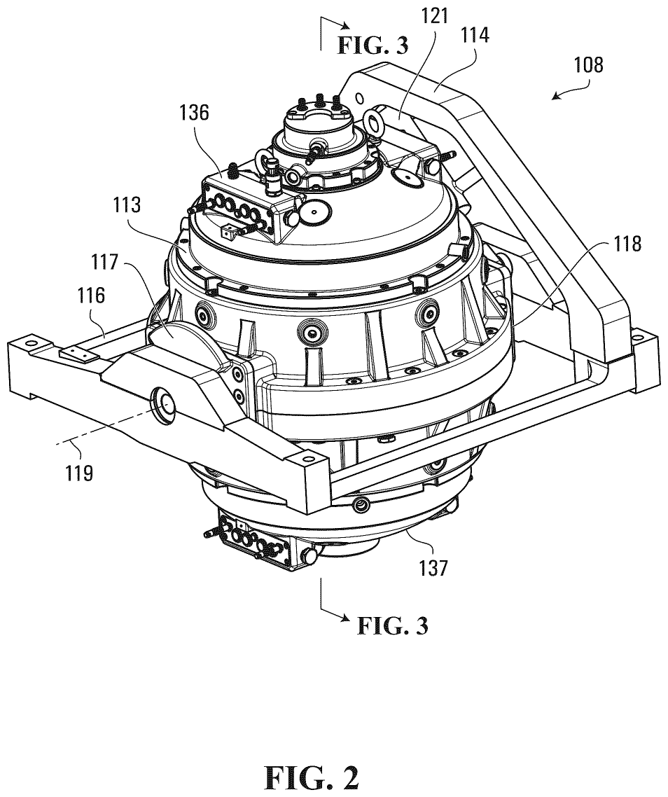

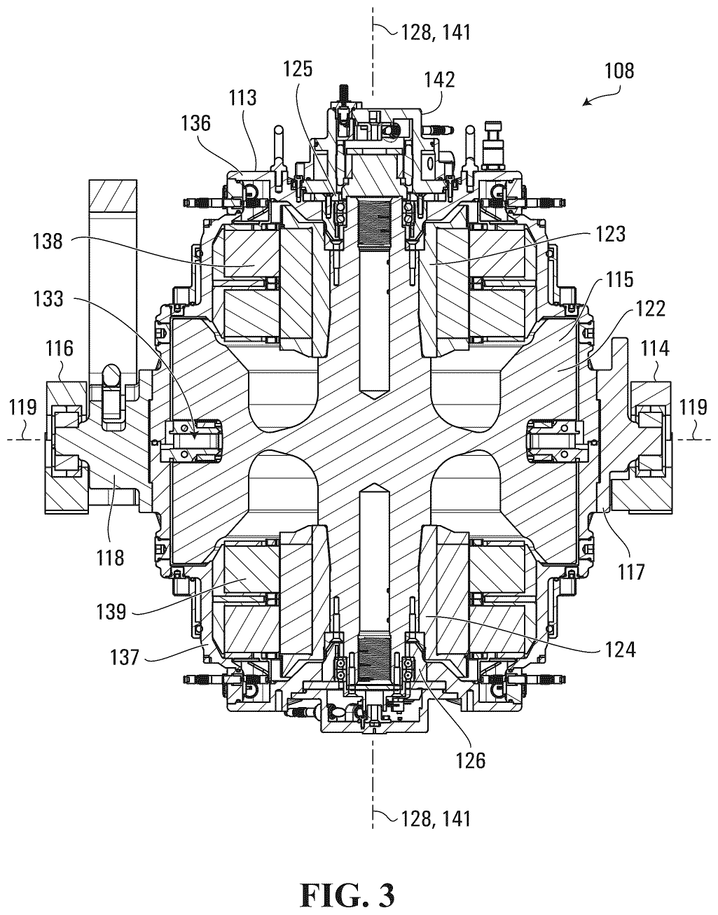

Referring to FIG. 2 and to FIG. 3, the roll-stabilizer apparatus 108 includes a flywheel-support body 113, a mounting body 114, and a flywheel assembly 115 in the flywheel-support body 113.

### Mounting Body

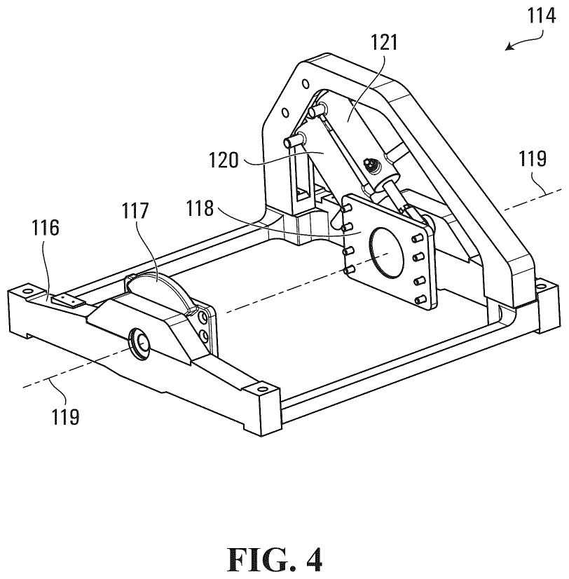

Referring to FIG. 4, the mounting body 114 includes a base 116 attachable to one or more other structures in the roll-stabilizer assembly 107, which may be attached to the hull 101 directly or indirectly to attach the mounting body 114, and thus the roll-stabilizer apparatus 108, to the hull 101. However, in alternative embodiments, the roll-stabilizer apparatus 108 may be attached directly or indirectly to the hull 101 in other ways, or the roll-stabilizer apparatus 108 may not be attached to any hull or to any marine vessel. Therefore, in some embodiments, measurements of linear acceleration, of rotational acceleration, of orientation, or a combination of two or more thereof of the hull 101, relative to an inertial frame of reference or another frame of reference, by the inertial measurement unit 111 may indicate such acceleration, orientation, or both of the mounting body 114 relative to such a frame of reference. Therefore, references herein to movement, acceleration, or orientation of the mounting body 114, relative to an inertial frame of reference or another frame of reference, may refer to movement, acceleration, or orientation, relative to such a frame of reference, of the inertial measurement unit 111 or of any other location that may be attached directly or indirectly to the mounting body 114 or that may otherwise move with mounting body 114.

The mounting body 114 also includes mounting brackets 117 and 118, each supported by a respective precession bearing and rotatable relative to the base 116 around a precession axis of rotation (or simply a precession axis) 119. The mounting brackets 117 and 118 are spaced apart from each other to define a space between the mounting brackets 117 and 118 to receive the flywheel-support body 113, and the mounting brackets 117 and 118 are each attachable to the flywheel-support body 113 such that when the flywheel-support body 113 is attached to the mounting brackets 117 and 118, the flywheel-support body 113 is attached to the mounting body 114 while the mounting body 114 permits the flywheel-support body 113 to rotate around the precession axis of rotation 119 relative to the base 116.

In some embodiments, movement of the flywheel-support body 113 relative to the mounting body 114 may be constrained to rotation of the flywheel-support body 113 relative to the mounting body 114 around the precession axis of rotation 119. However, alternative embodiments may differ. For example, in alternative embodiments, the flywheel-support body 113 may be mounted for both translation and rotation relative to the mounting body 114, for example using a linkage such as a four-bar linkage.

The mounting body 114 also includes precession-control devices 120 and 121. In general, a precession-control device may include an actuator, which may be a linear actuator or a torsional actuator, and which may be an electromechanical actuator, a screw actuator, a hydraulic actuator, or a pneumatic actuator. Further, a precession-control device may include a shock absorber, a damper, an electric generator, or another device that can apply a resistive torque to the flywheel-support body 113 relative to the mounting body 114 to dampen the rotation of the flywheel-support body 113 relative to the mounting body 114.

The precession-control device 120 is a linear actuator rotatably attached to the base 116 and rotatably attached to the mounting bracket 118 at a distance away from the precession axis of rotation 119 such that linear extension or contraction of the precession-control device 120 may cause rotation of the mounting bracket 118 (and thus of the flywheel-support body 113) around the precession axis of rotation 119 relative to the base 116, and such that rotation of the flywheel-support body 113 (and thus of the mounting bracket 118) around the precession axis of rotation 119 relative to the base 116 may cause linear extension or contraction of the precession-control device 120.

Also, the precession-control device 121 is a linear actuator rotatably attached to the base 116 and rotatably attached to the mounting bracket 118 at a distance away from the precession axis of rotation 119 such that linear extension or contraction of the precession-control device 121 may cause rotation of the mounting bracket 118 (and thus of the flywheel-support body 113) around the precession axis of rotation 119 relative to the base 116, and such that rotation of the flywheel-support body 113 (and thus of the mounting bracket 118) around the precession axis of rotation 119 relative to the base 116 may cause linear extension or contraction of the precession-control device 121.

In some embodiments, each of the precession-control devices 120 and 121 may be a roller-screw actuator as described in United States patent application publication no. US 2020/0102053 A1, for example, and may be self-locking. For example, the actuators may be backdrivable and may include brakes to resist or prevent rotation of the flywheel-support body 113 relative to the mounting body 114. Such actuators may be simpler than other actuators, such as hydraulic actuators that may require handling hydraulic fluid and producing pressurized hydraulic fluid.

Each of the precession-control devices 120 and 121 is in communication with the roll-stabilizer controller 109 (shown in FIG. 1) to receive one or more control signals from the roll-stabilizer controller 109. Further, each of the precession-control devices 120 and 121 is an electromechanical actuator operable to extend and contract to apply a torque to, and to rotate, the mounting bracket 118 (and thus the flywheel-support body 113) around the precession axis of rotation 119 relative to the base 116 in response to, at least, one or more control signals from the roll-stabilizer controller 109. Such a torque applied by the precession-control devices 120 and 121 may differ from a resistive torque because, for example, a torque applied by the precession-control devices 120 and 121 may cause rotation of the mounting bracket 118 around the precession axis of rotation 119 relative to the base 116 in a same direction as the applied torque, and the applied torque may be independent of rotation of the mounting bracket 118 around the precession axis of rotation 119 relative to the base 116.

Further, each of the precession-control devices 120 and 121 is operable to generate electrical energy from rotation of the flywheel-support body 113 (and thus of the mounting bracket 118) around the precession axis of rotation 119 relative to the base 116 and thereby dampen precession of the flywheel-support body 113 around the precession axis of rotation 119 relative to the base 116. The precession-control devices 120 and 121 are electrically connected to the roll-stabilizer energy-storage device 110 such that electrical energy generated by the precession-control devices 120 and 121 may be stored by the roll-stabilizer energy-storage device 110.

In some embodiments, minimizing backlash or lost motion between the flywheel-support body 113 and the precession-control devices 120 and 121, or between the mounting body 114 and the precession-control devices 120 and 121, may be important for control stability.

However, alternative embodiments may differ. For example, alternative embodiments may include more or fewer precession-control devices that may differ from the precession-control devices 120 and 121. For example, a precession-control device according to an alternative embodiment may include a different electromechanical actuator, a different electric generator, or both, and some embodiments may omit such precession-control devices. Further, alternative embodiments may differ and may include hydraulic actuators, torsional actuators, or both, for example. Also, precession-control devices of alternative embodiments need not be actuators, but could apply only resistive forces or torques that simply resist or dampen movement of the flywheel-support body 113 relative to the mounting body 114.

### Flywheel Assembly

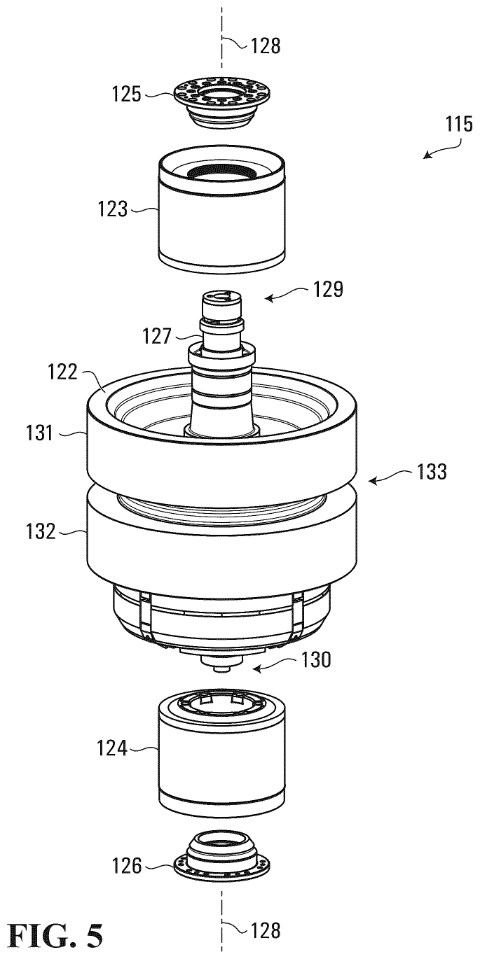

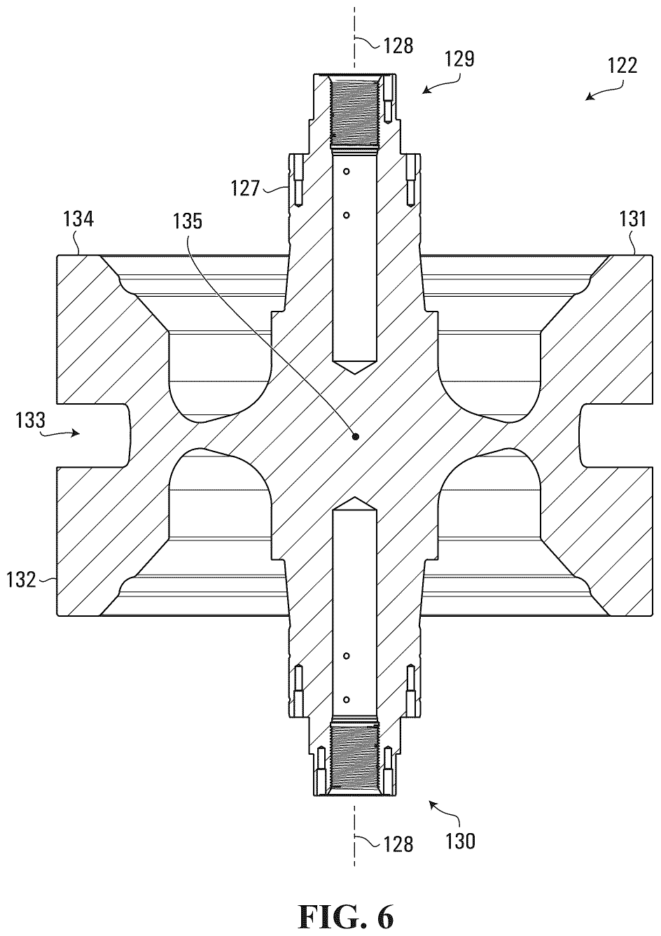

Referring to FIG. 5 and to FIG. 6, the flywheel assembly 115 includes a flywheel body 122, rotors 123 and 124, and touchdown bearings in touchdown-bearing assemblies 125 and 126. The flywheel body 122 has a shaft 127 extending along a spin axis of rotation 128 between opposite ends shown generally at 129 and 130 of the shaft 127. The rotor 123 may be attached to the shaft 127 at the end 129, and the rotor 124 attached to the shaft 127 at the end 130. The spin axis of rotation 128 may be through a center of mass of the flywheel assembly 115 and through centers of the opposite ends 129 and 130, although the flywheel assembly 115 does not necessarily have to spin around spin axis of rotation 128. In some embodiments, the flywheel assembly 115 may spin in other ways.

A wheel portion 131 surrounds the shaft 127 and the spin axis of rotation 128, and much of the wheel portion 131 is spaced apart from the spin axis of rotation 128 to increase a moment of inertia of the flywheel body 122. An outer (or outermost) peripheral surface 132 of the wheel portion 131 also surrounds the shaft 127 and the spin axis of rotation 128, and is generally cylindrical around the spin axis of rotation 128. However, the wheel portion 131 of the flywheel body 122 defines a groove (or taper cut) shown generally at 133 and recessed in the outer peripheral surface 132. Alternative embodiments may differ. For example, a wheel portion of an alternative embodiment may include a groove in a peripheral surface that is not necessarily an outer or outermost peripheral surface of the wheel portion, and that may be an inner surface of a flywheel body, for example. Such a surface may be cylindrical, or may be generally cylindrical (for example, not exactly cylindrical but similar to cylindrical).

Because the wheel portion 131 of the flywheel body 122 defines the groove 133, a point of peak stress of the flywheel body 122 during rotation of flywheel body 122 around the spin axis of rotation 128 may be at a location 134, as opposed to a location 135 that may be a point of peak stress of the flywheel body 122 if the flywheel body 122 omitted the groove 133. The location 134 is closer to a surface of the wheel portion 131 than the location 135, so the point of peak stress at the location 134 may be preferable to the point of peak stress at the location 135, for example because the location 134 is closer to a surface of the wheel portion 131 that may be heat-treated.

The flywheel assembly 115 is an example only, and alternative embodiments may differ.

### Flywheel Body

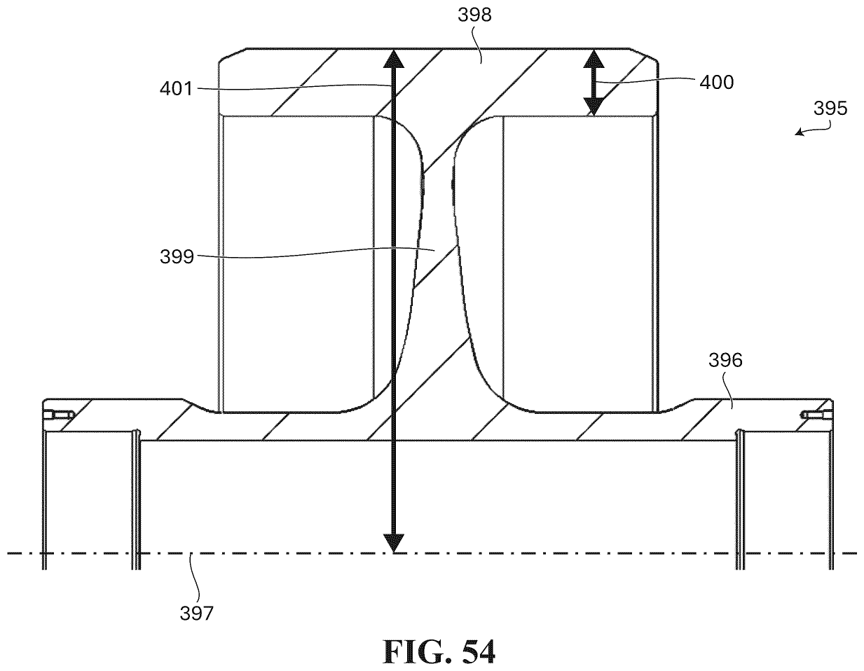

Referring to FIG. 54, a flywheel body according to one embodiment is shown generally at 395 and includes a central portion 396 rotatable around a central-rotation axis 397 of the flywheel body 395. The flywheel body 395 may be rotationally symmetric around the central-rotation axis 397 or otherwise configured to rotate around the central-rotation axis 397 in a roll-stabilizer apparatus such as those described herein or in gyroscope or another flywheel application. The flywheel body 395 also includes a wheel portion 398 spaced apart from the central portion 396 radially relative to the central-rotation axis 397. The flywheel body 395 also includes at least one radial portion 399 coupling the wheel portion 398 to the central portion 396.

The wheel portion 398 has a maximum radial thickness 400 relative to the central-rotation axis 397, and the wheel portion 398 extends to a maximum radius 401 from the central-rotation axis 397. In some embodiments, a ratio of the maximum radial thickness 400 to the maximum radius 401 is less than 0.27, less than 0.27, less than 0.26, less than 0.25, less than 0.24, less than 0.23, less than 0.22, less than 0.21, less than 0.20, less than 0.19, less than 0.18, less than 0.17, less than 0.16, or less than 0.15.

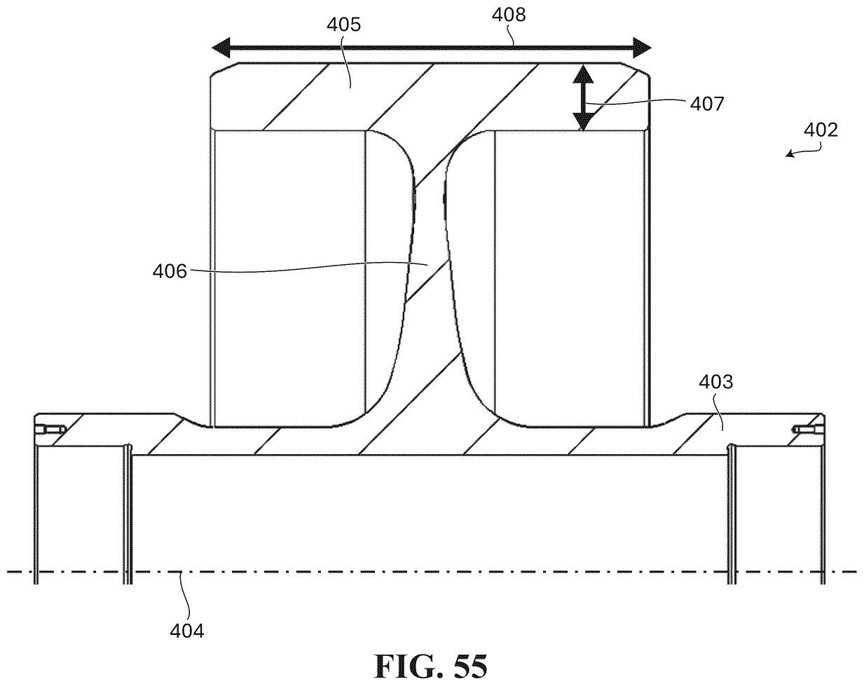

Referring to FIG. 55, a flywheel body according to one embodiment is shown generally at 402 and includes a central portion 403 rotatable around a central-rotation axis 404 of the flywheel body 402. The flywheel body 402 may be rotationally symmetric around the central-rotation axis 404 or otherwise configured to rotate around the central-rotation axis 404 in a roll-stabilizer apparatus such as those described herein or in gyroscope or another flywheel application. The flywheel body 402 also includes a wheel portion 405 spaced apart from the central portion 403 radially relative to the central-rotation axis 404. The flywheel body 402 also includes at least one radial portion 406 coupling the wheel portion 405 to the central portion 403.

The wheel portion 405 has a maximum radial thickness 407 relative to the central-rotation axis 404, and the wheel portion 405 has maximum height 408 along the central-rotation axis 404. In some embodiments, a ratio of the maximum radial thickness 407 to the maximum height 408 is less than 0.23, less than 0.22, less than 0.21, less than 0.20, less than 0.19, less than 0.18, less than 0.17, or less than 0.16.

Embodiments such as those described above may balance a high proportion of moment of inertia to mass of a flywheel body or a maximum rotational speed of the flywheel body with possible challenges such as potentially damaging vibration modes or manufacturing challenges.

### Flywheel-Support Body

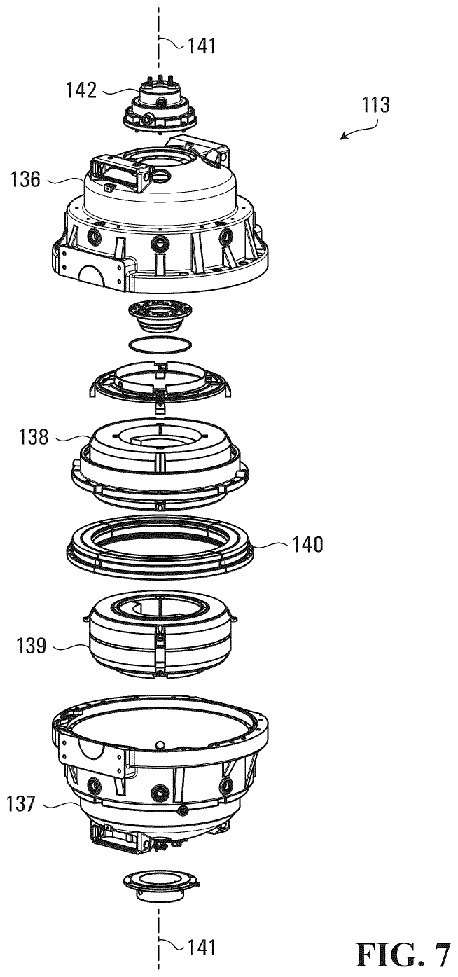

Referring to FIG. 7, the flywheel-support body 113 includes housing bodies 136 and 137 that, when assembled as shown in FIG. 2 and in FIG. 3, form a housing that houses the flywheel assembly 115. The housing bodies 136 and 137 may be hemispheric bodies in some embodiments, and the housing formed by the housing bodies 136 and 137 may include very low air pressure, a slippery gas, helium, some other gas or mixture of gases, or a vacuum in some embodiments. More specifically, the housing formed by the housing bodies 136 and 137 may form a seal to contain an internal environment different than an ambient external environment. For example, the seal may be an air-tight seal, and the internal environment may have a different pressure than ambient pressure, or may contain gases or mixtures of gases different than ambient air. Thus, for example, in some embodiments the housing formed by the housing bodies 136 and 137 may enclose the flywheel assembly 115 in an environment that has a pressure lower than ambient pressure, such as a vacuum, or that includes a slippery gas, helium, or some other gas or mixture of gases. The flywheel-support body 113 also includes, within the housing formed by the housing bodies 136 and 137, stators 138 and 139 and an axial active magnetic bearing 140. In general, the flywheel-support body 113 has a central-rotation axis 141. The central-rotation axis 141 is perpendicular to the precession axis of rotation 119. In alternative embodiments, the central-rotation axis 141 may be non-parallel to, and not necessarily perpendicular to, the precession axis of rotation 119. The central-rotation axis 141 is not necessarily at an exact center of the flywheel-support body 113 or of any other structure.

The flywheel-support body 113 is operable to support the flywheel assembly 115 such that the flywheel assembly 115 is rotatable within the flywheel-support body 113 at least when the spin axis of rotation 128 is colinear with the central-rotation axis 141. However, the spin axis of rotation 128 does not necessarily have to be colinear with the central-rotation axis 141, and a target axis for the spin axis of rotation 128 may be colinear with the central-rotation axis 141, or close to but not necessarily colinear with the central-rotation axis 141.

The flywheel-support body 113 also includes an electric motor/generator 142 electrically connected (either directly or indirectly, such as indirectly through the roll-stabilizer controller 109) to the roll-stabilizer energy-storage device 110 (shown in FIG. 1) such that the electric motor/generator 142 may use electric energy stored by the roll-stabilizer energy-storage device 110 to apply a torque to the flywheel assembly 115 (and thus to the flywheel body 122) around the spin axis of rotation 128 relative to the flywheel-support body 113. In some embodiments, the electric motor/generator 142 may have multiple different windings to facilitate generating different torque profiles, which may provide higher rates of acceleration or deceleration. As used herein, the term “electric motor/generator” excludes any electrical or other connections, such as wires, studs, or plugs.

Further, the electric motor/generator 142 may convert rotational kinetic energy, from rotation of the flywheel assembly 115 (and thus from the flywheel body 122) around the spin axis of rotation 128 relative to the flywheel-support body 113, to electrical energy, and the electric motor/generator 142 is electrically connected to the roll-stabilizer energy-storage device 110 such that the roll-stabilizer energy-storage device 110 may receive and store such electrical energy converted from such rotational kinetic energy.

In some embodiments, the electric motor/generator 142 may be located entirely within the housing formed by the housing bodies 136 and 137. As such, when the housing formed by the housing bodies 136 and 137 encloses the flywheel assembly 115 in an internal environment different than an ambient external environment, the electric motor/generator 142 may also be contained in this internal environment. In such embodiments, electrical connections (not shown) to the electric motor/generator 142 could pass through one or both of the housing bodies 136 and 137.

The electric motor/generator 142 is an example only, and alternative embodiments may differ. For example, an alternative embodiment may include only an electric motor, or may include an electric motor and an electric generator separate from the electric motor. Further, an alternative embodiment may include more than one electric motor, more than one electric generator, or more than one electric motor/generator that may differ from the electric motor/generator 142. Also, alternative embodiments could generate torque in other ways. For example, alternative embodiments may include a hydraulic pump and motor, or could use air power. Further, as described below for example, one or more magnetic bearings may apply a torque to the flywheel assembly 115. Also, in some embodiments, a motor may have an output shaft that is spaced apart from the central-rotation axis 141.

More generally, the flywheel-support body 113 is an example only, and alternative embodiments may differ.

The flywheel-support body 113 may also include one or more proximity sensors, one or more position sensors, or both that are operable to provide, to the roll-stabilizer controller 109 (shown in FIG. 1), one or more signals indicating measurements of proximity or position of the flywheel assembly 115 relative to the flywheel-support body 113. For example, such one or more sensors may include one or more optical sensors, one or more magnetic sensors (such as one or more eddy-current sensors, for example), one or more capacitive sensors, one or more inductive sensors (for example, one or more sensors of inductance of one or more magnetic bearings as described herein), one or more other proximity sensors, one or more other position sensors, or a combination of two or more thereof.

### Power Management

In some embodiments, power transfer from and to the main energy-storage device 105 (also referred to as a Boat House Battery (BHB)) and the roll-stabilizer energy-storage device 110 (also referred to as a Device Dedicated Battery (DDB)) may be coordinated.

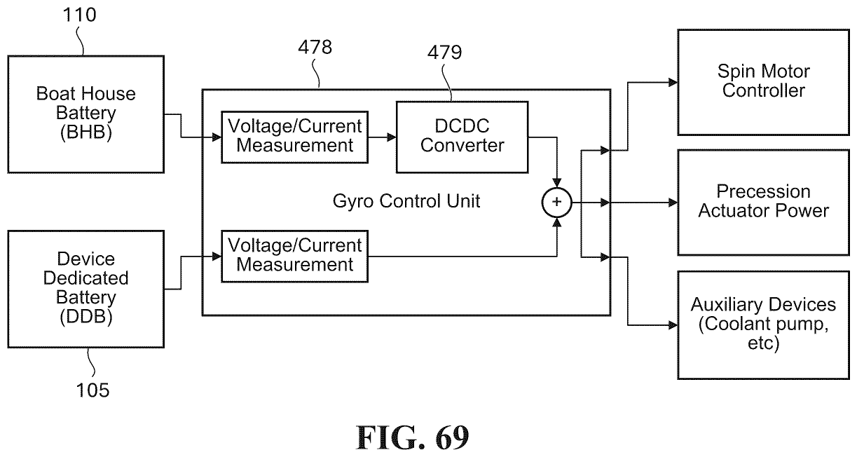

For example, FIG. 69 illustrates how power from the main energy-storage device 105 and the roll-stabilizer energy-storage device 110 may be used by a roll-stabilizer apparatus such as the roll-stabilizer apparatus 108. A battery controller 478 includes a DCDC converter 479, which may step up voltage from the main energy-storage device 105 and the roll-stabilizer energy-storage device 110 to a higher voltage for us by the roll-stabilizer apparatus.

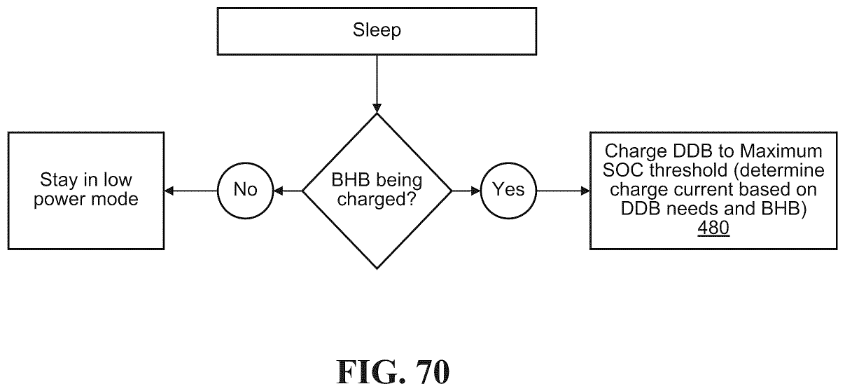

FIG. 70 illustrates schematically a standby mode according to one embodiment. During such a standby mode, energy is not transferred to or from rotational kinetic energy of a flywheel body. As shown at 480 in FIG. 70, in the standby mode, if the main energy-storage device 105 is being charged, the battery controller 478 may cause the roll-stabilizer energy-storage device 110 to be charged up to a standby-maximum charge threshold. For example, the standby-maximum charge threshold at 480 may be 80% of a maximum charge level of the roll-stabilizer energy-storage device 110, 100% of a maximum charge level of the roll-stabilizer energy-storage device 110, or some other charge threshold as may be recommended or chosen to extend a usable lifetime of the roll-stabilizer energy-storage device 110 or for some other reason.

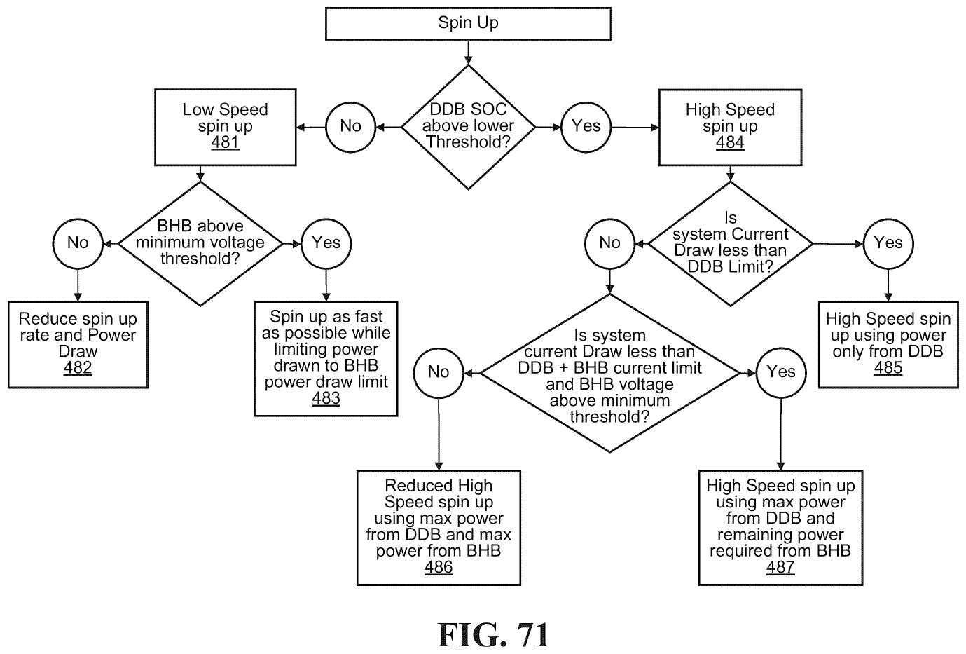

FIG. 71 illustrates schematically a startup mode according to one embodiment. During such a startup mode, energy is transferred to rotational kinetic energy of a flywheel body from the main energy-storage device 105, from the roll-stabilizer energy-storage device 110, or from both until the flywheel body reaches a threshold minimum angular speed or angular momentum for roll stabilization. During such a spin-up mode, if a level of charge of the roll-stabilizer energy-storage device 110 is not (as shown at 481) at least a roll-stabilizer-energy-storage-device minimum threshold, then energy may be transferred to rotational kinetic energy of the flywheel body from at least (or only) the main energy-storage device 105. As shown at 482, if a voltage of the main energy-storage device 105 is not at least a minimum-voltage threshold, then a rate of energy transfer to rotational kinetic energy of the flywheel body from the main energy-storage device 105 may be reduced. As shown at 483, if the voltage of the main energy-storage device 105 is at least the minimum-voltage threshold, then a rate of energy transfer to rotational kinetic energy of the flywheel body from the main energy-storage device 105 may be increased up to a maximum power transfer from the main energy-storage device 105.

As shown at 484, if the level of charge of the roll-stabilizer energy-storage device 110 is at least the roll-stabilizer-energy-storage-device minimum threshold, then energy from the roll-stabilizer energy-storage device 110 may be transferred to rotational kinetic energy of the flywheel body. As shown at 485, if an electric current demand for roll stabilization is less than available electric current from the roll-stabilizer energy-storage device 110 or a voltage of the main energy-storage device 105 is at least a minimum-voltage threshold, then energy may be transferred to rotational kinetic energy of the flywheel body from at least (or only) the roll-stabilizer energy-storage device 110. Herein, “electric current demand for roll stabilization” may refer to electric current for increasing rotational kinetic energy of a flywheel body, for maintaining a target angular speed or angular momentum for roll stabilization, for active actuation or precession control, and for other purposes related to roll stabilization.

However, if the electric current demand for roll stabilization is at least the available electric current from the main energy-storage device 105 and from the roll-stabilizer energy-storage device 110, of if the voltage of the main energy-storage device 105 is not at least the minimum-voltage threshold, then as shown at 486, a rate of energy transfer to rotational kinetic energy of the flywheel body from the main energy-storage device 105 may be reduced until the electric current demand for roll stabilization is no more than the available electric current from the main energy-storage device 105 and from the roll-stabilizer energy-storage device 110. Also, if the electric current demand for roll stabilization is no more than the available electric current from the main energy-storage device 105 and from the roll-stabilizer energy-storage device 110, and if the voltage of the main energy-storage device 105 is at least the minimum-voltage threshold, then as shown at 487, then energy may be transferred to rotational kinetic energy of the flywheel body using the maximum available power from the roll-stabilizer energy-storage device 110 and using power from the main energy-storage device 105 as required.

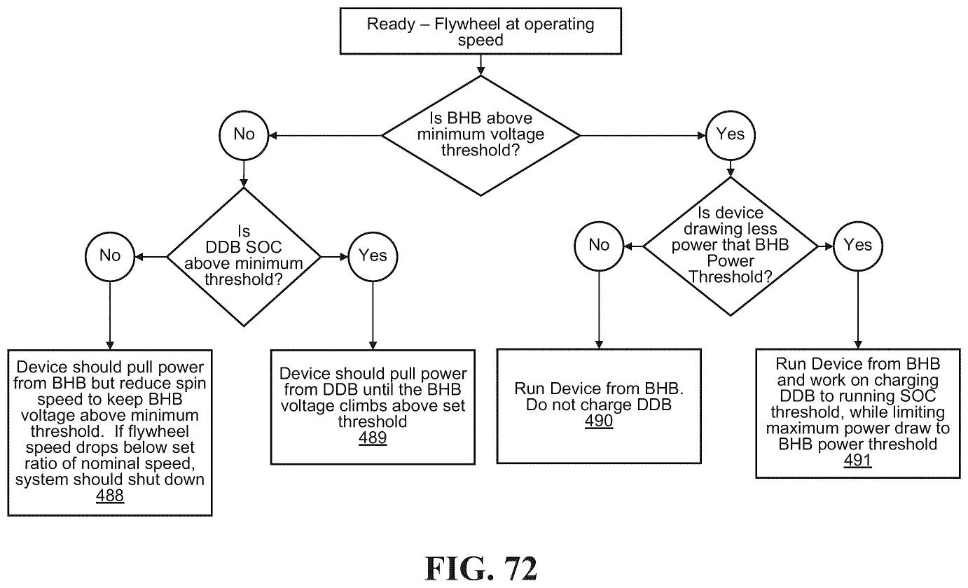

FIG. 72 illustrates schematically an operation mode according to one embodiment. During such an operation mode, energy may be transferred to the flywheel body to maintain a target angular speed or angular momentum for roll stabilization. As shown at 488, if the voltage of the main energy-storage device 105 is not at least a minimum-voltage threshold, and if a level of charge of the roll-stabilizer energy-storage device 110 is not at least a roll-stabilizer-energy-storage-device minimum threshold, then angular speed or angular momentum of the flywheel body may be reduced. However, as shown at 489, if the voltage of the main energy-storage device 105 is not at least the minimum-voltage threshold but the level of charge of the roll-stabilizer energy-storage device 110 is at least the roll-stabilizer-energy-storage-device minimum threshold, then energy may be transferred to rotational kinetic energy of the flywheel body using power from at least (or only) the roll-stabilizer energy-storage device 110.

As shown at 490, if the voltage of the main energy-storage device 105 is at least the minimum-voltage threshold, and if non-charging power transfer (for example, power transfer for roll stabilization functions excluding charging the roll-stabilizer energy-storage device 110) is at least a maximum power transfer from the main energy-storage device 105, then the roll-stabilizer energy-storage device 110 is not charged.

However, as shown at 491, if the voltage of the main energy-storage device 105 is at least the minimum-voltage threshold, and if non-charging power transfer (for example, power transfer for roll stabilization functions excluding charging the roll-stabilizer energy-storage device 110) is less than the maximum power transfer from the main energy-storage device 105, then the roll-stabilizer energy-storage device 110 may be charged up to a roll-stabilizer-energy-storage-device operation-maximum threshold that may be less than the standby-maximum charge threshold. The roll-stabilizer-energy-storage-device operation-maximum threshold may be determined based on an estimate of rotational kinetic energy of the flywheel body and on an estimate of efficiency of conversion of the rotational kinetic energy of the flywheel body to electrical energy to be stored by the roll-stabilizer energy-storage device 110, such that the roll-stabilizer energy-storage device 110, when charged to the roll-stabilizer-energy-storage-device operation-maximum threshold, may be recharged with the rotational kinetic energy of the flywheel body, at the efficiency of conversion of the rotational kinetic energy of the flywheel body to electrical energy to be stored by the roll-stabilizer energy-storage device 110, to the standby-maximum charge threshold or without exceeding the standby-maximum charge threshold.

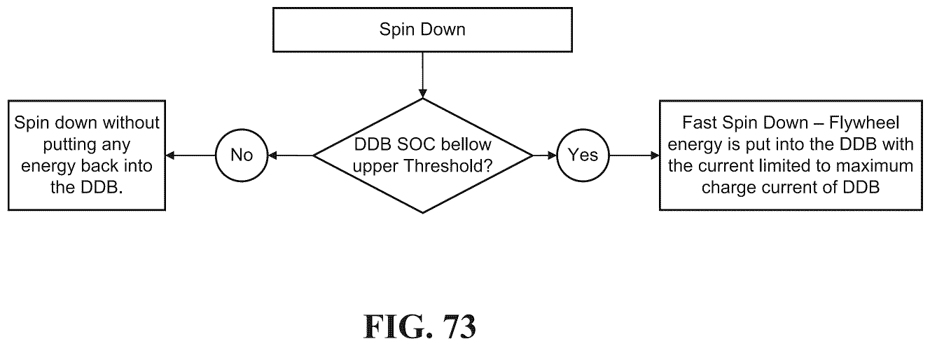

FIG. 73 illustrates schematically a spin-down mode in which an angular speed or angular momentum of the flywheel body is decreasing. During operation, the roll-stabilizer energy-storage device 110 may be charged from decreasing angular speed or angular momentum of the flywheel body to no more than the roll-stabilizer-energy-storage-device operation-maximum threshold, and during shutdown, the roll-stabilizer energy-storage device 110 may be charged from decreasing angular speed or angular momentum of the flywheel body to no more than the standby-maximum charge threshold.

### Homopolar Radial Magnetic Bearing

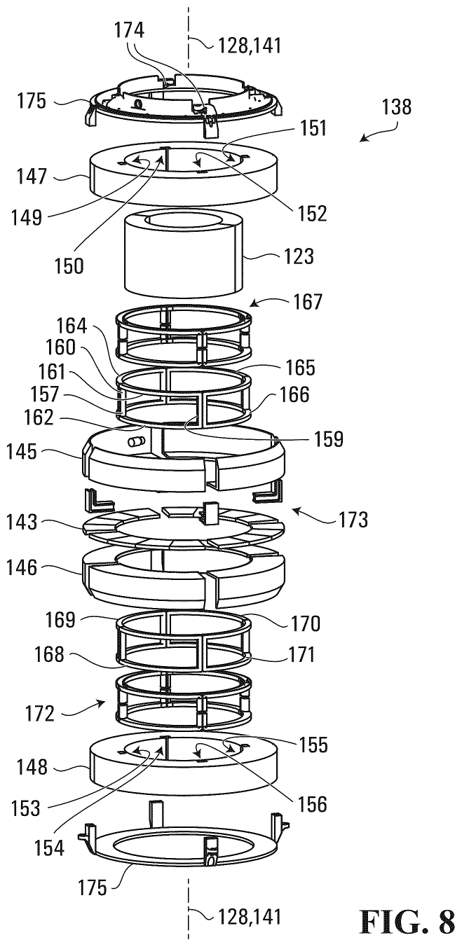

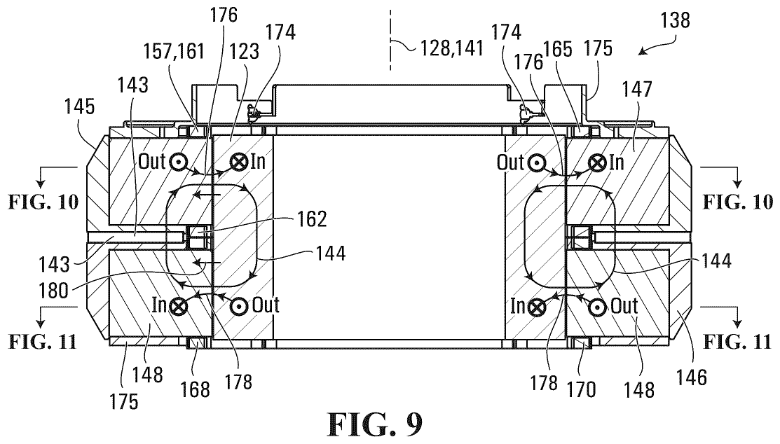

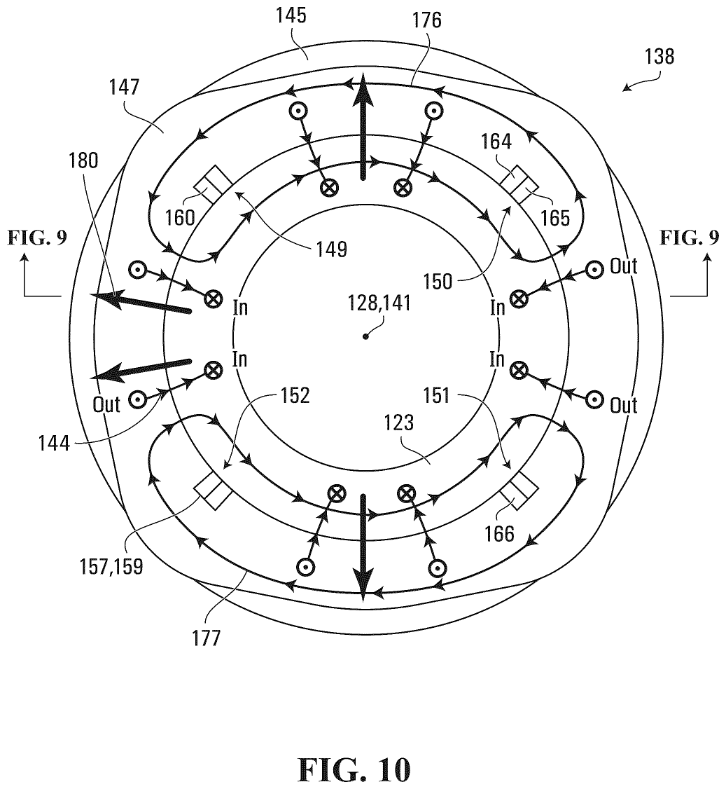

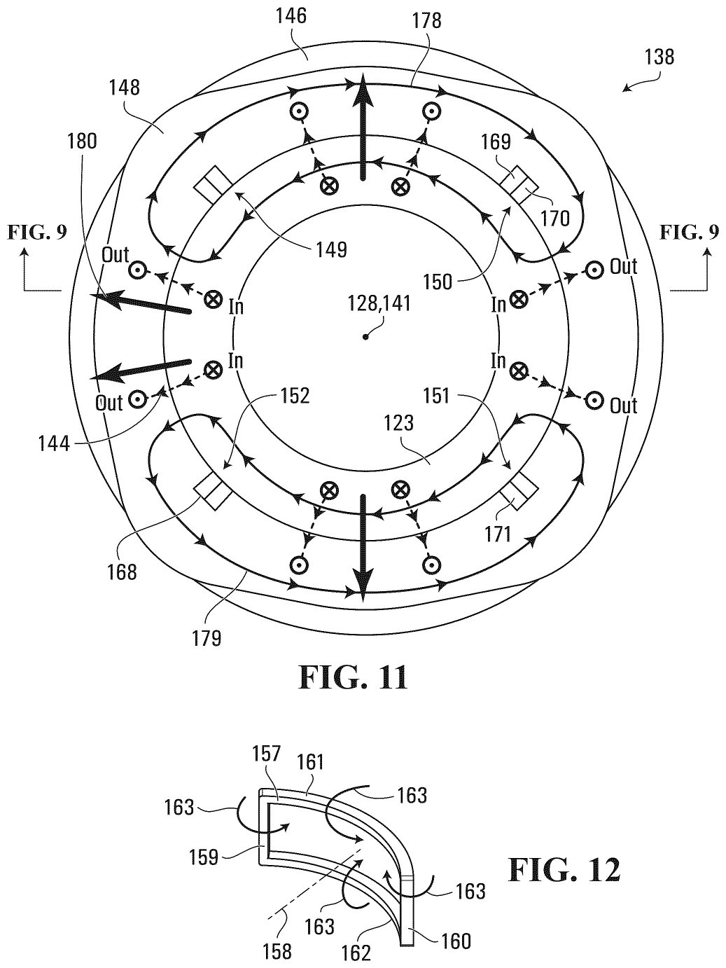

Referring to FIG. 8, to FIG. 9, to FIG. 10, and to FIG. 11, the rotor 123 (also shown in FIG. 5) is a cylindrically shaped assembly of steel laminations stacked in a direction along the central-rotation axis 141. The rotor 124 (also shown in FIG. 5) may be similar to the rotor 123. However, the rotor 123 is an example only, and alternative embodiments may differ. For example, alternative embodiments may include more or fewer components, or one or more alternatives to the components described above. For example, an alternative embodiment may include materials that differ from the materials described above.

The stator 138 (also shown in FIG. 7) includes a row of permanent magnets 143 in a generally annular shape around the central-rotation axis 141. However, alternative embodiments may include one or more electromagnets or other magnets additionally or alternatively to the permanent magnets 143. The permanent magnets 143 are magnetized in a direction along the central-rotation axis 141 and create a bias magnetic field as shown by magnetic-field arrows 144. The magnetization direction of the permanent magnets 143 as shown in FIG. 9, in FIG. 10, and in FIG. 11 is an example only, and the magnetization direction may be opposite or otherwise different in other embodiments.

Steel pieces 145 and 146 are on opposite sides, along the central-rotation axis 141, of the permanent magnets 143. The steel pieces 145 and 146 may function as back-iron flux distributors.

Also on opposite sides, along the central-rotation axis 141, of the permanent magnets 143 are cylindrically shaped axially stacked lamination-steel bodies 147 and 148. The lamination-steel bodies 147 and 148 could additionally or alternatively be made of soft-magnetic-composite (SMC), similar low-loss magnetic steels, sintered magnetic materials, laminations, or other materials, and alternative embodiments may have topologies that differ from the topology shown. The lamination-steel body 147 is between the steel piece 145 and the rotor 123, and the lamination-steel body 148 is between the steel piece 146 and the rotor 123. The lamination-steel body 147 is generally annular, and an inner surface of the lamination-steel body 147 defines axially extending grooves shown generally at 149, 150, 151, and 152. The lamination-steel body 148 is also generally annular, and an inner surface of the lamination-steel body 148 defines axially extending grooves shown generally at 153, 154, 155, and 156.

The rotor 123 and the lamination-steel bodies 147 and 148 may be sized and positioned such that a gap (which may be an air gap in some embodiments) is between the rotor 123 and the lamination-steel bodies 147 and 148. Such a gap may facilitate generation of magnetic forces as described herein, for example.

Referring to FIG. 8, to FIG. 10, to FIG. 11, and to FIG. 12, the stator 138 also includes an electric coil 157 including an electric conductor (such as copper) coiled around an axis 158 extending through and across the electric coil 157. The coil has axial portions 159 and 160 and peripheral portions 161 and 162 between the axial portions 159 and 160. When an electric current passes through the electric coil 157 in a clockwise direction from the perspective of the central-rotation axis 141 (or clockwise in the orientation of FIG. 12), the electric coil 157 produces a magnetic field as shown by magnetic-field arrows 163, and when an electric current passes through the electric coil 157 in a counter-clockwise direction from the perspective of the central-rotation axis 141 (or counter-clockwise in the orientation of FIG. 12), the electric coil 157 produces a magnetic field opposite the magnetic-field arrows 163 in FIG. 12. The axial portion 159 is received in the groove 152, and the axial portion 160 is received in the groove 149. The peripheral portions 161 and 162 are therefore on opposite sides, along the central-rotation axis 141, of the lamination-steel body 147.

The stator 138 also includes an electric coil 164 that may be similar to the electric coil 157, although axial portions of the electric coil 164 are received in the grooves 149 and 150.

The stator 138 also includes an electric coil 165 that may be similar to the electric coil 157, although axial portions of the electric coil 165 are received in the grooves 150 and 151.

The stator 138 also includes an electric coil 166 that may be similar to the electric coil 157, although axial portions of the electric coil 166 are received in the grooves 151 and 152.

The stator 138 also includes electric insulators shown generally at 167, each for surrounding and electrically insulating a respective one of the electric coils 157, 164, 165, and 166.

The stator 138 also includes an electric coil 168 that may be similar to the electric coil 157, although axial portions of the electric coil 168 are received in the grooves 153 and 156, and peripheral portions of the electric coil 168 are on opposite sides, along the central-rotation axis 141, of the lamination-steel body 148.

The stator 138 also includes an electric coil 169 that may be similar to the electric coil 168, although axial portions of the electric coil 169 are received in the grooves 153 and 154.

The stator 138 also includes an electric coil 170 that may be similar to the electric coil 168, although axial portions of the electric coil 170 are received in the grooves 154 and 155.

The stator 138 also includes an electric coil 171 that may be similar to the electric coil 168, although axial portions of the electric coil 171 are received in the grooves 155 and 156.

The stator 138 also includes electric insulators shown generally at 172, each for surrounding and electrically insulating a respective one of the electric coils 168, 169, 170, and 171.

The stator 138 also includes wire guides shown generally at 173 for guiding wires or other electric conductors electrically connected to one, more than one, or all of the electric coils 157, 164, 165, 166, 168, 169, 170, and 171. The electric coils 157, 164, 165, 166, 168, 169, 170, and 171 are electrically connected to the roll-stabilizer energy-storage device 110 (either directly or indirectly, such as indirectly through the roll-stabilizer controller 109) and may receive electric current from the roll-stabilizer energy-storage device 110 (shown in FIG. 1), and the roll-stabilizer controller 109 (also shown in FIG. 1) may control electric current through each of the electric coils 157, 164, 165, 166, 168, 169, 170, and 171 independently such that electric current through one of the electric coils 157, 164, 165, 166, 168, 169, 170, and 171 may be independent from electric current through one, more than one, or all of the others of the electric coils 157, 164, 165, 166, 168, 169, 170, and 171.

When the stator 138 is assembled as shown in FIG. 9, in FIG. 10, and in FIG. 11, peripheral portions of the electric coils 157, 164, 165, 166, 168, 169, 170, and 171 that are axially between the lamination-steel bodies 147 and 148 are also radially between the rotor 123 and the permanent magnets 143.

The stator 138 also includes a radial sensor mount 174 that may be used to mount one or more sensors, and a clamp 175 may be used for retention.

Referring to FIG. 9, to FIG. 10, and to FIG. 11, the bias magnetic field as shown by the magnetic-field arrows 144 is generally toroidal (or generally rectangular in a cross-section along the central-rotation axis 141) and passes through the permanent magnets 143, through the lamination-steel body 147, through the rotor 123 and around the peripheral portions of the electric coils 157, 164, 165, 166, 168, 169, 170, and 171 that are axially between the lamination-steel bodies 147 and 148, through the lamination-steel body 148, and back through the permanent magnets 143.

In general, the bias magnetic field as shown by the magnetic-field arrows 144 creates magnetic forces that are generally radial relative to the spin axis of rotation 128 and that attract the rotor 123 towards the stator 138 radially relative to the spin axis of rotation 128. Such attractive magnetic forces from the bias magnetic fields as shown by the magnetic-field arrows 144 may be uniform or similar around the spin axis of rotation 128, so the rotor 123 and the stator 138 therefore may function as a radial magnetic bearing (that may be known as a homopolar magnetic bearing) that may align the spin axis of rotation 128 to the central-rotation axis 141.

Referring to FIG. 9, to FIG. 10, and to FIG. 11, when an electric current passes through the electric coil 157 in a counter-clockwise direction from the perspective of the central-rotation axis 141 (or counter-clockwise in the orientation of FIG. 12), when an electric current passes through the electric coil 165 in a clockwise direction from the perspective of the central-rotation axis 141, when an electric current passes through the electric coil 168 in a clockwise direction from the perspective of the central-rotation axis 141, and when an electric current passes through the electric coil 170 in a counter-clockwise direction from the perspective of the central-rotation axis 141,
1. a control magnetic field as shown by magnetic-field arrows 176 passes around the axial portion 160 of the electric coil 157, through the rotor 123, around an axial portion of the electric coil 165, through the lamination-steel body 147, and back around the axial portion 160 of the electric coil 157,
2. a control magnetic field as shown by magnetic-field arrows 177 passes around the axial portion 159 of the electric coil 157, through the rotor 123, around an axial portion of the electric coil 165, through the lamination-steel body 147, and back around the axial portion 159 of the electric coil 157,
3. a control magnetic field as shown by magnetic-field arrows 178 passes around an axial portion of the electric coil 168, through the lamination-steel body 148, around an axial portion of the electric coil 170, through the rotor 123, and back around the axial portion of the electric coil 168, and
4. a control magnetic field as shown by magnetic-field arrows 179 passes around an axial portion of the electric coil 168, through the lamination-steel body 148, around an axial portion of the electric coil 170, through the rotor 123, and back around the axial portion of the electric coil 168.

As shown in FIG. 9, in FIG. 10, and in FIG. 11, on a side of the stator 138 having the electric coils 157 and 168, the control magnetic fields as shown by the magnetic-field arrows 176, 177, 178, and 179 are in the same direction as the bias magnetic fields as shown by the magnetic-field arrows 144, so the control magnetic fields as shown by the magnetic-field arrows 176, 177, 178, and 179 complement or enhance the bias magnetic fields as shown by the magnetic-field arrows 144 and strengthen the magnetic attraction of the rotor 123 towards the side of stator 138 having the electric coils 157 and 168.

As also shown in FIG. 9, in FIG. 10, and in FIG. 11, on a side of the stator 138 having the electric coils 165 and 170 (opposite the side of the stator 138 having the electric coils 157 and 168), the control magnetic fields as shown by the magnetic-field arrows 176, 177, 178, and 179 are in an opposite direction from the bias magnetic fields as shown by the magnetic-field arrows 144, so the control magnetic fields as shown by the magnetic-field arrows 176, 177, 178, and 179 counter or diminish the bias magnetic fields as shown by the magnetic-field arrows 144 and weaken the magnetic attraction of the rotor 123 towards the side of stator 138 having the electric coils 157 and 168.

As a result, when an electric current passes through the electric coil 157 in a counter-clockwise direction from the perspective of the central-rotation axis 141 (or counter-clockwise in the orientation of FIG. 12), when an electric current passes through the electric coil 165 in a clockwise direction from the perspective of the central-rotation axis 141, when an electric current passes through the electric coil 168 in a clockwise direction from the perspective of the central-rotation axis 141, and when an electric current passes through the electric coil 170 in a counter-clockwise direction from the perspective of the central-rotation axis 141, the electric coils 157, 165, 168, and 170 cause a net magnetic force 180 radially towards the side of the stator 138 having the electric coils 157 and 168, so the rotor 123 and the stator 138 therefore may function as an active radial magnetic bearing having radial forces controllable at least in part by controlling electric currents through the electric coils 157, 165, 168, and 170.

If directions of the electric currents through the electric coils 157, 165, 168, and 170 are reversed from the directions described in the example above, then the electric currents would cause a net magnetic force opposite the net magnetic force 180 and radially towards the side of the stator 138 having the electric coils 165 and 170. Further, the example described above involves electric currents through the electric coils 157, 165, 168, and 170, but similar radial forces towards or away from a side of the stator 138 having the electric coils 164 and 169 or a side of the stator 138 having the electric coils 166 and 171 may be controlled at least in part by controlling electric currents through the electric coils 164, 166, 169, and 171.

In general, diametrically opposed electric coils may cooperate to control radial magnetic forces. Therefore, in some embodiments, the electric coils 157, 165, 168, and 170 may be electrically connected to each other, the electric coils 164, 166, 169, and 171 may be electrically connected to each other, and the roll-stabilizer controller 109 (also shown in FIG. 1) may control electric current through the electric coils 157, 165, 168, and 170 independently from electric current through the electric coils 164, 166, 169, and 171.

The stator 139 (also shown in FIG. 7) may be similar to the stator 138. However, the stator 138 is an example only, and alternative embodiments may differ. For example, alternative embodiments may include more or fewer components, or one or more alternatives to the components described above. For example, an alternative embodiment may include materials that differ from the materials described above. Alternative embodiments may also include passive magnetic bearings in place of or in addition to the rotor 123 and the stator 138.

### E-Core Radial Magnetic Bearing

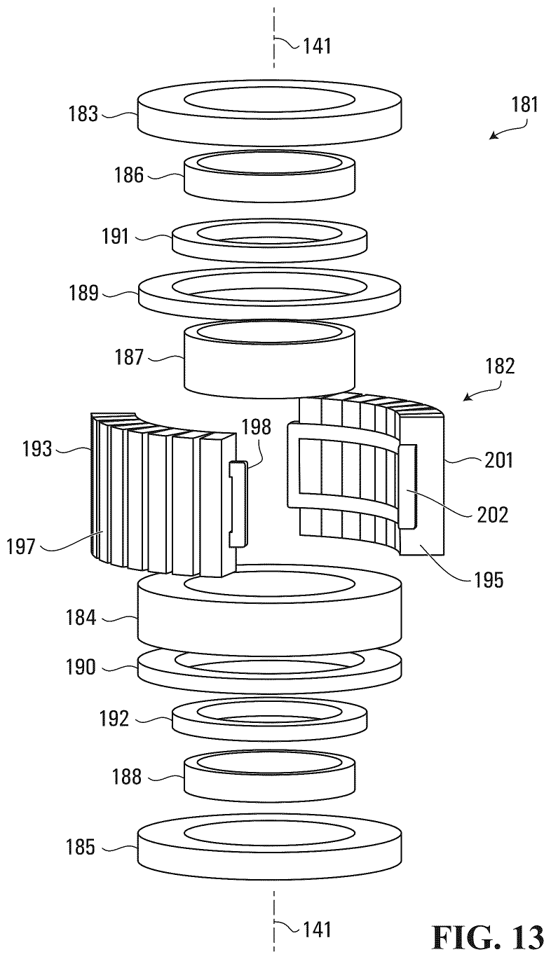

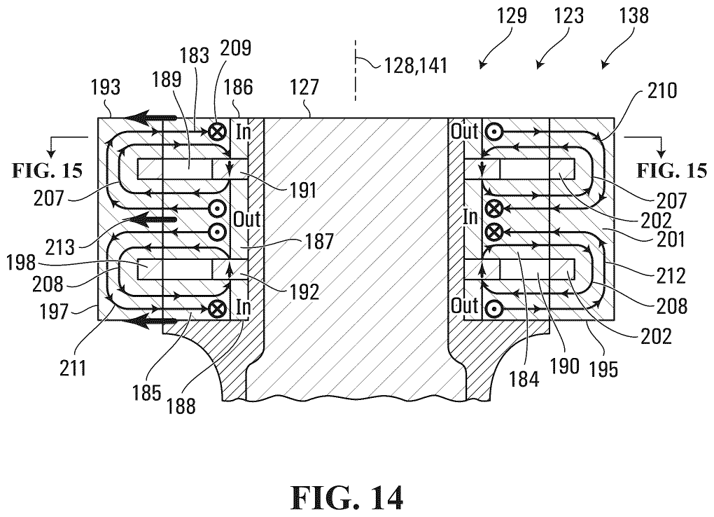

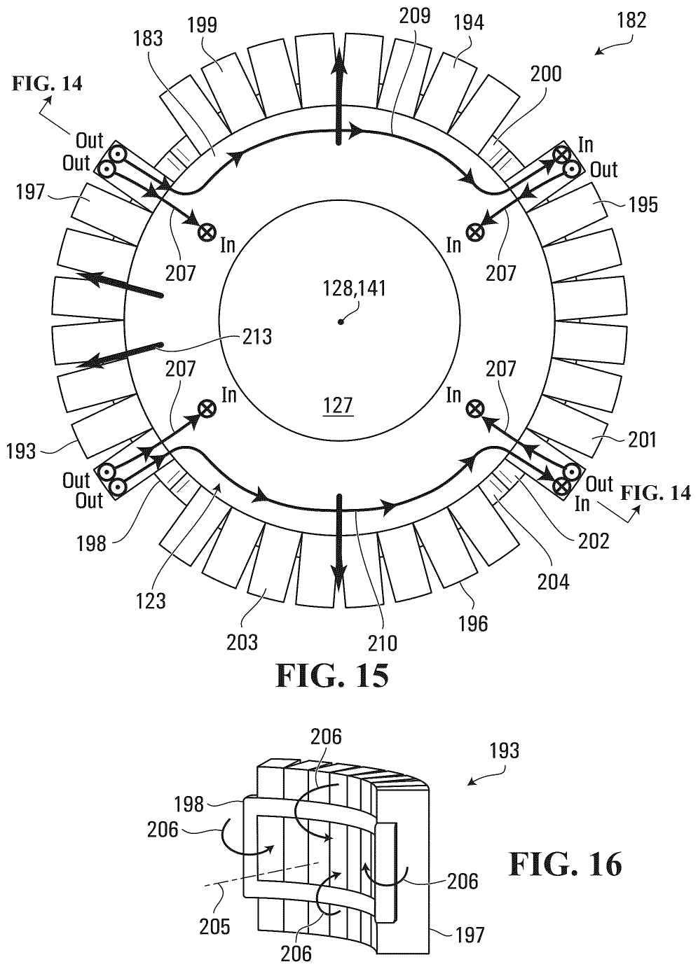

Referring to FIG. 13, to FIG. 14, and to FIG. 15, an alternative embodiment includes a rotor 181 and a stator 182. In the embodiment of FIG. 13, FIG. 14, and FIG. 15, the flywheel assembly 115 may include the rotor 181 as an alternative to the rotor 123, to the rotor 124, or to both, so FIG. 13, FIG. 14, and FIG. 15 illustrate the spin axis of rotation 128 as in the embodiment of FIG. 8, FIG. 9, FIG. 10, and FIG. 11. Likewise, in the embodiment of FIG. 13, FIG. 14, and FIG. 15, the flywheel-support body 113 may include the stator 182 as an alternative to the stator 138, to the stator 139, or to both, so FIG. 13, FIG. 14, and FIG. 15 illustrate the central-rotation axis 141 as in the embodiment of FIG. 8, FIG. 9, FIG. 10, and FIG. 11.

The rotor 181 includes lamination rings 183, 184, and 185. The rotor 181 also includes a solid-steel ring 186 inside the lamination ring 183, a solid-steel ring 187 inside the lamination ring 184, and a solid-steel ring 188 inside the lamination ring 185. The rotor 181 also includes a non-magnetic ring (such as a stainless-steel ring) 189 between the lamination rings 183 and 184, and a non-magnetic ring (such as a stainless-steel ring) 190 between the lamination rings 184 and 185. The rotor 181 also includes an annular permanent magnet 191 inside the non-magnetic ring 189, between the lamination rings 183 and 184, and between the solid-steel rings 186 and 187. The rotor 181 also includes an annular permanent magnet 192 inside the non-magnetic ring 190, between the lamination rings 184 and 185, and between the solid-steel rings 187 and 188. The annular permanent magnets 191 and 192 are magnetized in opposite directions along the central-rotation axis 141. The magnetization directions of the permanent magnets 191 and 192 as shown in FIG. 14 and in FIG. 15 are an example only, and the magnetization directions may be opposite or otherwise different in other embodiments. Further, alternative embodiments may include one or more electromagnets or other magnets additionally or alternatively to one or both of the permanent magnets 191 and 192.

More generally, the rotor 181 is an example only, and alternative embodiments may differ. For example, alternative embodiments may include more or fewer components, or one or more alternatives to the components described above. For example, an alternative embodiment may include materials that differ from the materials described above.

Still referring to FIG. 13, to FIG. 14, and to FIG. 15, the stator 182 includes four annular-sector stator bodies 193, 194, 195, and 196. The annular-sector stator bodies 194 and 196 are omitted from FIG. 13 for simplicity of illustration. The annular-sector stator body 193 includes SMC bodies 197 and an electric coil 198. The annular-sector stator body 194 includes SMC bodies 199 and an electric coil 200. The annular-sector stator body 195 includes SMC bodies 201 and an electric coil 202. The annular-sector stator body 196 includes SMC bodies 203 and an electric coil 204. The SMC bodies may be made from other materials, such as similar low-loss magnetic steels, sintered magnetic materials, or laminations, and alternative embodiments may have topologies that differ from the topology shown.

The lamination rings 183, 184, and 185 and the annular-sector stator bodies 193, 194, 195, and 196 may be sized and positioned such that a gap (which may be an air gap in some embodiments) is between the lamination rings 183, 184, and 185 and the annular-sector stator bodies 193, 194, 195, and 196. Such a gap may facilitate generation of magnetic forces as described herein, for example.

The electric coils 198, 200, 202, and 204 are electrically connected to the roll-stabilizer energy-storage device 110 (either directly or indirectly, such as indirectly through the roll-stabilizer controller 109) and may receive electric current from the roll-stabilizer energy-storage device 110 (shown in FIG. 1), and the roll-stabilizer controller 109 (also shown in FIG. 1) may control electric current through each of the electric coils 198, 200, 202, and 204 independently such that electric current through one of the electric coils 198, 200, 202, and 204 may be independent from electric current through one, more than one, or all of the others of the electric coils 198, 200, 202, and 204.

Referring to FIG. 16, the annular-sector stator body 193 is illustrated, and the annular-sector stator bodies 194, 195, and 196 may be similar to the annular-sector stator body 193. The electric coil 198 includes an electric conductor coiled around an axis 205 extending through and across the electric coil 198 the such that when an electric current passes through the electric coil 198 in a clockwise direction from the perspective of the central-rotation axis 141 (or clockwise in the orientation of FIG. 16), the electric coil 198 produces a magnetic field as shown by magnetic-field arrows 206 in FIG. 16, and when an electric current passes through the electric coil 198 in a counter-clockwise direction from the perspective of the central-rotation axis 141 (or counter-clockwise in the orientation of FIG. 16), the electric coil 198 produces a magnetic field opposite the magnetic-field arrows 206 in FIG. 16.

Referring back to FIG. 14 and to FIG. 15, the permanent magnet 191 creates a bias magnetic field as shown by magnetic-field arrows 207. The bias magnetic field as shown by the magnetic-field arrows 207 is generally toroidal (or generally rectangular in a cross-section along the central-rotation axis 141) and passes through the permanent magnet 191, around the non-magnetic ring 189, through the lamination ring 184, around the electric coils 198, 200, 202, and 204, through the SMC bodies 197, 199, 201, and 203, through the lamination ring 183, and back through the permanent magnet 191. The solid-steel rings 186 and 187 may, in some embodiments, facilitate flow of magnetic flux, through the permanent magnet 191, from the bias magnetic field as shown by the magnetic-field arrows 207. The non-magnetic ring 189 may, in some embodiments, create a magnetic-flux barrier to shape the bias magnetic field as shown by the magnetic-field arrows 207.

Further, the permanent magnet 192 creates a bias magnetic field as shown by magnetic-field arrows 208. The bias magnetic field as shown by the magnetic-field arrows 208 is generally toroidal (or generally rectangular in a cross-section along the central-rotation axis 141, and opposite in direction to the bias magnetic field as shown by the magnetic-field arrows 207) and passes through the permanent magnet 192, around the non-magnetic ring 190, through the lamination ring 184, around the electric coils 198, 200, 202, and 204, through the SMC bodies 197, 199, 201, and 203, through the lamination ring 185, and back through the permanent magnet 192. The solid-steel rings 187 and 188 may, in some embodiments, facilitate flow of magnetic flux, through the permanent magnet 192, from the bias magnetic field as shown by the magnetic-field arrows 208. The non-magnetic ring 190 may, in some embodiments, create a magnetic-flux barrier to shape the bias magnetic field as shown by the magnetic-field arrows 208.

In general, the bias magnetic fields as shown by the magnetic-field arrows 207 and 208 create magnetic forces that are generally radial relative to the spin axis of rotation 128 and that attract the rotor 181 towards the stator 182 radially relative to the spin axis of rotation 128. Such attractive magnetic forces from the bias magnetic fields as shown by the magnetic-field arrows 207 and 208 may be uniform or similar around the spin axis of rotation 128, so the rotor 181 and the stator 182 therefore may function as a radial magnetic bearing (that may be known as a homopolar magnetic bearing) that may align the spin axis of rotation 128 to the central-rotation axis 141.

Referring to FIG. 14, to FIG. 15, and to FIG. 16, when an electric current passes through the electric coil 198 in a clockwise direction from the perspective of the central-rotation axis 141 (or clockwise in the orientation of FIG. 16), and when an electric current passes through the electric coil 202 in a counter-clockwise direction from the perspective of the central-rotation axis 141,
1. control magnetic fields as shown by magnetic-field arrows 209 and 210 pass around the electric coil 198, through the SMC bodies 197, through the lamination ring 183, through the SMC bodies 201, around the electric coil 202, through the lamination ring 184, and back around the electric coil 198, and
2. control magnetic fields as shown by magnetic-field arrows 211 and 212 pass around the electric coil 198, through the SMC bodies 197, through the lamination ring 185, through the SMC bodies 201, around the electric coil 202, through the lamination ring 184, and back around the electric coil 198.

As shown in FIG. 14, in the annular-sector stator body 193, the control magnetic fields as shown by the magnetic-field arrows 209 and 211 are in the same direction as the bias magnetic fields as shown by the magnetic-field arrows 207 and 208, so the control magnetic fields as shown by the magnetic-field arrows 209 and 211 complement or enhance the bias magnetic fields as shown by the magnetic-field arrows 207 and 208 in the annular-sector stator body 193 and strengthen the magnetic attraction of the rotor 181 towards the annular-sector stator body 193 of the stator 182.

As also shown in FIG. 14, in the annular-sector stator body 195, the control magnetic fields as shown by the magnetic-field arrows 209 and 211 are in an opposite direction from the bias magnetic fields as shown by the magnetic-field arrows 207 and 208, so the control magnetic fields as shown by the magnetic-field arrows 209 and 211 counter or diminish the bias magnetic fields as shown by the magnetic-field arrows 207 and 208 in the annular-sector stator body 195 and weaken the magnetic attraction of the rotor 181 towards the annular-sector stator body 195 of the stator 182.

As a result, when an electric current passes through the electric coil 198 in a clockwise direction from the perspective of the central-rotation axis 141 (or clockwise in the orientation of FIG. 16), and when an electric current passes through the electric coil 202 in a counter-clockwise direction from the perspective of the central-rotation axis 141, the electric coils 198 and 202 cause a net magnetic force 213 radially towards the annular-sector stator body 193, so the rotor 181 and the stator 182 therefore may function as an active radial magnetic bearing (that may be known as an e-core active radial magnetic bearing) having radial forces controllable at least in part by controlling electric currents through the electric coils 198 and 202.

If directions of the electric currents through the electric coils 198 and 202 are reversed from the directions described in the example above, then the electric currents would cause a net magnetic force opposite the net magnetic force 213 and radially towards the annular-sector stator body 195. Further, the example described above involves electric currents through the electric coils 198 and 202, but similar radial forces towards or away from the annular-sector stator bodies 194 and 196 may be controlled at least in part by controlling electric currents through the electric coils 200 and 204.

In general, diametrically opposed electric coils may cooperate to control radial magnetic forces. Therefore, in some embodiments, the electric coils 198 and 202 may be electrically connected to each other, the electric coils 200 and 204 may be electrically connected to each other, and the roll-stabilizer controller 109 (also shown in FIG. 1) may control electric current through the electric coils 198 and 202 independently from electric current through the electric coils 200 and 204.

In some embodiments, an e-core active radial magnetic bearing as described above may involve shorter paths for magnetic flux than other homopolar active magnetic bearings, so an e-core active radial magnetic bearing as described above may involve less material and be smaller than other homopolar active magnetic bearings.

The stator 182 is an example only, and alternative embodiments may differ. For example, an alternative embodiment may include more or fewer annular-sector stator bodies. Further, alternative embodiments may include more or fewer components, or one or more alternatives to the components described above. For example, an alternative embodiment may include materials that differ from the materials described above. As one example, alternative embodiments may include sets of laminations aligned in a radial direction instead of the SMC bodies. Also, an alternative embodiment may include more or fewer magnets than the embodiment described above.

### Axial Magnetic Bearing

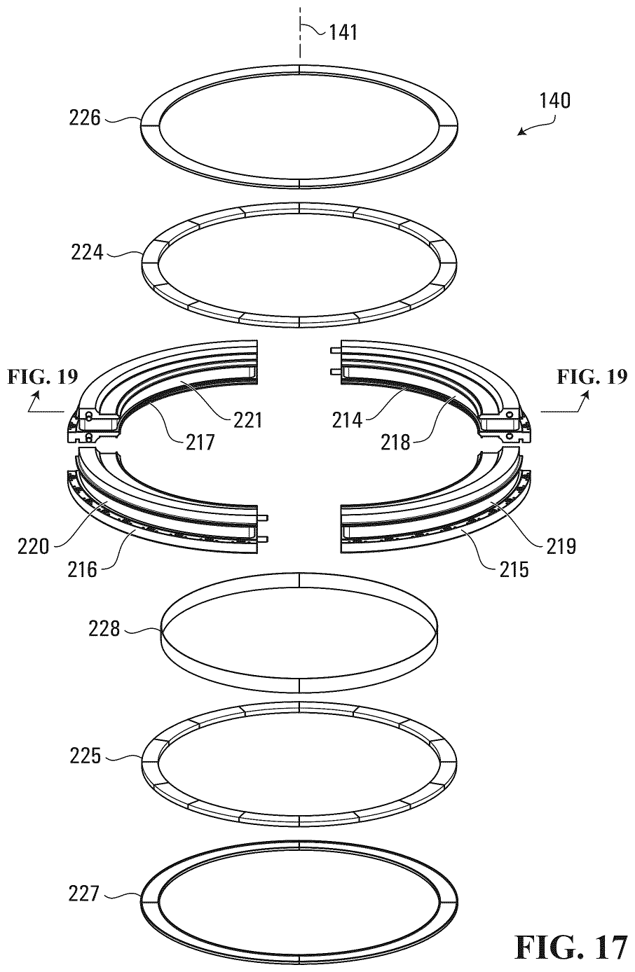

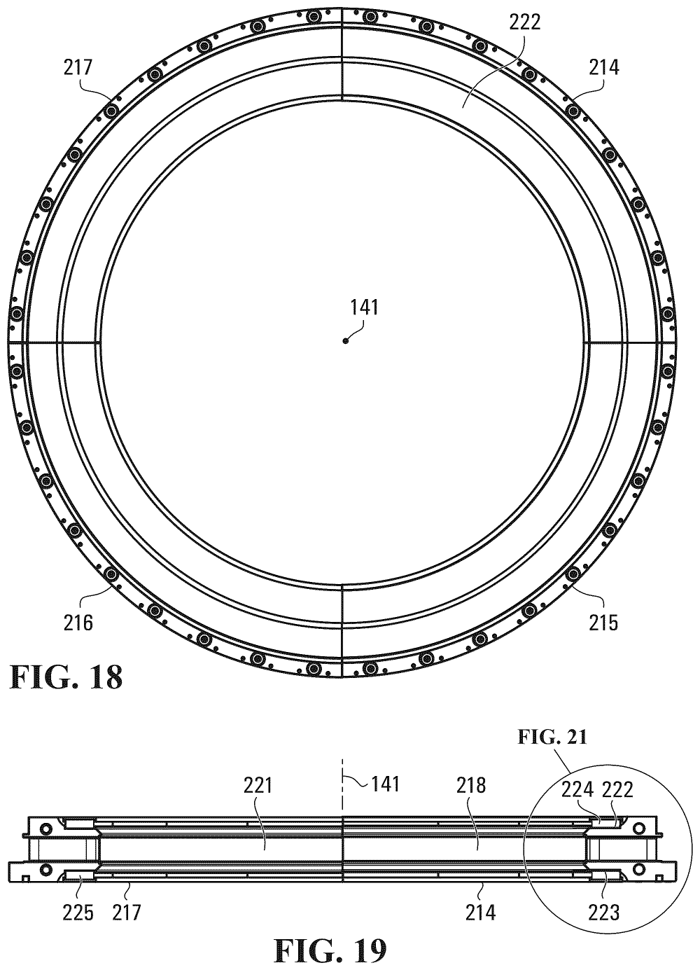

Referring to FIG. 17, the axial active magnetic bearing 140 includes four annular-sector bodies 214, 215, 216, and 217, which may be made from steel. When assembled as shown in FIGS. 18 and 19, the annular-sector bodies 214, 215, 216, and 217 collectively form an annular bearing body having a plurality of annular sectors surrounding the central-rotation axis 141. The sectors may be overlapping in some embodiments.

The annular-sector body 214 includes an electric coil 218. The electric coil 218 includes an electric conductor coiled around an axis parallel to the central-rotation axis 141 (or, more generally, extending transversely to the central-rotation axis 141) such that when an electric current passes through the electric coil, the electric coil magnetizes the annular-sector body 214 in a direction along such an axis parallel to the central-rotation axis 141. The annular-sector body 214 and the electric coil 218 thus function as an electromagnet positioned on the annular bearing body in one of the annular sectors of the annular bearing body.

The annular-sector body 215 includes an electric coil 219. The electric coil 219 includes an electric conductor coiled around an axis parallel to the central-rotation axis 141 (or, more generally, extending transversely to the central-rotation axis 141) such that when an electric current passes through the electric coil, the electric coil magnetizes the annular-sector body 215 in a direction along such an axis parallel to the central-rotation axis 141. The annular-sector body 215 and the electric coil 219 thus function as an electromagnet positioned on the annular bearing body in one of the annular sectors of the annular bearing body.

The annular-sector body 216 includes an electric coil 220. The electric coil 220 includes an electric conductor coiled around an axis parallel to the central-rotation axis 141 (or, more generally, extending transversely to the central-rotation axis 141) such that when an electric current passes through the electric coil, the electric coil magnetizes the annular-sector body 216 in a direction along such an axis parallel to the central-rotation axis 141. The annular-sector body 216 and the electric coil 220 thus function as an electromagnet positioned on the annular bearing body in one of the annular sectors of the annular bearing body.

The annular-sector body 217 includes an electric coil 221. The electric coil 221 includes an electric conductor coiled around an axis parallel to the central-rotation axis 141 (or, more generally, extending transversely to the central-rotation axis 141) such that when an electric current passes through the electric coil, the electric coil magnetizes the annular-sector body 217 in a direction along such an axis parallel to the central-rotation axis 141. The annular-sector body 217 and the electric coil 221 thus function as an electromagnet positioned on the annular bearing body in one of the annular sectors of the annular bearing body.

The electric coils 218, 219, 220, and 221 are electrically connected to the roll-stabilizer energy-storage device 110 (either directly or indirectly, such as indirectly through the roll-stabilizer controller 109) and may receive electric current from the roll-stabilizer energy-storage device 110 (shown in FIG. 1), and the roll-stabilizer controller 109 (also shown in FIG. 1) may control electric current through each of the electric coils 218, 219, 220, and 221 independently such that electric current through one of the electric coils 218, 219, 220, and 221 may be independent from electric current through one, more than one, or all of the others of the electric coils 218, 219, 220, and 221.

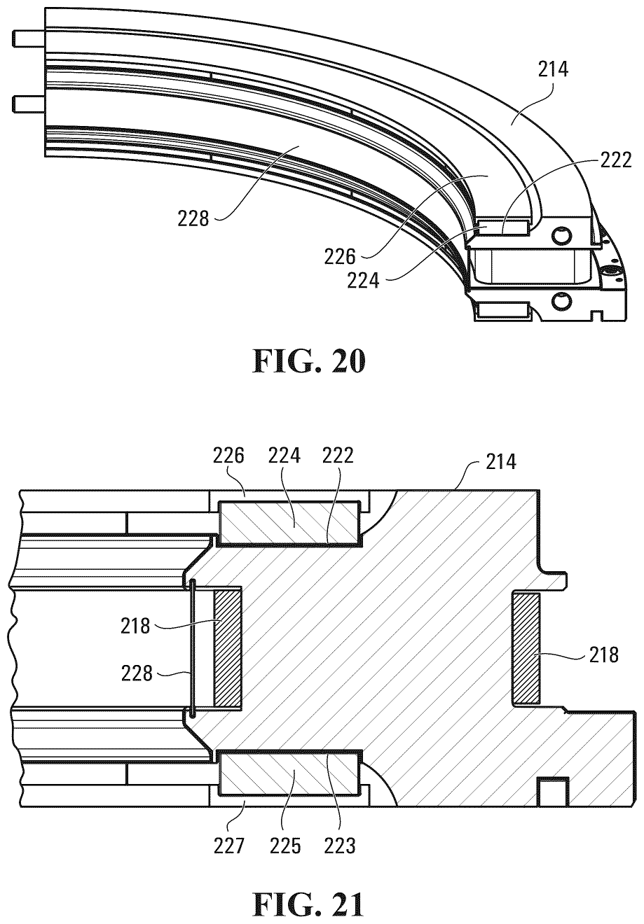

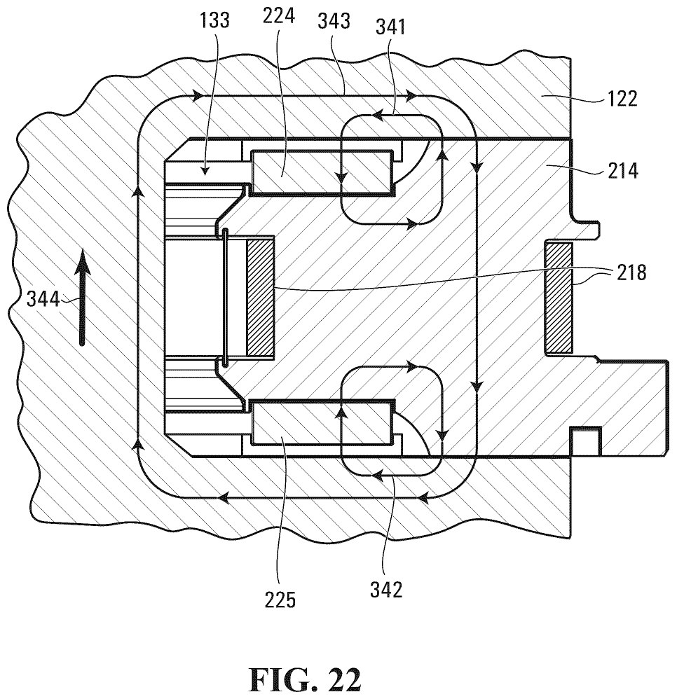

Referring to FIG. 20, to FIG. 21, and to FIG. 22, the annular-sector body 214 is illustrated, and the annular-sector bodies 215, 216, and 217 are similar to the annular-sector body 214. The annular-sector body 214 has an annular-sector surface 222 on one side, along an axis parallel to the central-rotation axis 141, of the electric coil 218, and an annular-sector surface 223 on an opposite side, along the axis parallel to the central-rotation axis 141, of the electric coil 218 from the annular-sector surface 222. An annular permanent magnet 224 may be positioned against annular-sector surfaces (such as the annular-sector surface 222) on one side of the electric coil 218 along an axis parallel to the central-rotation axis 141, and an annular permanent magnet 225 may be positioned against annular-sector surfaces (such as the annular-sector surface 223) on an opposite side of the electric coil 218 from the annular-sector surface 222 along the axis parallel to the central-rotation axis 141.

The annular permanent magnets 224 and 225 are magnetized in opposite directions along the central-rotation axis 141 (shown in FIG. 17) such that the annular permanent magnet 224 creates a bias magnetic field through the flywheel body 122 and through the annular-sector body 214 as shown by magnetic-field arrows 341 in FIG. 22, and the annular permanent magnet 225 creates a bias magnetic field through the flywheel body 122 and through the annular-sector body 214 as shown by magnetic-field arrows 342 in FIG. 22. Also, when an electric current passes through the electric coil 218, a control magnetic field as shown by magnetic-field arrows 343 in FIG. 22 passes through the flywheel body 122 and through the annular-sector body 214. As shown in FIG. 22, the control magnetic field as shown by the magnetic-field arrows 343 is in an opposite direction from the bias magnetic field as shown by the magnetic-field arrows 341 and in the same direction as the bias magnetic field as shown by the magnetic-field arrows 342, so the bias magnetic fields shown by magnetic-field arrows 342 and 343 and the control magnetic field as shown by the magnetic-field arrows 343 create a magnetic force 344 that is generally axial relative to the spin axis of rotation 128 and that attracts the rotor 123 upwards. However, alternative embodiments may include one or more electromagnets or other magnets additionally or alternatively to one or both of the permanent magnets 224 and 225. Further, the magnetization directions of the permanent magnets 224 and 225, and the control magnetic field as shown by the magnetic-field arrows 343, as shown in FIG. 22 are examples only, and the magnetization directions and magnetic fields may be opposite or otherwise different in other embodiments.

Referring to FIG. 17 and to FIG. 21, the axial active magnetic bearing 140 also includes a solid-steel ring 226 (which may be formed from four pieces as shown) on the annular permanent magnet 224 such that the annular permanent magnet 224 is between the annular-sector body 214 and the solid-steel ring 226. The axial active magnetic bearing 140 also includes a solid-steel ring 227 on the annular permanent magnet 225 such that the annular permanent magnet 225 is between the annular-sector body 214 and the solid-steel ring 227. The annular permanent magnets 224 and 225 may be segmented, which may create some discontinuities in magnetic flux density, so the solid-steel rings 226 and 227 may, in some embodiments, more uniformly distribute magnetic flux density between the annular-sector bodies 214, 215, 216, and 217 and the flywheel body 122. The axial active magnetic bearing 140 also includes a wire shield 228 between the electric coils 218, 219, 220, and 221 and the central-rotation axis 141 such that the wire shield 228 may retain and protect the electric coils 218, 219, 220, and 221.

Referring now to FIG. 22, when the roll-stabilizer apparatus 108 is assembled as shown in FIG. 3, at least a portion of the axial active magnetic bearing 140 may be positioned in the groove 133 so that magnetic fields produced by the axial active magnetic bearing 140 may exert axial forces on the flywheel body 122 to maintain the flywheel assembly 115 away from the touchdown bearings in the touchdown-bearing assemblies 125 and 126. In some embodiments, positioning the axial active magnetic bearing 140 in the groove 133 may permit a more-compact roll-stabilizer apparatus 108 when compared to other roll-stabilizer apparatuses having similar capacities for roll stabilization.

The groove 133, the solid-steel ring 226, and the annular-sector bodies 214, 215, 216, and 217 may be sized and positioned such that a gap (which may be an air gap in some embodiments) is between: the flywheel body 122 and the solid-steel ring 226; and the annular-sector bodies 214, 215, 216, and 217. Such a gap may facilitate generation of magnetic forces as described herein, for example.

The axial active magnetic bearing 140 is an example only, and alternative embodiments may differ. For example, the electromagnets of the axial active magnetic bearing 140 are in four annular sectors, but alternative embodiments may include more or fewer annular sectors. The number of sectors may be an even number in some embodiments. Further, in alternative embodiments, the annular sectors may not be equal to each other in size but rather may differ in size from each other. More generally, alternative embodiments may include more or fewer components, or one or more alternatives to the components described above. For example, an alternative embodiment may include materials that differ from the materials described above. Also, an alternative embodiment may include more or fewer magnets than the embodiment described above. Some alternative embodiments may include more than one axial magnet bearing, and may include stacks of axial magnetic bearings to increase axial force and/or torque output.

Torque from Axial Magnetic Bearing

In some embodiments, the axial active magnetic bearing 140 may apply a torque to the flywheel assembly 115, for example to complement a radial magnetic bearing including the rotor 123 and the stator 138, a radial magnetic bearing including the rotor 124 and the stator 139, or both, or more generally to function similarly to one or more radial bearings.

For example, one or more electric coils on a first side of the axial active magnetic bearing 140 may produce one or more magnetic fields that differ from one or more magnetic fields produced by one or more electric coils on a second side of the axial active magnetic bearing 140 opposite the first side of the axial active magnetic bearing 140. For example, one side of the axial active magnetic bearing 140 may include the electric coils 218 and 219, and an opposite side of the axial active magnetic bearing 140 may include the electric coils 220 and 221. As another example, one side of the axial active magnetic bearing 140 may include the electric coils 219 and 220, and an opposite side of the axial active magnetic bearing 140 may include the electric coils 218 and 221.

The one or more magnetic fields produced by the one or more electric coils on one side of the axial active magnetic bearing 140 may differ from the one or more magnetic fields produced by the one or more electric coils on an opposite side of the axial active magnetic bearing 140 in direction, in strength, or in both. Such different magnetic fields may cause the axial active magnetic bearing 140 to exert, in addition to any net axial force on the flywheel body 122, torque on the flywheel body 122 (and thus on the flywheel assembly 115) around an axis between the two sides of the axial active magnetic bearing 140 as described above, for example.

In some embodiments, because the axial active magnetic bearing 140 may apply a torque to the flywheel assembly 115, other radial bearings may be smaller, and the roll-stabilizer apparatus 108 may better control positions of the flywheel assembly 115 in the flywheel-support body 113. For example, the roll-stabilizer apparatus 108 may experience significant external forces, and the axial active magnetic bearing 140 functioning as a radial bearing may, in some embodiments, allow the roll-stabilizer apparatus 108 to accommodate such external forces.

### Wire Guide

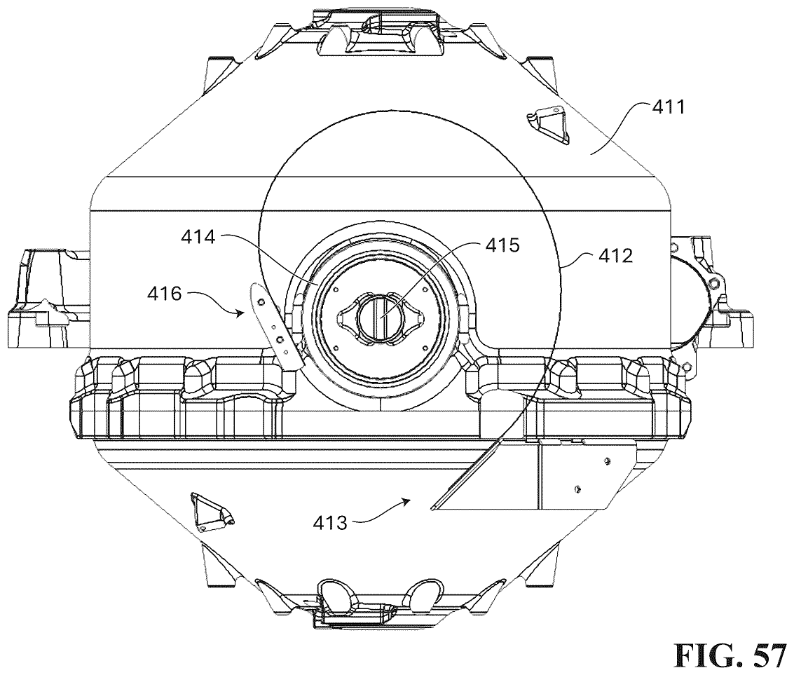

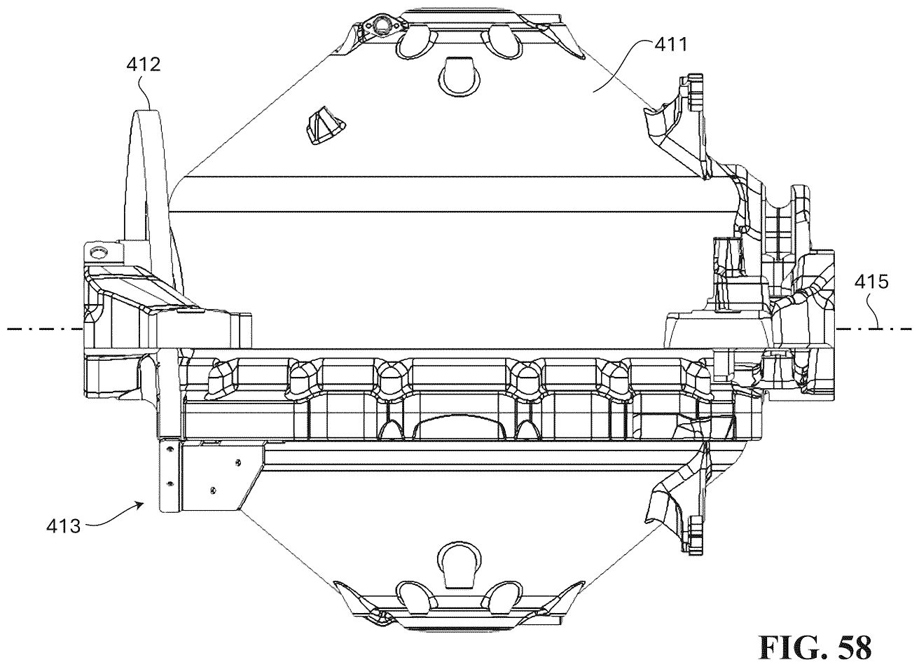

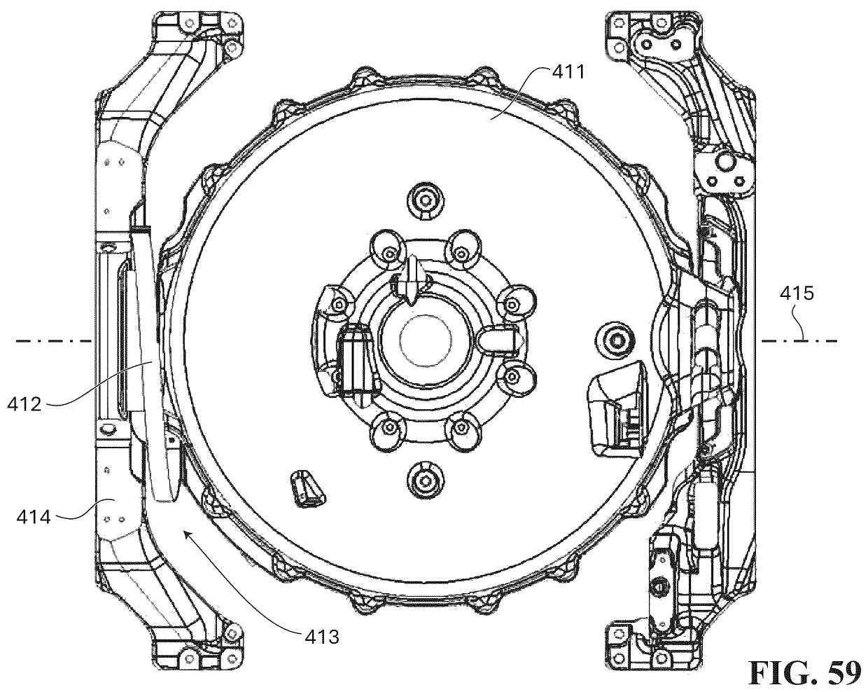

FIGS. 57, 58, and 59 illustrate a flywheel-support body 411 according to one embodiment. The flywheel-support body 411 may be similar to a flywheel-support body as described herein, for example. A wire guide 412 includes one or more wires extending between a mounting body 414 (that may be similar to a mounting body as described herein, for example) and the flywheel-support body 411. FIG. 57 shows a portion of the mounting body 414, which is shown more fully in FIG. 59. Stringers under the mounting body 414 may attach the mounting body 414 to a hull or other structure of a marine vessel. The flywheel-support body 411 is rotatable relative to the mounting body 414 around a precession axis of rotation 415.

The one or more wires of the wire guide 412 may convey electrical power to one or more electric motors inside the flywheel-support body 411, receive electrical power from one or more electric generators inside the flywheel-support body 411, receive signals from one or more sensors inside the flywheel-support body 411, transmit control signals to one or more motor drivers or sensors inside or on the flywheel-support body 411, or two or more thereof, for example.

The wire guide 412 is attached or attachable to the flywheel-support body 411 at a location shown generally at 413 and is attached or attachable to the mounting body 414 at a location shown generally at 416. The location 413 is spaced apart from the location 416 along the precession axis of rotation 415. The wire guide 412 curves around the precession axis of rotation 415 between the location 416 and the location 413. The location 413 is, or is positioned to be, between the flywheel-support body and the mounting body 414. The location 416 is above at least a portion of the mounting body 414. The location 416 overlaps at least partially along the precession axis of rotation 415 with a bearing supporting the flywheel-support body for rotation around the precession axis of rotation 415 relative to the mounting body 414.

### Operation

Referring back to FIG. 1, to FIG. 2, and to FIG. 3, the roll-stabilizer assembly 107 may be attached to the hull 101 directly or indirectly such that the precession axis of rotation 119 is not parallel to the longitudinal axis 106. In some embodiments, the precession axis of rotation 119 may extend horizontally and perpendicular to the longitudinal axis 106, namely transversely relative to the hull 101. However, alternative embodiments may differ. For example, in some embodiments, the precession axis of rotation 119 may extend vertically or in another direction that is not parallel (and that may be perpendicular) to the longitudinal axis 106 of the marine vessel 100.

In operation, the electric motor/generator 142 may apply a torque to the flywheel assembly 115 (and thus to the flywheel body 122) around the spin axis of rotation 128 relative to the flywheel-support body 113, which may cause the flywheel assembly 115 to spin around the spin axis of rotation 128 relative to the flywheel-support body 113, thus causing the flywheel assembly 115 to have angular momentum along the spin axis of rotation 128.

In general, when waves or other external forces apply torque to the marine vessel 100, the hull 101 (and thus the mounting body 114) may rotate or roll around a roll axis (which may be close to the longitudinal axis 106). Such rotation of the mounting body 114 around the roll axis causes the flywheel-support body 113 (and thus the flywheel body 122) to rotate around the roll axis, and conservation of angular momentum of the flywheel body 122 causes the flywheel body 122 (and thus the flywheel-support body 113) to precess relative to the mounting body 114 around the precession axis of rotation 119 in response to such rotation of the flywheel body 122 around the roll axis. Such precession of the flywheel body 122 relative to an intertial reference frame, and around the precession axis of rotation 119, causes a torque to be exerted by the flywheel body 122 (and thus by the flywheel-support body 113 and the mounting body 114) on the hull 101 in a direction opposite the rotation of the hull 101 (and thus the mounting body 114) around the roll axis. The angular momentum of the flywheel body 122 may thus resist the rotation of the hull 101 (and thus the mounting body 114) around the roll axis, and the roll-stabilizer apparatus 108 may stabilize the marine vessel 100 by resisting roll around the roll axis. However, other torques and movements may arise, for example in response to yaw or pitch motion of the hull 101.

When the flywheel assembly 115 is being prepared to spin, or is spinning, around the spin axis of rotation 128 relative to the flywheel-support body 113, the roll-stabilizer controller 109 may, in response to, at least, one or more signals indicating measurements of proximity or position of the flywheel assembly 115 in the flywheel-support body 113 from one or more proximity sensors, one or more position sensors, or both as described above, control electric currents through one or more of the electric coils 157, 164, 165, 166, 168, 169, 170, 171, 198, 200, 202, 204, 218, 219, 220, and 221, as described herein for example, to maintain the spin axis of rotation 128 along the central-rotation axis 141 (or along any other axis that may be desired as described below, for example) and to maintain the flywheel assembly 115 away from the touchdown bearings in the touchdown-bearing assemblies 125 and 126.

As indicated above, the rotor 123 and the stator 138 may function as a magnetic bearing. As also indicated above, the rotor 124 may be similar to the rotor 123, and the stator 139 may be similar to the stator 138. Therefore, the rotor 124 and the stator 139 may also function as a magnetic bearing. As also indicated above, the rotor 181 may be an alternative to the rotor 123, and the stator 182 may be an alternative to the stator 138, so the rotor 181 and the stator 182 may also function as a magnetic bearing. The axial active magnetic bearing 140 is also a magnetic bearing.

In some embodiments, such magnetic bearings may allow the flywheel assembly 115 to spin around the spin axis of rotation 128 relative to the flywheel-support body 113 with less friction when compared to other types of bearings. Such reduced friction may, in some embodiments, allow the flywheel assembly 115 to spin around the spin axis of rotation 128 relative to the flywheel-support body 113 with less power to the electric motor/generator 142 and with less cooling than a roll-stabilizer apparatus having other types of bearings. Further, in some embodiments, magnetic bearings such as those described herein may last longer than other bearings (such as mechanical bearings) and reduce or avoid cumbersome replacement of worn bearings. Also, in some embodiments, magnetic bearings such as those described herein may vibrate less and generate less noise than such other bearings, and may tolerate higher operating temperatures than such other bearings. Overall, the roll-stabilizer apparatus 108 may, in some embodiments, have a longer usable life or require less maintenance than a roll-stabilizer apparatus having other types of bearings.

Also, magnetic bearings such as those described herein may, in some embodiments, permit the flywheel assembly 115 to spin around the spin axis of rotation 128 relative to the flywheel-support body 113 faster than a roll-stabilizer apparatus having other types of bearings. Such faster spin of the flywheel assembly 115 around the spin axis of rotation 128 relative to the flywheel-support body 113 may, in some embodiments, permit, when compared to a roll-stabilizer apparatus having other types of bearings, greater angular momentum (and therefore greater capacity for roll stabilization) for the same mass of the flywheel assembly 115, or similar angular momentum (and therefore similar capacity for roll stabilization) for a reduced mass of the flywheel assembly 115. Therefore, the roll-stabilizer apparatus 108 may have a reduced mass compared to a roll-stabilizer apparatus having other types of bearings but similar capacity for roll stabilization.

When the roll-stabilizer apparatus 108 is not in operation, and in case such magnetic bearings are insufficient or fail for some reason, the touchdown bearings in the touchdown-bearing assemblies 125 and 126 may constrain movement of the flywheel assembly 115 relative to the flywheel-support body 113 to reduce or avoid any possible damage to the flywheel assembly 115 or to the flywheel-support body 113 from excessive movement of the flywheel assembly 115 relative to the flywheel-support body 113.

### Startup

In general, “startup” may refer to a process that involves controlling electric currents through electric coils to maintain the spin axis of rotation 128 along (namely colinear with, or close to but not necessarily colinear with) the central-rotation axis 141 and to maintain the flywheel assembly 115 away from the touchdown bearings in the touchdown-bearing assemblies 125 and 126, and that involves causing the flywheel assembly 115 (and thus the flywheel body 122) to spin around the spin axis of rotation 128 relative to the flywheel-support body 113 until the flywheel assembly 115 reach a threshold minimum angular speed or angular momentum for roll stabilization.

In some embodiments, the remote device 112 may be used to initiate such startup by transmitting one or more wired, wireless, or other signals directly or indirectly to the roll-stabilizer controller 109 to indicate initiation of startup. For example, an application may be installed on the remote device 112 that causes remote device 112 to transmit one or more signals directly or indirectly to the roll-stabilizer controller 109. Startup may take some time because the flywheel assembly 115 may take some time to reach the threshold minimum angular speed or angular momentum for roll stabilization. Therefore, remote initiation may allow for remote initiation of startup, which may reduce or avoid time spent waiting for the flywheel assembly 115 to reach the threshold minimum angular speed or angular momentum for roll stabilization. Further, remote initiation may allow for a slower startup and thus reduced electrical power during startup.

### Remote Diagnostics

The remote device 112 may also receive one or more wired, wireless, or other signals directly or indirectly from the roll-stabilizer controller 109 to indicate diagnostic information regarding the roll-stabilizer assembly 107. Such diagnostic information may include, for example, operation status, a time when the flywheel assembly 115 (and thus the flywheel body 122) is predicted to reach a threshold minimum angular speed or angular momentum for roll stabilization, a battery charge or other condition of the roll-stabilizer energy-storage device 110, one or more indications of any faults, or a combination of two or more thereof. For example, an application may be installed on the remote device 112 that causes remote device 112 to indicate such diagnostic information in response to one or more wired, wireless, or other signals received by the remote device 112 directly or indirectly from the roll-stabilizer controller 109.

In some embodiments, such remote diagnostics may permit more-efficient maintenance or reductions in required maintenance, easier diagnosis by a manufacturer or maintenance provider, and possible remote maintenance to reduce or avoid time required for in-person maintenance.

### Energy Management

As indicated above, the electric motor/generator 142 is electrically connected to the roll-stabilizer energy-storage device 110, which is distinct from the main energy-storage device 105 in the embodiment shown (although alternative embodiments may differ). As also indicated above, the electric coils 157, 164, 165, 166, 168, 169, 170, 171, 198, 200, 202, 204, 218, 219, 220, and 221 are also electrically connected to the roll-stabilizer energy-storage device 110 (either directly or indirectly, such as indirectly through the roll-stabilizer controller 109) and may receive electric current from the roll-stabilizer energy-storage device 110. The electric energy used by the electric motor/generator 142 and by the electric coils 157, 164, 165, 166, 168, 169, 170, 171, 198, 200, 202, 204, 218, 219, 220, and 221 is used for roll stabilization. The electric motor/generator 142 may also provide electric energy to the roll-stabilizer controller 109 or to the inertial measurement unit 111 or otherwise provide electric energy for roll stabilization.

Therefore, energy stored by the roll-stabilizer energy-storage device 110 may be for roll stabilization. In some embodiments, energy stored by the roll-stabilizer energy-storage device 110 is only for one or more such roll-stabilization functions and unavailable for functions other than roll-stabilization, such as for a starter motor of the marine engine 104, for the marine engine 104 if the marine engine 104 includes an electric motor, or for other functions such as for navigation or lights, for example.

In some embodiments, the roll-stabilizer energy-storage device 110, distinct from the main energy-storage device 105, may reduce power draws on the main energy-storage device 105 when the electric motor/generator 142 is apply a torque to the flywheel assembly 115 (and thus to the flywheel body 122) around the spin axis of rotation 128 relative to the flywheel-support body 113.

Further, in some embodiments, the roll-stabilizer energy-storage device 110, distinct from the main energy-storage device 105, may provide greater electrical power than the main energy-storage device 105. In some embodiments, such greater electrical power may permit greater torque and therefore greater acceleration of flywheel assembly 115 (and thus to the flywheel body 122) around the spin axis of rotation 128 relative to the flywheel-support body 113, which may prepare the roll-stabilizer apparatus 108 for roll stabilization faster than other roll-stabilizer apparatuses that omit the roll-stabilizer energy-storage device 110.

Further, in some embodiments, the roll-stabilizer energy-storage device 110, distinct from the main energy-storage device 105, may facilitate recovery of rotational kinetic energy, from rotation of the flywheel assembly 115 (and thus from the flywheel body 122) around the spin axis of rotation 128 relative to the flywheel-support body 113, by converting such rotational kinetic energy to electrical energy and storing such electrical energy in the roll-stabilizer energy-storage device 110. Such recovery of rotational kinetic energy may be more difficult or impossible in other roll-stabilizer apparatuses that omit the roll-stabilizer energy-storage device 110. Further, such recovery of rotational kinetic energy may, in some embodiments, generate less heat than other roll-stabilizer apparatuses that omit the roll-stabilizer energy-storage device 110, so the roll-stabilizer apparatus 108 may require less cooling than a roll-stabilizer apparatus that does not recover of rotational kinetic energy.

### Eddy-Current Brake

As indicated above, the electric motor/generator 142 may convert rotational kinetic energy, from rotation of the flywheel assembly 115 (and thus from the flywheel body 122) around the spin axis of rotation 128 relative to the flywheel-support body 113, to electrical energy, and the electric motor/generator 142 may therefore function as a brake.

However, in some situations, further braking forces may be desired. In such cases, the roll-stabilizer controller 109 may cause at least some of the electric coils 218, 219, 220, and 221 (shown in FIG. 17) to produce different magnetic fields, for example by causing respective electric currents through at least some of the electric coils 218, 219, 220, and 221 to differ.

For example, the roll-stabilizer controller 109 may cause the electric coils 218 and 220 to produce magnetic fields in a first direction along an axis parallel to the central-rotation axis 141 while causing the electric coils 219 and 221 to produce magnetic fields in a second direction opposite the first direction along the axis parallel to the central-rotation axis 141. As another example, the roll-stabilizer controller 109 may cause the electric coils 218 and 220 to produce magnetic fields having a first strength while causing the electric coils 219 and 221 to produce magnetic fields having a second strength different from the first strength. In some embodiments, magnetic fields produced by some or all of the electric coils 218, 219, 220, and 221 may, in a direction around the central-rotation axis 141, alternate between two different types of magnetic fields. For example, magnetic fields produced by some or all of the electric coils 218, 219, 220, and 221 may, in a direction around the central-rotation axis 141, alternate between different directions, different strengths, or both.

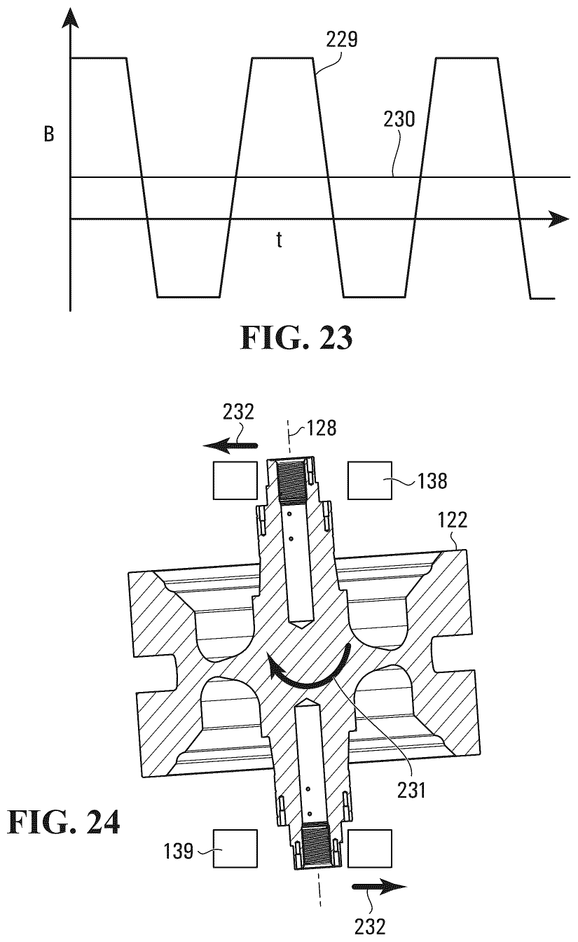

When the flywheel body 122 is rotating around the spin axis of rotation 128 relative to the flywheel-support body 113, and when the roll-stabilizer controller 109 causes at least some of the electric coils 218, 219, 220, and 221 to produce different magnetic fields, a point on the flywheel body 122 may experience changes in magnetic field over time. In FIG. 23, a line 229 illustrates an example of changes over time (indicated by t in FIG. 23) in magnetic field (indicated by B in FIG. 23) experienced by a point on the flywheel body 122 when the flywheel body 122 is rotating around the spin axis of rotation 128 relative to the flywheel-support body 113 and when the roll-stabilizer controller 109 causes at least some of the electric coils 218, 219, 220, and 221 to produce different magnetic fields, and a line 230 illustrates an average magnetic field over a period of time when the flywheel body 122 is rotating around the spin axis of rotation 128 relative to the flywheel-support body 113 and when the roll-stabilizer controller 109 causes at least some of the electric coils 218, 219, 220, and 221 to produce different magnetic fields.

Such changes over time in magnetic field, as illustrated by the line 229 for example, may induce eddy currents in the flywheel body 122, which may result in a torque on the flywheel body 122 (and thus on the flywheel assembly 115) in a direction opposite a direction of rotation of the flywheel body 122 is rotating around the spin axis of rotation 128 relative to the flywheel-support body 113. Therefore, by causing at least some of the electric coils 218, 219, 220, and 221 to produce different magnetic fields, the roll-stabilizer controller 109 may cause the axial active magnetic bearing 140 to function as an eddy-current brake.

Such an eddy-current brake may, in some embodiments, allow for fast braking when desired. Also, such an eddy-current brake may, in some embodiments, reduce or avoid wear on physical brakes, or allow physical brakes to be reduced in size, simplified, or avoided altogether. Also, in some embodiments, heat generated from such an eddy-current brake may be absorbed by the flywheel body 122, which may be able to accommodate such heat better than other components of the roll-stabilizer apparatus 108.

### Movement Estimation and Prediction

As indicated above, measurements of linear acceleration, of rotational acceleration, of orientation, or a combination of two or more thereof, relative to an inertial frame of reference or another frame of reference, of the hull 101 by the inertial measurement unit 111 may indicate such acceleration, orientation, or both of the mounting body 114 relative to such a frame of reference. In some embodiments, the roll-stabilizer controller 109 may estimate, predict, or both movement of the hull 101, of the mounting body 114, of one or more other locations on the marine vessel 100, or of a combination of two or more thereof, relative to an inertial frame of reference or another frame of reference, for example in response to, at least, one or more signals indicating measurements (by the inertial measurement unit 111 shown in FIG. 1, for example) of linear acceleration, of rotational acceleration, of orientation, or of two or more thereof of the hull 101 relative to such a frame of reference. In some embodiments, such movement estimation, movement prediction, or both may involve an open-loop system of the roll-stabilizer controller 109, at least one predictive model of the roll-stabilizer controller 109, a time history of measurements, or two or more thereof, for example. For example, such prediction or estimation may involve analysis or consideration of measurements of acceleration, velocity, or both by the inertial measurement unit 111.

For example, in response to, at least, one or more signals indicating measurements by the inertial measurement unit 111, the roll-stabilizer controller 109 may detect periodic movement (for example, from waves causing roll of the hull 101) of the hull 101, of the mounting body 114, of one or more other locations on the marine vessel 100, or of a combination of two or more thereof, relative to an inertial frame of reference or another frame of reference, and predicted movement may be movement of the hull 101, of the mounting body 114, of one or more other locations on the marine vessel 100, or of a combination of two or more thereof, relative to such a frame of reference and according to such detected periodic movement. Such movement may include roll of the hull 101 around the longitudinal axis 106 or other movement such as linear or other rotational movement, and such movement may not necessarily be periodic.

In general, movement of the hull 101, of the mounting body 114, of one or more other locations on the marine vessel 100, relative to an inertial frame of reference or another frame of reference, may cause precession of the flywheel assembly 115 relative to the flywheel-support body 113 and relative to the mounting body 114. Therefore, when the roll-stabilizer controller 109 predicts movement of the hull 101, of the mounting body 114, of one or more other locations on the marine vessel 100, or of a combination of two or more thereof, relative to an inertial frame of reference or another frame of reference, the roll-stabilizer controller 109 may also predict resulting precession of the flywheel assembly 115 relative to the flywheel-support body 113 and relative to the mounting body 114 in a predicted direction of precession.

Alternative embodiments may differ and may, for example, estimate or predict movement of the hull 101, of the mounting body 114, of one or more other locations on the marine vessel 100, or of a combination of two or more thereof in other ways. For example, in some embodiments, movement of the hull 101, of the mounting body 114, of one or more other locations on the marine vessel 100, or of a combination of two or more thereof may be estimated or predicted using one or more measurements, relative to an inertial frame of reference or another frame of reference, of linear acceleration, of rotational acceleration, of orientation, or a combination of two or more thereof of the flywheel-support body 113.

### Flywheel Force, Torque, or Movement in Response to Predicted Movement

As indicated above, the roll-stabilizer controller 109 may, in response to, at least, one or more signals indicating measurements of proximity or position of the flywheel assembly 115 in the flywheel-support body 113 from one or more proximity sensors, one or more position sensors, or both as described above, control electric currents through one or more of the electric coils 157, 164, 165, 166, 168, 169, 170, 171, 198, 200, 202, 204, 218, 219, 220, and 221, as described herein for example, to maintain the spin axis of rotation 128 along a target axis, which may be colinear with the central-rotation axis 141 or close to but not necessarily colinear with the central-rotation axis 141, and to maintain the flywheel assembly 115 away from the touchdown bearings in the touchdown-bearing assemblies 125 and 126. However, in some embodiments, the roll-stabilizer controller 109 may control electric currents through one or more of the electric coils 157, 164, 165, 166, 168, 169, 170, 171, 198, 200, 202, 204, 218, 219, 220, and 221 in response to other measurements, detections, or predictions, such as acceleration, velocity, or both of the flywheel-support body 113 relative to inertial ground as measured by an inertial measurement unit similar to the inertial measurement unit 111, for example.

In general, movement of the hull 101, of the mounting body 114, of one or more other locations on the marine vessel 100, or of a combination of two or more thereof, relative to an inertial frame of reference or another frame of reference, may cause the flywheel-support body 113 to move relative to the flywheel assembly 115 in a direction of such movement. Therefore, in some embodiments, in response to, at least, predicting predicted movement of the hull 101, of the mounting body 114, of one or more other locations on the marine vessel 100, or of a combination of two or more thereof in a predicted direction relative to an inertial frame of reference or another frame of reference, the roll-stabilizer controller 109 may control electric currents through one or more of the electric coils 157, 164, 165, 166, 168, 169, 170, 171, 198, 200, 202, 204, 218, 219, 220, and 221 to cause at least one magnetic bearing to exert one or more forces, one or more torques, or both on, or to move, the flywheel assembly 115 (and thus the flywheel body 122) generally in the predicted direction of movement (for example, in the predicted direction of movement or in a direction close to the predicted direction of movement) relative to the flywheel-support body 113, for example to maintain the spin axis of rotation 128 along (namely colinear with, or close to but not necessarily colinear with) the central-rotation axis 141 and to maintain the flywheel assembly 115 away from the touchdown bearings in the touchdown-bearing assemblies 125 and 126. In some embodiments, the roll-stabilizer controller 109 may do so independently of any measurement of position of the flywheel assembly 115 or of the flywheel body 122 relative to the flywheel-support body 113.

Also, in general, rotation of the flywheel assembly 115 (and thus of the flywheel body 122), relative to an inertial frame of reference or another frame of reference, may cause the flywheel assembly 115 (and thus of the flywheel body 122) to move in a direction of precession relative to the flywheel-support body 113 and relative to the mounting body 114. Therefore, in some embodiments, in response to, at least, predicting predicted precession of the flywheel assembly 115 (and thus of the flywheel body 122) relative to the flywheel-support body 113 and relative to the mounting body 114 in a predicted direction of precession, the roll-stabilizer controller 109 may control electric currents through one or more of the electric coils 157, 164, 165, 166, 168, 169, 170, 171, 198, 200, 202, 204, 218, 219, 220, and 221 to cause at least one magnetic bearing to exert one or more forces, one or more torques, or both on, or to move, the flywheel assembly 115 (and thus the flywheel body 122) generally opposite the predicted direction of precession (for example, opposite the predicted direction of precession or in a direction close to opposite the predicted direction of precession) relative to the flywheel-support body 113 to maintain the spin axis of rotation 128 along (namely colinear with, or close to but not necessarily colinear with) the central-rotation axis 141 and to maintain the flywheel assembly 115 away from the touchdown bearings in the touchdown-bearing assemblies 125 and 126. In some embodiments, the roll-stabilizer controller 109 may do so independently of any measurement of position of the flywheel assembly 115 or of the flywheel body 122 relative to the flywheel-support body 113.

In some embodiments, such flywheel movement in response to predicted movement, predicted precession, or both may reduce undesired physical contact between the flywheel assembly 115 and the flywheel-support body 113.

### Negative Stiffness

Referring back to FIG. 3, to FIG. 10, to FIG. 11, and to FIG. 12, if the rotor 123 moves in a radial direction relative to the stator 138 such that the spin axis of rotation 128 is not along the central-rotation axis 141 within the rotor 123 and the stator 138, then magnetic forces created by the bias magnetic fields as shown by the magnetic-field arrows 144 are stronger on a side of the rotor 123 that is closer to the stator 138 and are weaker on a side of the rotor 123 that is farther from the stator 138, so magnetic forces will tend to attract the rotor 123 to the stator 138 towards the side of the rotor 123 that is closer to the stator 138.

The rotor 123 and the stator 138 are part of an example shown in FIG. 3, in FIG. 10, in FIG. 11, and in FIG. 12, but likewise if the rotor 124 moves in a radial direction relative to the stator 139 such that the spin axis of rotation 128 is not along the central-rotation axis 141 within the rotor 124 and the stator 139, magnetic forces will tend to attract the rotor 124 to the stator 139 towards the side of the rotor 124 that is closer to the stator 139. Likewise, if the rotor 181 moves in a radial direction relative to the stator 182 such that the spin axis of rotation 128 is not along the central-rotation axis 141 within the rotor 181 and the stator 182, magnetic forces will tend to attract the rotor 181 to the stator 182 towards the side of the rotor 181 that is closer to the stator 182.

Such tendencies may be referred to as “negative stiffness”, which may cause undesired contact between a rotor and a stator, or undesired misalignment of a rotor relative to a stator. However, in some embodiments, negative stiffness may facilitate alignment of the rotor 123 and the stator 138, alignment of the rotor 124 and the stator 139, alignment of the rotor 181 and the stator 182, or two or more thereof.

As indicated above, in some embodiments, in response to, at least, predicting the predicted movement of the mounting body 114, the roll-stabilizer controller 109 may control electric currents through one or more of the electric coils 157, 164, 165, 166, 168, 169, 170, 171, 198, 200, 202, 204, 218, 219, 220, and 221 to cause the at least one magnetic bearing to move the flywheel assembly 115 (and thus the flywheel body 122) in the predicted direction of movement, in the predicted direction of precession, or both relative to the flywheel-support body 113 to maintain the spin axis of rotation 128 along the central-rotation axis 141 and to maintain the flywheel assembly 115 away from the touchdown bearings in the touchdown-bearing assemblies 125 and 126. In some embodiments, the roll-stabilizer controller 109 may do so in response to predicted magnetic forces that result from such movement.

For example, referring to FIG. 24, the roll-stabilizer controller 109 may predict movement of the flywheel assembly 115 or of the flywheel body 122 relative to the flywheel-support body 113 in a predicted direction 231 different from a direction around the spin axis of rotation 128. In the example of FIG. 24, in response predicting predicted movement of the flywheel body 122 relative to the flywheel-support body 113 in the predicted direction 231, the roll-stabilizer controller 109 may cause at least one radial magnetic bearing (such as a radial magnetic bearing including the rotor 123 and the stator 138, a radial magnetic bearing including the rotor 124 and the stator 139, or both) to rotate the flywheel assembly 115 (and thus the flywheel body 122) relative to the flywheel-support body 113 in a direction as shown by arrows 232 and opposite the predicted direction 231 such that the flywheel body 122 is farther from the at least one radial magnetic bearing in the predicted direction than in a direction opposite the predicted direction 231.

Rotation of the flywheel assembly 115 (and thus the flywheel body 122) relative to the flywheel-support body 113 in the direction as shown by the arrows 232 may cause negative stiffness because magnetic forces in the radial magnetic bearings may tend to cause the flywheel assembly 115 (and thus the flywheel body 122) to rotate further relative to the flywheel-support body 113 in the direction as shown by the arrows 232. However, such negative stiffness may resist the predicted movement of the flywheel body 122 relative to the flywheel-support body 113 in the predicted direction 231 such that the radial magnetic bearings require less electric current, may be smaller, or may be simpler than would be required to resist the predicted movement of the flywheel body 122 relative to the flywheel-support body 113 in the predicted direction 231 without such negative stiffness.

In some embodiments, such negative stiffness may result from moving the flywheel assembly 115 (and thus the flywheel body 122) relative to the flywheel-support body 113
1. generally in a predicted direction of motion of the flywheel-support body 113, and
2. generally in a direction opposite a predicted direction of precession of the flywheel assembly 115 (and thus the flywheel body 122) relative to the flywheel-support body 113.

In some embodiments, negative stiffness as described above may facilitate alignment of the flywheel body 122 because the magnetic forces caused by the resulting negative stiffness may tend to resist the predicted movement of the flywheel assembly 115 (and thus of the flywheel body 122) relative to the flywheel-support body 113 and require less electric current through one or more of the electric coils 157, 164, 165, 166, 168, 169, 170, 171, 198, 200, 202, 204, 218, 219, 220, and 221 to control positions of the flywheel assembly 115 relative to the flywheel-support body 113. Such a reduction in electric current may, in some embodiments, conserve energy and also reduce generation of heat in the roll-stabilizer apparatus 108. Further, such use of negative stiffness may, in some embodiments, permit smaller or simpler magnetic bearings than would be required in a roll-stabilizer apparatus that does not use of negative stiffness as described above, for example.

In the example of FIG. 24, the predicted direction 231 is a rotational direction and the arrows 232 also indicate a rotational direction. However, alternative embodiments may differ, and for example the predicted direction may be linear or a combination of rotational and linear.

### Active Actuation

Referring back to FIG. 4, as indicated above, each of the precession-control devices 120 and 121 is operable to apply a torque to, and to rotate, the mounting bracket 118 (and thus the flywheel-support body 113) around the precession axis of rotation 119 relative to the base 116 in response to, at least, one or more control signals from the roll-stabilizer controller 109.

In some embodiments, the roll-stabilizer controller 109 may cause such rotation of the mounting bracket 118 around the precession axis of rotation 119 relative to the base 116 to counteract detected or predicted roll of the marine vessel 100 around the longitudinal axis 106, or for other reasons.

For example, the roll-stabilizer controller 109 may cause such rotation of the mounting bracket 118 around the precession axis of rotation 119 relative to the base 116 to facilitate identification of a roll factor of the marine vessel 100, and the roll-stabilizer controller 109 may use such a roll factor of the marine vessel 100 to determine how to control rotation of the mounting bracket 118 around the precession axis of rotation 119 relative to the base 116 to counteract detected or predicted roll of the marine vessel 100 around the longitudinal axis 106.

As another example, the roll-stabilizer controller 109 may cause such rotation of the mounting bracket 118 around the precession axis of rotation 119 relative to the base 116 to cause desired roll of the marine vessel 100 around the longitudinal axis 106.

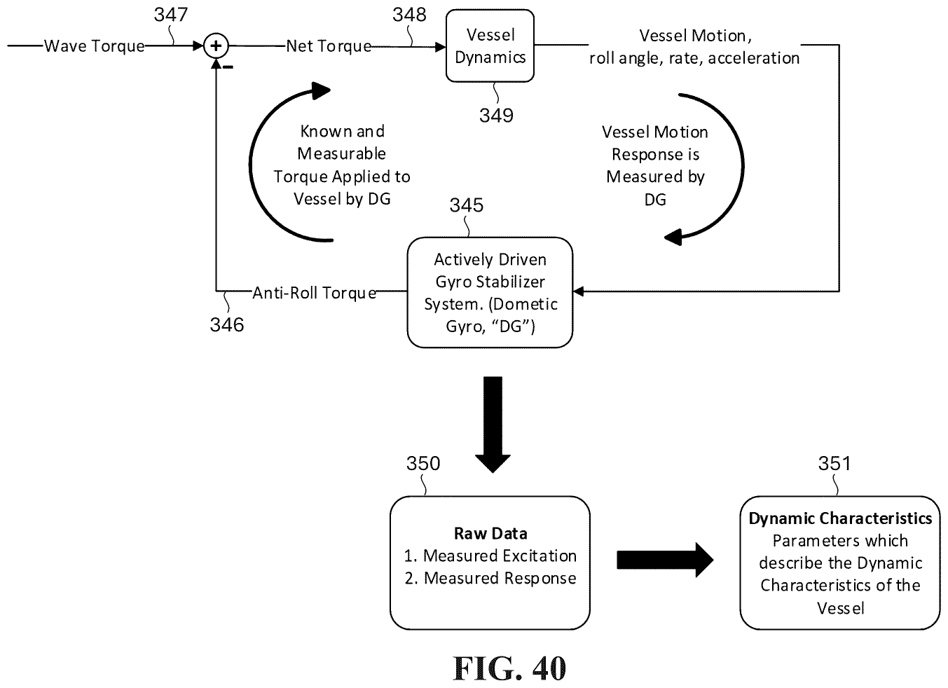

FIG. 40 schematically illustrates an example of identifying dynamic vessel characteristics according to one embodiment. Such dynamic vessel characteristics may facilitate active actuation in some embodiments.

As shown at 345 in FIG. 40, a roll-stabilizer apparatus (as described herein, for example) may apply an anti-roll torque 346 to a marine vessel. A wave torque 347 applied to the marine vessel, less the anti-roll torque 346, results in a net torque 348 on the marine vessel. The marine vessel has certain properties (or vessel dynamics) shown at 349, such as moment of inertia of the marine vessel, one or more roll-damping properties of the marine vessel, distribution of weight of the marine vessel, center of gravity (KG), center of buoyancy (KB), transverse metacenter (KMT), metacentric height (GM), volume of displacement (V), righting moment (RM), righting arm (GZ), radius of gyration (k), added radius of gyration (a), orientation of a roll axis relative to the vessel, restoring torque on the marine vessel from buoyancy of the marine vessel, one or more other properties or vessel dynamics, or any two or more thereof. Those properties 349 determine a response (such as motion of the marine vessel, a roll angle around a roll axis, an angular speed around the roll axis, an angular acceleration around the roll axis, natural period of rolling, one or more other responses, or two or more thereof) in response to the net torque 348. As shown at 350, one or more such responses may be measured (by the inertial measurement unit 111, for example) and one or more controllers (such as the roll-stabilizer controller 109, for example) may infer (as shown at 351) one or more properties (or vessel dynamics) of the marine vessel, such as moment of inertia of the marine vessel, one or more roll-damping properties of the marine vessel, distribution of weight of the marine vessel, orientation of a roll axis relative to the vessel, restoring torque on the marine vessel from buoyancy of the marine vessel, one or more other properties or vessel dynamics, or any two or more thereof.

In some embodiments, the anti-roll torque 346 may be applied to the marine vessel by a roll-stabilizer apparatus as shown at 345 to facilitate identification of one or more properties (or vessel dynamics) of the marine vessel as shown at 351. However, one or more properties (or vessel dynamics) of a marine vessel may be identified in other ways.

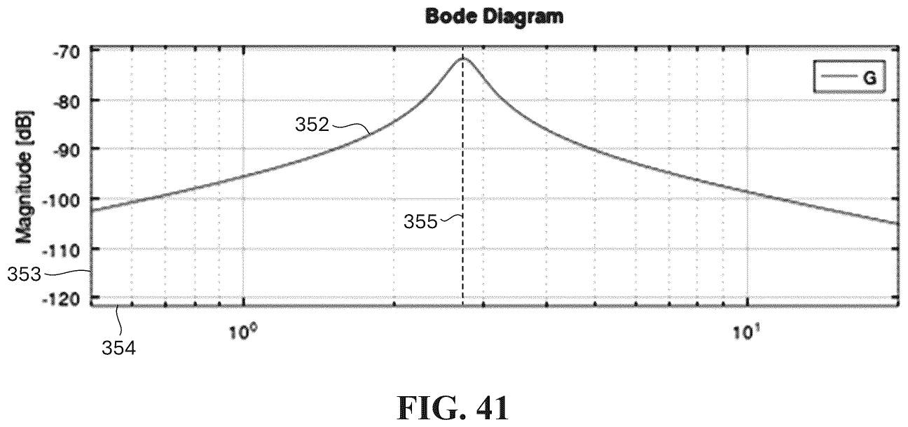

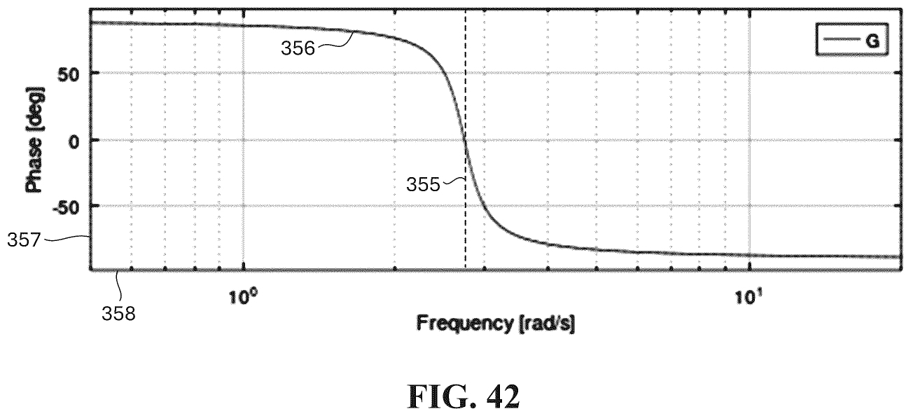

In FIG. 41, a line 352 illustrates roll dynamic mobility (on a vertical axis 353) of a marine vessel as a function of experienced torque frequency (on a horizontal axis 354) in one embodiment. Roll dynamic compliance may be a ratio of roll angle to torque and may be an inverse of roll dynamic stiffness, whereas roll dynamic mobility may be a ratio of roll rate to torque. As shown in FIG. 41, the marine vessel in the embodiment shown has a natural frequency 355 at which roll dynamic stiffness is minimal or roll dynamic mobility is at a maximum. Of course, alternative embodiments may differ.

As indicated above, when waves or other external forces apply torque to the marine vessel 100, the hull 101 (and thus the mounting body 114) may rotate or roll around a roll axis (which may be close to the longitudinal axis 106), and conservation of angular momentum of the flywheel body 122 causes the flywheel-support body 113 (and thus the flywheel body 122) to precess relative to the mounting body 114 around the precession axis of rotation 119 in response to rotation of the flywheel-support body 113 around the roll axis, which causes a torque to be exerted by the flywheel body 122 (and thus by the flywheel-support body 113 and the mounting body 114) on the hull 101 in a direction opposite the rotation of the hull 101 (and thus the mounting body 114) around the roll axis.

Absent active actuation such as active actuation as described herein for example, precession of the flywheel-support body 113 (and thus of the flywheel body 122) relative to the mounting body 114 around the precession axis of rotation 119 and resulting anti-roll torque 346 may be out of phase with wave torque 347 or other torque applied to a marine vessel. Such a phase difference between anti-roll torque 346 and wave torque 347 or other torque applied to the marine vessel may cause an undesired net torque 348 on the marine vessel, resulting in undesired movement of the marine vessel caused by the undesired net torque 348. The net torque 348 may be defined as the anti-roll torque 346 subtracted from the wave torque 347.

In FIG. 42, a line 356 illustrates a phase difference between motion of the marine vessel (such as a mounting body of the marine vessel, or structure that moves with the mounting body) around the roll axis and net torque 348 (on a vertical axis 357) as a function of roll frequency (on a horizontal axis 358) in one embodiment. As shown in FIG. 42, the phase difference may be zero at the natural frequency 355 and may be non-zero at other frequencies. Of course, alternative embodiments may differ.

In some embodiments, active actuation may involve applying a torque to the flywheel-support body 113 (and thus of the flywheel body 122) relative to an intertial reference frame around the precession axis of rotation 119 such that resulting motion of the flywheel-support body 113 (and thus of the flywheel body 122) relative to the intertial reference frame around the precession axis of rotation 119 has an absolute precession rate at a phase, shifted relative to a measured or predicted motion of the hull 101 (and thus the mounting body 114 or structure that moves with the mounting body) around a roll axis, by a phase shift responsive to at least such measured or predicted motion.

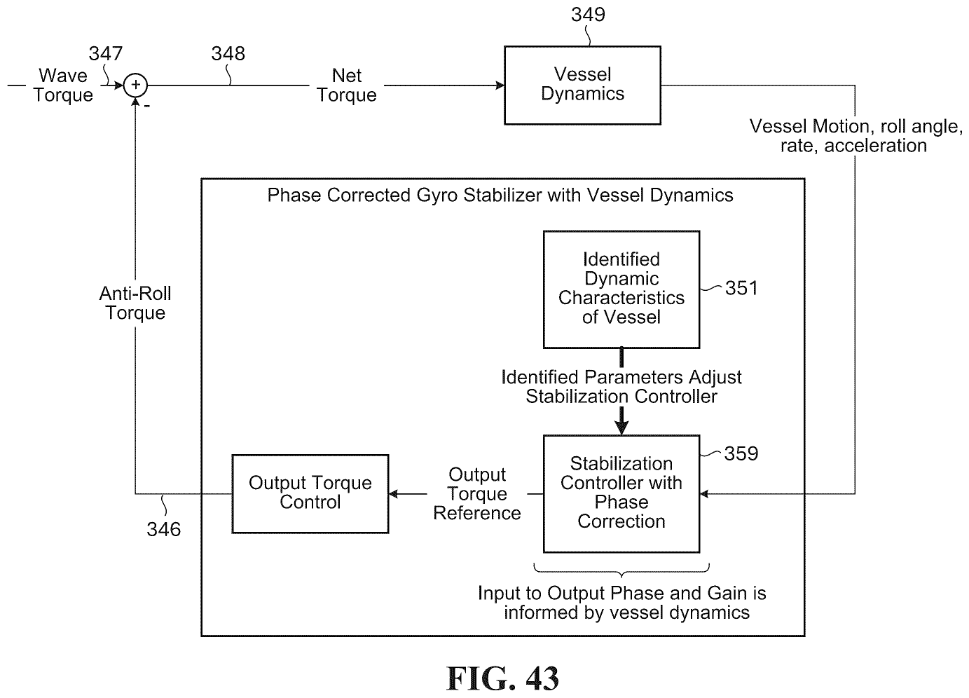

FIG. 43 illustrates schematically an embodiment showing at 359 adjustment of phase of motion of a marine vessel according to at least one or more properties (or vessel dynamics) 351 of the marine vessel in one embodiment.

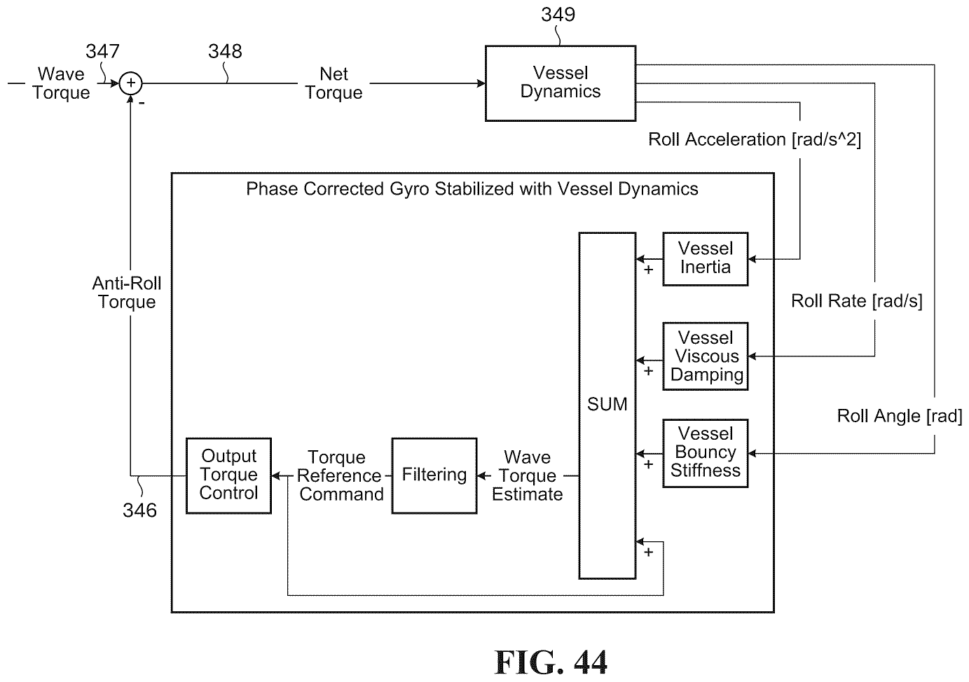

FIG. 44 illustrates schematically estimation of wave torque according to one embodiment.

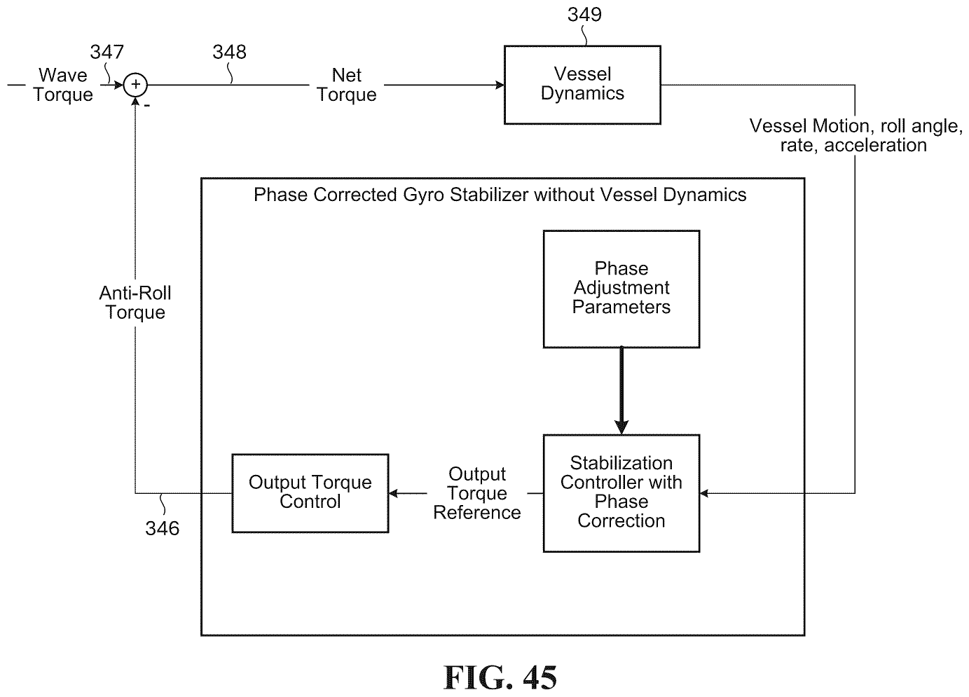

FIG. 45 illustrates schematically phase-corrected control according to one embodiment.

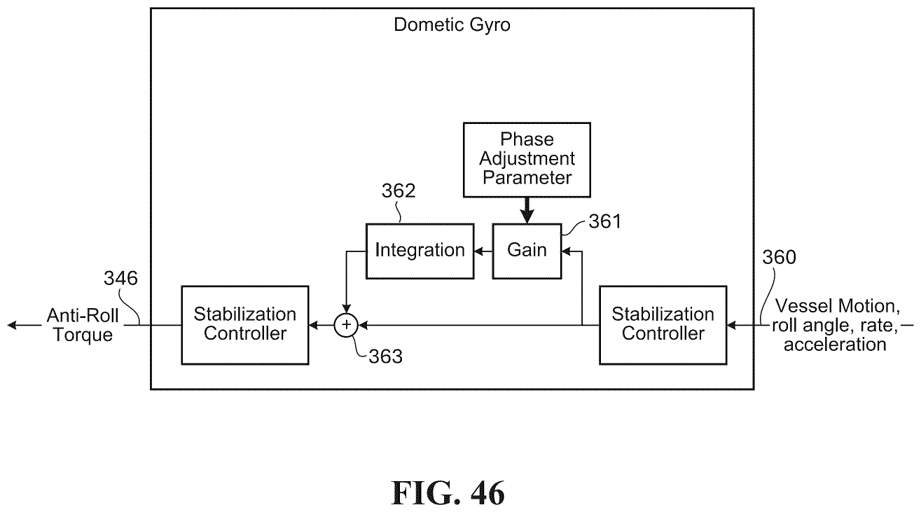

FIG. 46 illustrates implementation of phase-shift control to align anti-roll torque with wave torque in one embodiment. In some embodiments, one or more input signals 360 may indicate angular speed ωₕ of the hull 101 (and thus the mounting body 114 or structure that moves with the mounting body) around a roll axis over time t and may be expressed as ωₕ=A sin(ω_{w}t) where ω_{w} is an angular frequency of motion of the hull 101 (and thus the mounting body 114 or structure that moves with the mounting body) and A is an amplitude of the angular speed ωₕ.

As shown at 361, a gain k may be applied to the input signal to produce Ak sin(ω_{w}t), and at 362 an antiderivative of Ak sin(ω_{w}t) may be calculated as

$$\int A k sin ( {ω}_{w} t ) dt = - \frac{A k}{{ω}_{w}} cos ( {ω}_{w} t ) + C$$

for some constant C, which can be disregarded. At 363, the input A sin(ω_{w}t) may be added to the antiderivative

$$- \frac{A k}{{ω}_{w}} cos ( {ω}_{w} t )$$

to produce an output

$$A sin ( {ω}_{w} t ) - \frac{A k}{{ω}_{w}} cos ( {ω}_{w} t ) ,$$

which may be scaled by B as

$$A B sin ( {ω}_{w} t ) - \frac{A B k}{{ω}_{w}} cos ( {ω}_{w} t )$$

to compensate for addition of the antiderivative.

Because sin(a+b)=sin(a) cos(b)+cos(a) sin(b), applying the gain k at 361 causes the scaled output

$$A B sin ( {ω}_{w} t ) - \frac{A B k}{{ω}_{w}} cos ( {ω}_{w} t )$$

to have a phase shift ϕ relative to the input A sin(ω_{w}t) such that the scaled output

$$A B sin ( {ω}_{w} t ) - \frac{A B k}{{ω}_{w}} cos ( {ω}_{w} t ) = A sin ( {ω}_{w} t + ϕ )$$

$$where cos ( ϕ ) = B and sin ( ϕ ) = - \frac{A B k}{{ω}_{w}} .$$

In other words, for a desired phase shift ϕ, by choosing B=cos(ϕ) and die gain

$$k = - \frac{{ω}_{w} sin ( ϕ )}{A B} ,$$

the input A sin(ω_{w}t) is shifted by the phase shift ϕ to the output A sin(ω_{w}t+ϕ) by applying the gain, adding the antiderivative, and scaling as described above. Of course, alternative embodiments may differ and may, for example, shift phase in other ways.

The phase shift ϕ may be chosen according to the line 356. For example, if a frequency (such as a dominant frequency or other frequency) of motion of the marine vessel (such as a mounting body of the marine vessel, or structure that moves with the mounting body) around the roll axis is identified, the line 356 may identify, for that dominant frequency, a phase difference between motion of the marine vessel (such as a mounting body of the marine vessel, or structure that moves with the mounting body) around the roll axis and the wave torque 347. That identified phase difference may be used to determine the phase shift phase shift ϕ so that, by shifting the input A sin(ω_{w}t) by the phase shift ϕ to the output A sin(ω_{w}t+) as described above for example, the output A sin(ω_{w}t+) may be used to generate the anti-roll torque 346 such that the anti-roll torque 346 is in phase with the wave torque 347. As a result, the net torque 348 may be reduced, which may in some embodiments reduce undesired net torque 348 and undesired movement of the marine vessel caused by the undesired net torque 348. However, in at least some embodiments, a frequency (such as a dominant frequency or other frequency) need not be explicitly identified. In other words, in at least some embodiments, the phase shift ϕ may be identified by procedures that do not explicitly identify any frequency but that may rather, for example, respond to at least a frequency.

Active Actuation with Stabilizing Fins

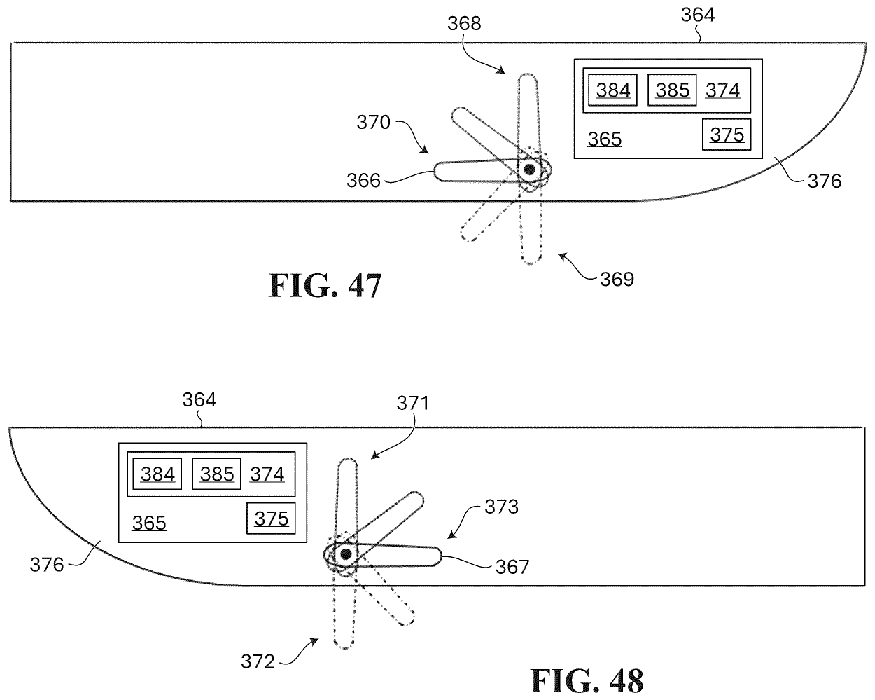

FIGS. 47 and 48 illustrate a marine vessel 364 according to one embodiment. The marine vessel 364 includes a hull 376. The marine vessel 364 also includes roll-stabilizer assembly 365 that may be similar to the roll-stabilizer assembly 107, for example. However, the marine vessel 364 includes a starboard-side stabilizing fin 366 on a starboard side of the marine vessel 364 and a port-side stabilizing fin 367 on a port side of the marine vessel 364. The starboard-side stabilizing fin 366 has a range of motion relative to the hull 376 from an uppermost vertical position shown generally at 368 to a lowermost vertical position shown generally at 369, with intermediate positions between the vertical positions 368 and 369 including a horizontal position shown generally at 370. Likewise, the port-side stabilizing fin 367 has a range of motion relative to the hull 376 from an uppermost vertical position shown generally at 371 to a lowermost vertical position shown generally at 372, with intermediate positions between the vertical positions 371 and 372 including a horizontal position shown generally at 373. Of course, alternative embodiments may differ and may, for example, have different types of stabilizing fins, a different number of stabilizing fins, or different ranges of motion, for example.

The roll-stabilizer assembly 365 includes a roll-stabilizer apparatus 374 that may be similar to the roll-stabilizer apparatus 108 and that includes a flywheel-support body 384 that may be similar to the flywheel-support body 113 and a mounting body 385 that may be similar to the mounting body 114. The roll-stabilizer assembly 365 also includes a roll-stabilizer controller 375 that may be similar to the roll-stabilizer controller 109, but the roll-stabilizer controller 375 may be programmed to control movement of the stabilizing fins 366 and 367 relative to the hull 376, to control one or more precession-control devices (such as the precession-control devices 120 and 121 or other precession-control devices such as those described herein, for example), or both.

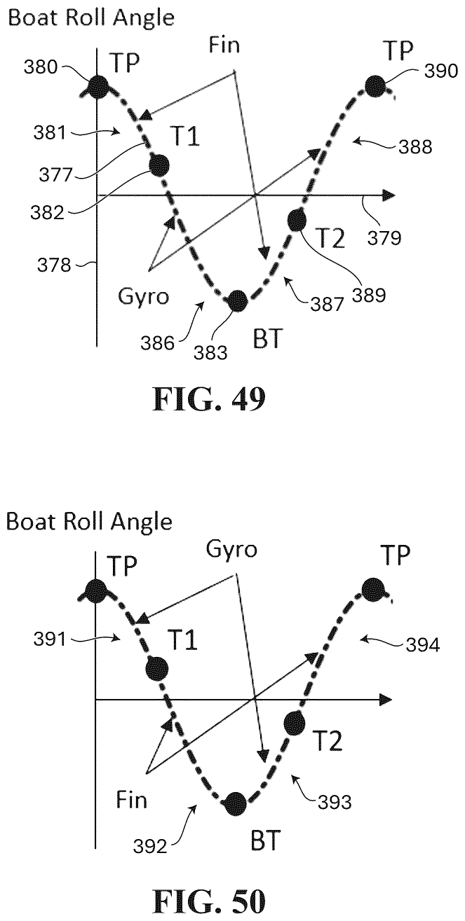

FIG. 49 illustrates stabilization of roll of a marine vessel as a function of time according to one embodiment. In FIG. 49, a line 377 illustrates roll angle of a marine vessel around a roll axis (on a vertical axis 378) as a function of time (on a horizontal axis 379) in one embodiment. In that embodiment, at a point 380 (top point TP), the marine vessel is rolled around the roll axis to a greatest extent to one side and is beginning to roll to the other side. The top point and the bottom point illustrate examples of positive and negative roll motion position extremes from tilting to starboard and to port respectively. Depending on the reference frame, a zero-roll position may refer to the vessel at its upright position or at a mid-point between the roll motion extremes.

At the point 380, the stabilizing fins 366 and 367 may be at or near respective ends of their range of motion relative to the hull 376 such that moving the stabilizing fins 366 and 367 relative to the hull 376 towards an opposite end of the range of motion would resist roll of the marine vessel around the roll axis to a side opposite the side of the point 380. For example, at the point 380, the marine vessel may be rolled around the roll axis to a greatest extent to a starboard side, in which case the starboard-side stabilizing fin 366 may be at its lowermost vertical position 369 relative to the hull 376 and the port-side stabilizing fin 367 may be at its uppermost vertical position 371 relative to the hull 376.

During some or all of a portion shown generally at 381 between the point 380 and a point 382 in time after the point 380 but before a point 383 (bottom point BT) when the marine vessel is rolled around the roll axis to a greatest extent to a side opposite the side of the point 380, the roll-stabilizer controller 375 may cause one or both of the stabilizing fins 366 and 367 to move relative to the hull 376 in a direction resisting roll of the marine vessel around the roll axis in the direction of roll between the points 380 and 382 while precession of the flywheel-support body 384 relative to the mounting body 385 in a direction that would resist such roll.

During some or all of the portion 381, the roll-stabilizer controller 375 may cause the flywheel-support body 384 to be held at or near an end of a range of precession of the flywheel-support body 384 relative to the mounting body 385 such that precession of the flywheel-support body 384 relative to the mounting body 385 towards an opposite end of the range of precession would resist roll of the marine vessel around the roll axis in the direction of roll between the points 380 and 382.

Such a range of precession is not necessarily a physically maximum range of precession between hard stops but may be a range equal to or less than such a physically maximum range. For example, in some embodiments, roll stabilization may be accomplished partly but not entirely by the stabilizing fins 366 and 367. In such embodiments, roll stabilization by the roll-stabilizer apparatus 374 may be most efficient when the stabilizing fin 366 is at either its uppermost vertical position 368 or its lowermost vertical position 369 relative to the hull 376, and when the port-side stabilizing fin 367 is at either its uppermost vertical position 371 or its lowermost vertical position 372 relative to the hull 376. Therefore, when roll stabilization may be accomplished partly but not entirely by the stabilizing fins 366 and 367, roll stabilization may be most efficient by using the maximum ranges of motion of the stabilizing fins 366 and 367, a physically maximum range of precession of the roll-stabilizer apparatus 374 may be unnecessary. Therefore, a range of precession of the roll-stabilizer apparatus 374 may be less than a physically maximum range of precession between hard stops, and an end of a range of precession is not necessarily at a physical hard stop but may instead be an end of a range less than a physically maximum range of precession.

At the point 382 at the end of the portion 381, one or both of the stabilizing fins 366 and 367 may reach or be near ends of their respective ranges of motion relative to the hull 376 opposite the ends of the ranges of motion at the point 380. For example, if at the point 380 the marine vessel was rolled around the roll axis to the greatest extent to the starboard side, then at point 382 the starboard-side stabilizing fin 366 may be at its uppermost vertical position 368 relative to the hull 376 and the port-side stabilizing fin 367 may be at its lowermost vertical position 372 relative to the hull 376.

At the point 382 at the end of the portion 381, the marine vessel has rolled around the roll axis a portion of an amount from the point 380 to the side opposite the side of the point 380, but one or both of the stabilizing fins 366 and 367 may be at or near ends of their respective ranges of motion relative to the hull 376 opposite the ends of the ranges of motion at the point 380.

Therefore, during some or all of a portion shown generally at 386 between the point 382 and the point 383, the roll-stabilizer controller 375 may cause precession of the flywheel-support body 384 relative to the mounting body 385 in a direction that resist roll of the marine vessel around the roll axis in the direction of roll between the points 380 and 382 and between the points 382 and 383. At the point 383 at the end of the portion 386, the flywheel-support body 384 may be at or near an end of its range of precession relative to the mounting body 385 opposite the end of the range of precession of points 380 and 382 and of the range 381. During some or all of the portion 386, the roll-stabilizer controller 375 may cause one or both of the stabilizing fins 366 and 367 to be held in their positions relative to the hull 376 of point 382.

During portions shown generally at 387 and 388, the marine vessel roll may around the roll axis in a direction opposite the direction of roll of the portions 381 and 386. During some or all of the portion 387, the roll-stabilizer controller 375 may cause one or both of the stabilizing fins 366 and 367 to move relative to the hull 376 in directions opposite the directions of the portion 381 while causing the flywheel-support body 384 to be held at or near its position relative to the mounting body 385 of the point 383. During some or all of the portion 388, which ends at a point 390, the roll-stabilizer controller 375 may cause precession of the flywheel-support body 384 relative to the mounting body 385 in a direction opposite the direction of the portion 386 while causing one or both of the stabilizing fins 366 and 367 to be held at or near their positions relative to the hull 376 at a point 389 at the end of the portion 387.

As shown in FIG. 49, the portions 381, 386, 387, and 388 are not necessary equal in time or in associated amount of roll of the marine vessel around the roll axis.

The example of FIG. 49 may be summarized as follows.

| | Point or | Position(s) of | Point or | |
|---|---|---|---|---|
| Roll Angle | Portion | Stabilizing Fin(s) | Portion | Precession Position |
| Greatest extent to | 380 | At or near first end (for | 380 | At or near first end of |
| first side (for | | example, 369 and 371) | | range of precession |
| example, starboard) | | of range of motion | | |
| Moving from first | 381 | Moving towards second end | 381 | |
| side to second | | (for example, 368 and 372) | | |
| side (for example, | | of range of motion opposite | | |
| port) opposite | | first end of range of motion | | |
| first side | | | | |
| | 382 | At or near second end | 382 | |
| | 386 | of range of motion | 386 | Moving towards |
| | | | | second end of range |
| | | | | of precession opposite |
| | | | | first end of range of |
| | | | | precession |
| Greatest extent | 383 | | 383 | At or near second end |
| to second side | | | | of range of precession |
| Moving from | 387 | Moving towards first | 387 | |
| second side to | | end of range of motion | | |
| first side | 389 | At or near first end | 389 | |
| | 388 | of range of motion | 388 | Moving towards first |
| | | | | end of range of precession |
| Greatest extent | 390 | | 390 | At or near first end of |
| to first side | | | | range of precession |

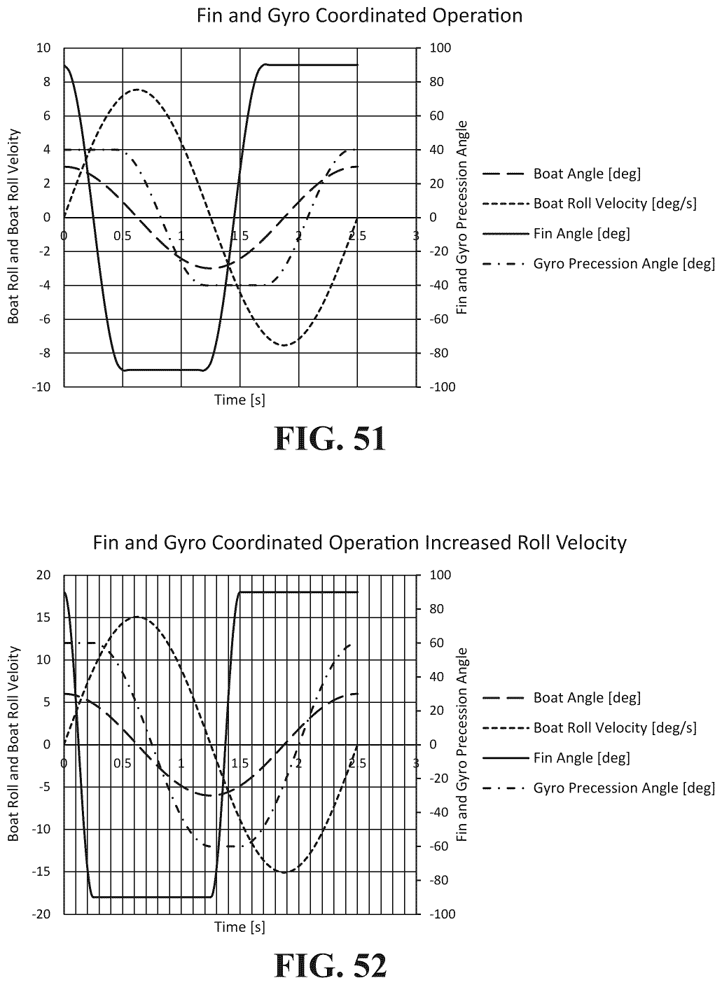

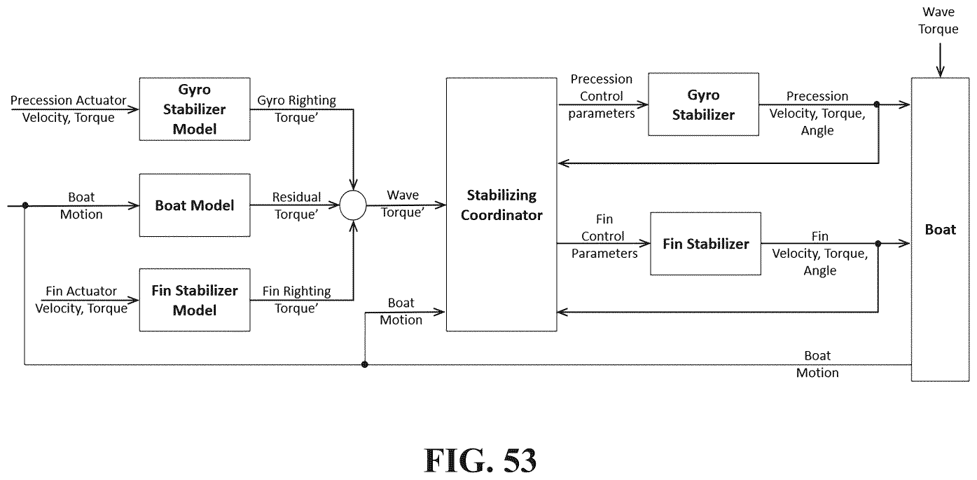

FIGS. 51 and 52 illustrate examples of operation according to the example of FIG. 49.

FIG. 50 illustrates an example including portions shown generally at 391, 392, 393, and 394 that are reversed with respect to order of use of the stabilizing fins and roll-stabilizer apparatus 374. In the example of FIG. 50, the portion 391 is similar to the portion 386, the portion 392 is similar to the portion 381 but after the portion 391, the portion 393 is similar to the portion 388, and the portion 394 is similar to the portion 387 but after the portion 393. Still other embodiments may differ.

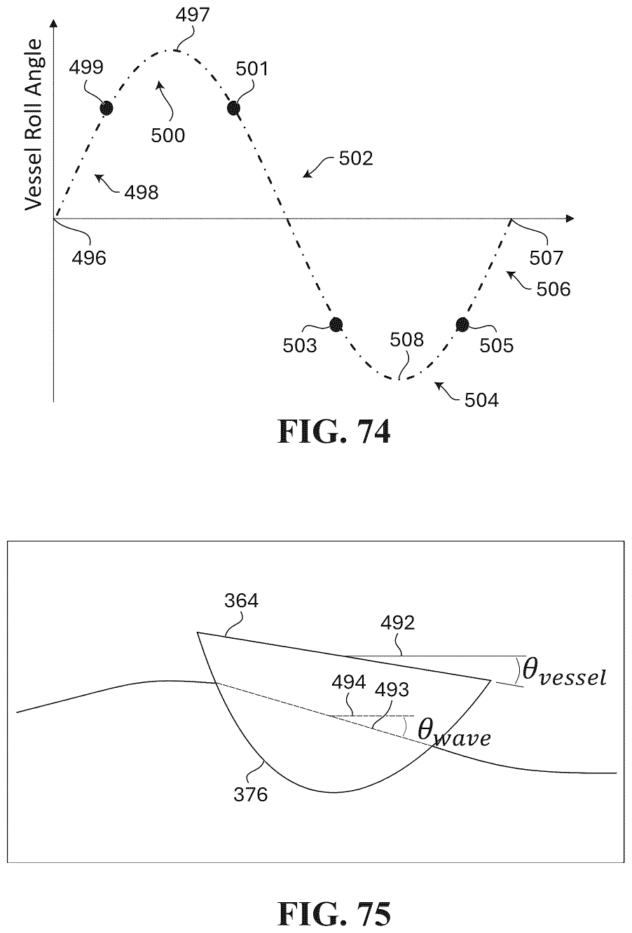

FIG. 74 illustrates an example including
1. a portion shown generally at 498 between a point 496 and a point 499 after the point 496,
2. a portion shown generally at 500 between the point 499 and a point 501 after the point 499,
3. a portion shown generally at 502 between the point 501 and a point 503 after the point 501,
4. a portion shown generally at 504 between the point 503 and a point 505 after the point 503, and
5. a portion shown generally at 506 between the point 505 and a point 507 after the point 505.

The portion 500 includes a point 497 at which the roll direction changes. Therefore, the portion 500 includes roll in a first direction (the direction of the portion 498 and 506) and then roll in a second direction (the direction of the portion 502) opposite the first direction. Also, the portion 504 includes a point 508 at which the roll direction changes again. Therefore, the portion 504 includes roll in the second direction (the direction of the portion 502) and then roll in the first direction (the direction of the portion 498 and 506), and in general such portions may include roll only in one direction or roll in two directions.

In the example of FIG. 74, roll stabilization of the marine vessel 364 may involve using the roll-stabilizer apparatus 374 during some or all of the portions 498, 502, and 506 and using the stabilizing fins 366 and 367 during some or all of the portions 500 and 504. Therefore, the example of FIG. 74 may be summarized as follows.

| Roll Angle or | Point or | Position(s) of | Point or | |
|---|---|---|---|---|
| Angular Speed | Portion | Stabilizing Fin(s) | Portion | Precession Position |
| Moving towards | 499 | At or near first end (for | 499 | At or near first end of |
| first side (for | | example, 369 and 371) | | range of precession |
| example, starboard) | | of range of motion | | |
| Moving towards and | 500 | Moving towards second | 500 | |
| reaching (at 497) | | end (for example, 368 | | |
| first side and then | | and 372) of range of | | |
| (after 497) moving | | motion opposite first | | |
| towards second side | | end of range of motion | | |
| (for example, port) | 501 | At or near second end | 501 | |
| opposite first side | 502 | of range of motion | 502 | Moving towards |
| | | | | second end of |
| | | | | range of precession |
| | | | | opposite first end of |
| | | | | range of precession |
| Moving towards | 503 | | 503 | At or near second end |
| second side | | | | of range of precession |
| Moving towards and | 504 | Moving towards first | 504 | |
| reaching (at 508) | | end of range of motion | | |
| second side and then | 505 | At or near first end | 505 | |
| (after 508) moving | 506 | of range of motion | 506 | Moving towards first |
| towards first side | | | | end of range of |
| | | | | precession |
| Moving towards | 507 | | 507 | At or near first end of |
| first side | | | | range of precession |

In some embodiments, roll stabilization using the stabilizing fins 366 and 367 and the roll-stabilizer apparatus 374 may be responsive to a rate of change of an angle between a marine vessel and waves. For example, FIG. 75 illustrates an angle θᵥₑₛₛₑₗ of roll of the marine vessel 364 relative to a horizontal line 492. FIG. 75 illustrates an angle θ_{wave} of a wave 493 relative to a horizontal line 494.

In some embodiments. θᵥₑₛₛₑₗ may be estimated as

$${θ}_{vessel} = {θ}_{wave} * \frac{{C}_{vessel} s + {K}_{vessel}}{{I}_{vessel} {s}^{2} + {C}_{vessel} s + {K}_{vessel}} + \frac{( {τ}_{fin} + {τ}_{gyro} )}{{I}_{vessel} {s}^{2} + {C}_{vessel} s + {K}_{vessel}}$$

where Cᵥₑₛₛₑₗ is a damping coefficient of the marine vessel 364 due to viscous forces on the hull from water for example, Kᵥₑₛₛₑₗ is a spring constant (from a restoring buoyancy, for example) of the marine vessel 364, Iᵥₑₛₛₑₗ is rotational inertia of the marine vessel 364, τ_{fin} is torque applied by one or both of the stabilizing fins 366 and 367 on the marine vessel 364, τ_{gyro} is torque applied by the roll-stabilizer apparatus 374 on the marine vessel 364, and s is a Laplace variable.

Also, in some embodiments, θ_{wave} may be estimated as

$${θ}_{wave} = {θ}_{v essel} * \frac{( {I}_{v essel} {s}^{2} + {c}_{v essel} s + {K}_{vessel} )}{{C}_{vessel} s + {K}_{vessel}} - \frac{( {τ}_{fin} + {τ}_{gyro} )}{{C}_{vessel} s + {K}_{vessel}} .$$

In some embodiments, θᵣₑₗₐₜᵢᵥₑ=θ_{wave}−θᵥₑₛₛₑₗ may represent a roll angle of the marine vessel 364 relative to the wave 493, and \hat{θ}ᵣₑₗₐₜᵢᵥₑ may be an estimate of θᵣₑₗₐₜᵢᵥₑ. In such embodiments, the derivative of \hat{θ}ᵣₑₗₐₜᵢᵥₑ in time t, namely δ\hat{θ}ᵣₑₗₐₜᵢᵥₑ/δt or \dot{\hat{θ}}ᵣₑₗₐₜᵢᵥₑ, may be an estimate of a rate of water flow laterally across the hull 376 of the marine vessel 364.

In some embodiments, roll stabilization of the marine vessel 364 using the stabilizing fins 366 and 367 may relatively more efficient when the marine vessel 364 is rolling in a direction opposite a change in θᵣₑₗₐₜᵢᵥₑ, namely when δ\hat{θ}ᵣₑₗₐₜᵢᵥₑ/δt or \dot{θ}ᵥₑₛₛₑₗ (the derivative of θᵥₑₛₛₑₗ in time t) and \dot{θ}ᵣₑₗₐₜᵢᵥₑ are opposite in sign, and roll stabilization of the marine vessel 364 using the stabilizing fins 366 and 367 may relatively less efficient when the marine vessel 364 is rolling in the same direction as a change in θᵣₑₗₐₜᵢᵥₑ, namely \dot{θ}ᵥₑₛₛₑₗ and \dot{θ}ᵣₑₗₐₜᵢᵥₑ are have the same sign.

In general some embodiments may involve prioritizing the stabilizing fins 366 and 367 when the stabilizing fins 366 and 367 are relatively more efficient (for example when \dot{θ}ᵥₑₛₛₑₗ and \dot{θ}ᵣₑₗₐₜᵢᵥₑ are opposite in sign) and prioritizing the roll-stabilizer apparatus 374 when the stabilizing fins 366 and 367 are relatively less efficient (for example when \dot{θ}ᵥₑₛₛₑₗ and \dot{θ}ᵣₑₗₐₜᵢᵥₑ have the same sign). Further, the stabilizing fins 366 and 367 may dampen roll relatively little when in uppermost (368 and 371) or lowermost (369 and 372) vertical positions and may dampen roll relatively more when in intermediate positions such as the horizontal positions 370 and 373.

Therefore, some embodiments may involve decreasing damping (for example by positioning the stabilizing fins 366 and 367 in uppermost (368 and 371) or lowermost (369 and 372) vertical positions) when waves are contributing to roll (for example when \dot{θ}ᵥₑₛₛₑₗ and \dot{θ}ᵣₑₗₐₜᵢᵥₑ have the same sign) and increasing damping (for example by positioning the stabilizing fins 366 and 367 in intermediate positions such as the horizontal positions 370 and 373) when waves are counteracting to roll (for example when \dot{θ}ᵥₑₛₛₑₗ and \dot{θ}ᵣₑₗₐₜᵢᵥₑ are opposite in sign).

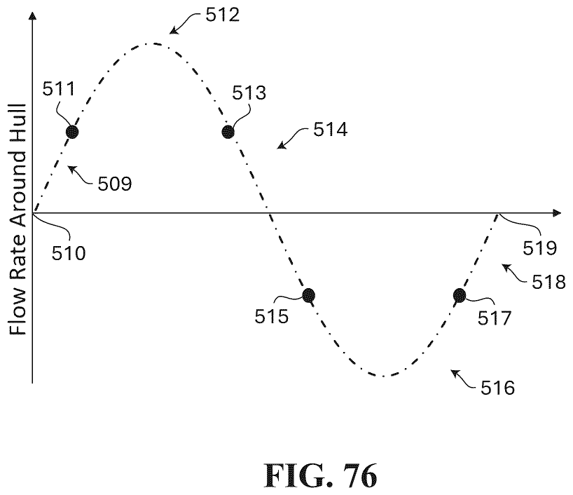

FIG. 76 illustrates an embodiment that may be responsive to an estimate of a rate of water flow laterally across the hull 376 of the marine vessel 364. Such an estimate of flow rate may be according to \dot{\hat{θ}}ᵣₑₗₐₜᵢᵥₑ as described above, or some other estimate.

During a portion shown generally at 509 between points 510 and 511, flow rate is in a first direction and relatively small but increasing. During the portion 509, because the flow rate is relatively small, the stabilizing fins 366 and 367 may be relatively more efficient than in a relatively high flow rate. Therefore, roll stabilization of the marine vessel 364 may involve using stabilizing fins 366 and 367 during some or all of the portion 509.

However, during some or all of a portion shown generally at 512 between the point 511 and a point 513 after the point 511, the flow rate is relatively high. During the portion 511, because the flow rate is relatively high, the stabilizing fins 366 and 367 may be relatively less efficient than in a relatively low flow rate. Therefore, roll stabilization of the marine vessel 364 may involve using the roll-stabilizer apparatus 374 during some or all of the portion 512.

During the portion 512, the flow rate changes direction, and during a portion shown generally at 514 between the point 513 and a point 515 after the point 513, the flow rate is relatively low and in a direction opposite the direction of the portion 510. During the portion 514, because the flow rate is relatively small, the stabilizing fins 366 and 367 may be relatively more efficient than in a relatively high flow rate, so roll stabilization of the marine vessel 364 may involve using stabilizing fins 366 and 367 during some or all of the portion 514.

During some or all of a portion shown generally at 516 between the point 515 and a point 517 after the point 515, the flow rate is relatively high, so roll stabilization of the marine vessel 364 may involve using the roll-stabilizer apparatus 374 during some or all of the portion 516.

During a portion shown generally at 518 between the point 517 and a point 519 after the point 517, the flow rate is relatively low and in a direction opposite the direction of the portion 514. During the portion 518, because the flow rate is relatively small, roll stabilization of the marine vessel 364 may involve using stabilizing fins 366 and 367 during some or all of the portion 518.

The example of FIG. 76 may be summarized as follows.

| | Point or | Position(s) of Stabilizing | Point or | |
|---|---|---|---|---|
| Flow Rate | Portion | Fin(s) | Portion | Precession Position |
| In first direction, | 509 | Moving towards first end | 509 | At or near first end |
| magnitude low but | | (for example, 369 and | | of range of |
| increasing | | 371) of range of motion | | precession |
| | 511 | At or near first end of | 511 | |
| In first direction, | 512 | range of motion | 512 | Moving towards |
| high in magnitude | | | | second end of range |
| | | | | of precession |
| | | | | opposite first end of |
| | | | | range of precession |
| In first direction, | 513 | | 513 | At or near second |
| magnitude decreasing | | | | end of range of |
| Low in magnitude, | 514 | Moving towards second | 514 | precession |
| changing from first | | end (for example, 368 and | | |
| direction to second | | 372) of range of motion | | |
| direction opposite | | opposite first end of range | | |
| first direction | | of motion | | |
| In second direction, | 515 | At or near second end of | 515 | |
| magnitude increasing | | range of motion | | |
| In second direction, | 516 | | 516 | Moving towards first |
| high in magnitude | | | | end of range of |
| | | | | precession |
| In second direction, | 517 | | 517 | At or near first |
| magnitude decreasing | | | | end of range of |
| In second direction, | 518 | Moving towards first end | 518 | precession |
| magnitude low and | | of range of motion | | |
| decreasing | | | | |

### Internally Supported Flywheel Body

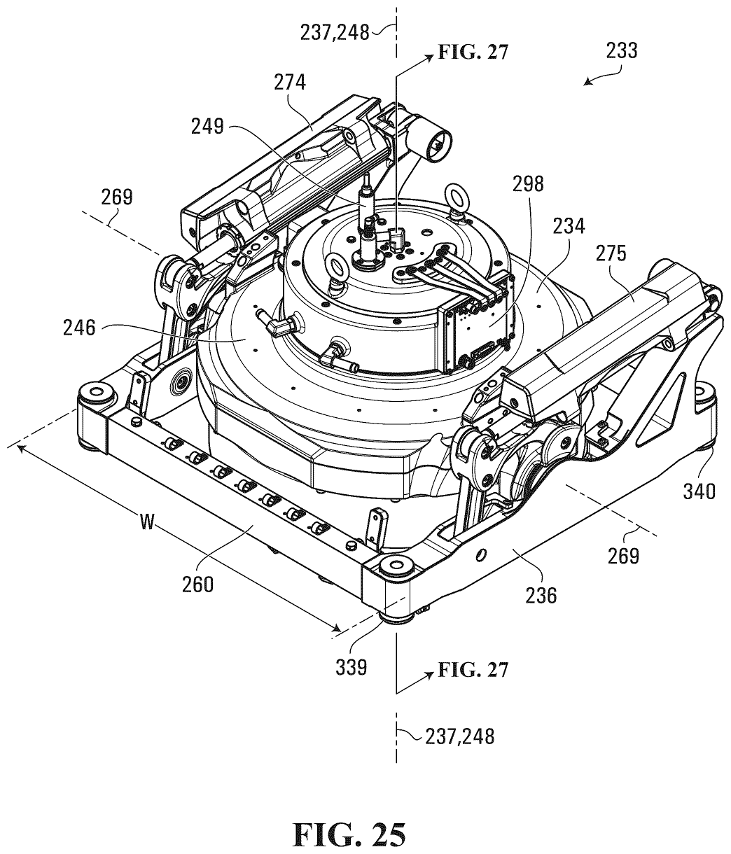

Referring now to FIGS. 25, 26, and 27, a roll-stabilizer apparatus according to another embodiment is shown generally at 233 and includes a flywheel-support body 234, a flywheel body 235 inside the flywheel-support body 234, and a mounting body 236. The roll-stabilizer apparatus 233 may be used, for example, in place of the roll-stabilizer apparatus 108 in the roll-stabilizer assembly 107 of the marine vessel 100, and may be controlled by the roll-stabilizer controller 109 as described above with respect to the roll-stabilizer apparatus 108.

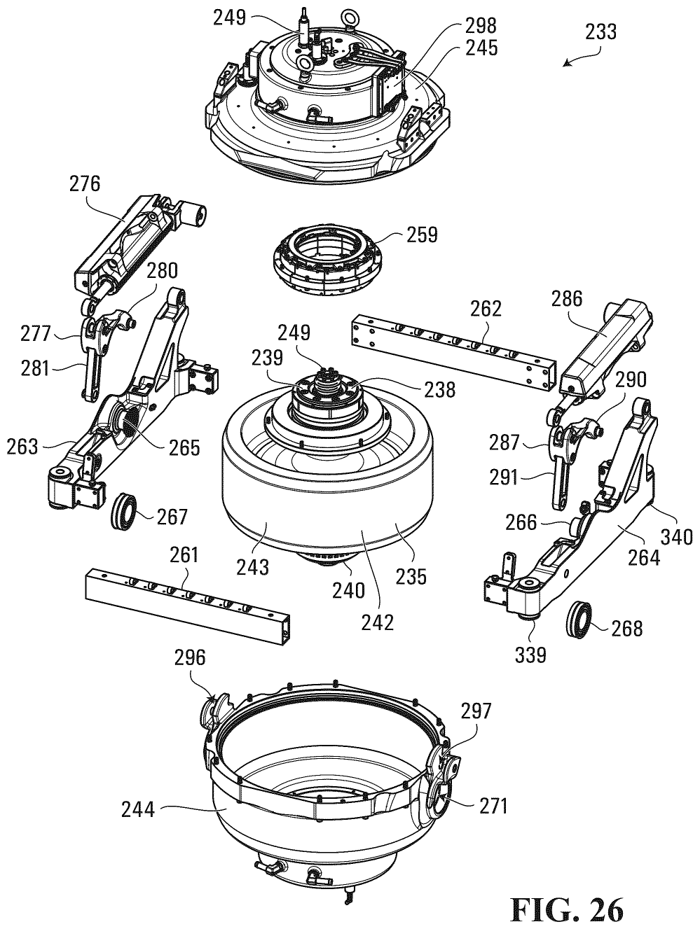

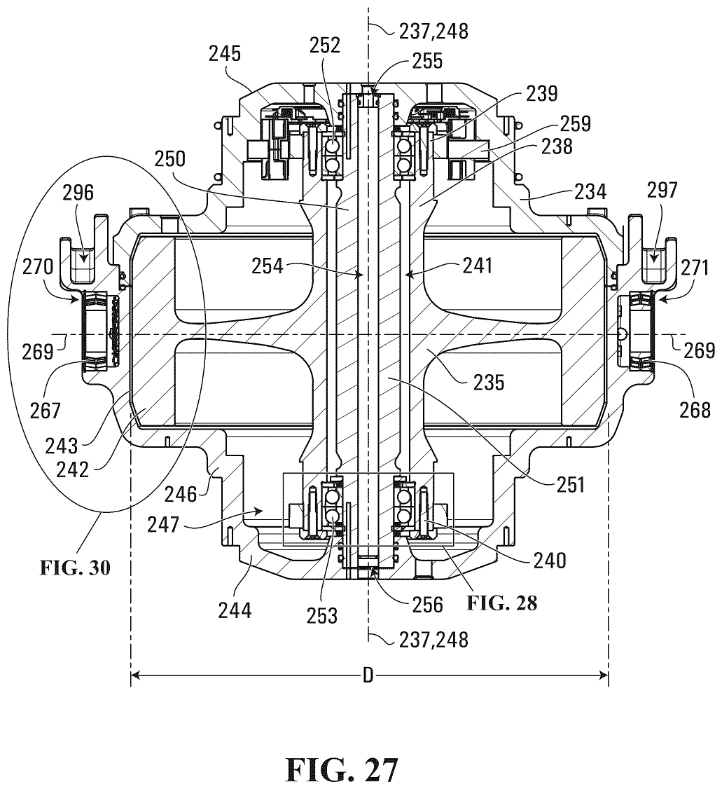

Referring to FIGS. 26 and 27, the flywheel body 235 is generally symmetrical about a spin axis of rotation 237, and includes a shaft 238 extending along the spin axis of rotation 237 between a first end, shown generally at 239, and a second end, shown generally at 240, of the shaft 238. The spin axis of rotation 237 may be through a center of mass of the flywheel body 235 and through centers of the first and second ends 239 and 240, although the flywheel body does not necessarily have to spin around the spin axis of rotation 237. The shaft 238 defines an axial through hole, shown generally at 241, extending along the spin axis of rotation 237 from the first end 239 to the second end 240. However, alternative embodiments may differ. For example, a shaft of an alternative embodiment may define an axial hole that extends along only part of a distance between a first end and a second end of the shaft, such as from the first end to a midpoint of the shaft. In other alternative embodiments, the shaft may include more than one axial hole, such as a first axial hole extending inward from the first end and a second axial hole extending inward from the second end.

The flywheel body 235 also includes a wheel portion 242 surrounding the shaft 238 and the spin axis of rotation 237. Much of the wheel portion 242 is spaced apart from the spin axis of rotation 237 to increase a moment of inertia of the flywheel body 235. An outer (or outermost) peripheral surface 243 of the wheel portion 242 also surrounds the shaft 238 and the spin axis of rotation 237, and is generally cylindrical around the spin axis of rotation 237. However, alternative embodiments may differ. For example, a wheel portion of an alternative embodiment may include a groove such as the groove 133 of the wheel portion 131 of the flywheel body 122, or may include a groove in a peripheral surface that is not necessarily an outer or outermost peripheral surface of the wheel portion, and that may be an inner surface of a flywheel body, for example.

Referring to FIGS. 25, 26, and 27, the flywheel-support body 234 includes housing bodies 244 and 245 that, when assembled as shown in FIG. 25 and in FIG. 27, form a housing 246 that defines an internal cavity, shown generally at 247. In some embodiments, the flywheel-support body 234 may include a central-rotation axis 248, which may extend through a center of the housing body 244 and a center of the housing body 245 when the housing bodies 244 and 245 are assembled to form the housing 246, and which may be colinear with the spin axis of rotation 237 of the flywheel body 235. As with the central-rotation axis 141 of the flywheel-support body 113 of the roll-stabilizer apparatus 108, the central-rotation axis 248 of the flywheel-support body 234 is not necessarily at an exact center of the housing body 244, the housing body 245, the flywheel-support body 234, or of any other structure. Of course, the embodiment shown is an example only, and alternative embodiments may vary. For example, alternative embodiments may include a different number of housing bodies forming the housing 246.

The housing 246 surrounds and houses the flywheel body 235 within the internal cavity 247. That is, the flywheel body 235 is located entirely within the internal cavity 247. The housing 246 may form a seal around the internal cavity 247 to enable the internal cavity 247 to contain an internal environment different than an ambient external environment. For example, the seal may be an air-tight seal, and the internal environment may have a different pressure than ambient pressure, or may contain gases or mixtures of gases different than ambient air. Thus, for example, the housing 246 may enclose the flywheel body 235 in an environment that has a pressure lower than ambient pressure, such as a vacuum, or that includes a slippery gas, helium, or some other gas or mixture of gases. In the embodiment shown, the flywheel-support body 234 includes valves, such as valve 249, which are in fluid communication with the internal cavity 247. The valve 249 is operable to control movement of gases into or out of the internal cavity 247. For example, the valve 249 may be operable to evacuate the internal cavity 247 to generate an environment having a pressure lower than ambient pressure.

The flywheel-support body 234 also includes a rotation-support body 250 extending from the center of the housing body 244 to the center of the housing body 245 within the internal cavity 247 when the housing bodies 244 and 245 are assembled to form the housing 246. The rotation-support body 250 is generally centered along the spin axis of rotation 237 of the flywheel body 235 (and/or the central-rotation axis 248 of the flywheel-support body 234) and extends through the axial through hole 241 of the flywheel body 235, such that an enclosed portion 251 of the rotation-support body 250 is positioned through the axial through hole 241. That is, the flywheel body 235 surrounds the enclosed portion 251 of the rotation-support body 250. In the embodiment shown, the flywheel-support body 234 also includes bearings 252 and 253 disposed along the enclosed portion 251 of the rotation-support body 250 within the axial through hole 241 of the flywheel body 235. The bearings 252 and 253 interface with the flywheel body 235 and are operable to support rotation of the flywheel body 235 relative to the rotation-support body 250, as well as axial loads between the flywheel body 235 and the rotation-support body 250. More specifically, the bearings 252 and 253 are operable to support the flywheel body 235 on the rotation-support body 250 such that the flywheel body 235 is rotatable within and relative to the flywheel-support body 234 around the spin axis of rotation 237, and such that the flywheel body 235 is maintained aligned with the flywheel-support body 234. In the embodiment shown, the bearings 252 and 253 and the rotation-support body 250 generally maintain the flywheel body 235 positioned relative to the flywheel-support body 234 such that the spin axis of rotation 237 of the flywheel body 235 is colinear with the central-rotation axis 248 of the flywheel-support body 234. This configuration can facilitate assembly, as it allows many rotating elements of the roll-stabilizer apparatus 233 (e.g., the flywheel body 235, the bearings 252 and 253, and the rotation-support body 250) to be assembled outside of the housing 246, thus eliminating a requirement for precision alignment of the housing bodies 244 and 245. Of course, the embodiment shown is an example only, and alternative embodiments may vary. For example, alternative embodiments may include a rotation-support body extending through only a part of the axial through hole 241, or may include more than one rotation-support body.

In the embodiment shown, the rotation-support body 250 defines an internal fluid conduit shown generally at 254. The internal fluid conduit 254 extends through an entirety of the rotation-support body 250 along the spin axis of rotation 237 and includes a first opening 255 where the rotation-support body 250 interfaces with the housing body 244 and a second opening 256 where the rotation-support body 250 interfaces with the housing body 245. The internal fluid conduit 254 is operable to convey a fluid through the rotation-support body 250 between the first opening 255 and the second opening 256. In some embodiments, the roll-stabilizer apparatus 233 may also include a fluid reservoir (not shown) fluidly connected to the internal fluid conduit 254, and a fluid pump (not shown) fluidly connected to both internal fluid conduit 254 and the fluid reservoir and operable to pump the fluid from the fluid reservoir to the internal fluid conduit 254. In some embodiments, the fluid conveyed through the internal fluid conduit 254 may be a coolant, and the internal fluid conduit 254, fluid reservoir, and fluid pump may function as a cooling system operable to cool the bearings 252 and 253. Such a cooling system may be used in conjunction with a heat exchanger and a separate cooling circuit.

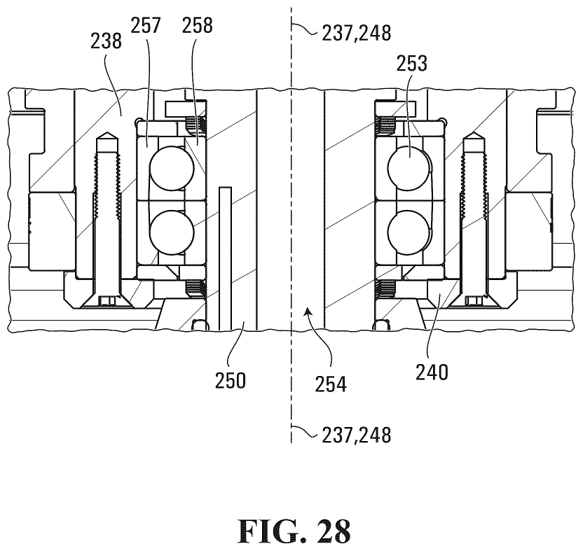

Referring now to FIGS. 27 and 28, the bearings 252 and 253 in the embodiment shown are mechanical bearings. More specifically, the bearings 252 and 253 are ball bearings. Considering as an example the bearing 253 as shown in greater detail in FIG. 28, the bearing 253 includes an outer race 257 and an inner race 258. The outer race 257 is fixed to the shaft 238 of the flywheel body 235, while the inner race 258 interfaces with the rotation-support body 250. In some embodiments, the inner race 258 may be fixed to the rotation-support body 250. However, in other embodiments, the inner race 258 may be a “floating” inner race, movable axially along the rotation-support body 250 (i.e., along the central-rotation axis 248 of the flywheel-support body 234). A “floating” inner race may be required to accommodate thermal expansion in some embodiments. The outer race 257 is operable to rotate relative to the inner race 258 and relative to the rotation-support body 250 and thus the flywheel-support body 234. As such, each of the bearings 252 and 253 includes an outer body (i.e., the outer race 257 of the bearing 253) that is rotatable relative to the flywheel-support body 234, and rotation of these outer bodies enables the flywheel body 235 to rotate relative to the flywheel-support body 234. In some embodiments, a majority of the heat generated in the bearings 252 and 253, such as about ⅔, for example, of the heat generated in the bearings 252 and 253, may be generated in inner races of the bearings 252 and 253, such as the inner race 258 of the bearing 253. Because these inner races are fixed to (i.e., in contact with) the rotation-support body 250, in embodiments where the internal fluid conduit 254, fluid reservoir, and fluid pump function as a cooling system operable to cool the bearings 252 and 253 as described above, cooling of the bearings 252 and 253 may be improved due to direct cooling of the inner races through conduction. Such improved cooling may increase an operating life of the bearings 252 and 253. Of course, the embodiment shown is an example only, and alternative may differ. For example, alternative embodiments may include a different number of bearings, or other types of mechanical bearings, such as cylindrical roller bearings or tapered roller bearings. Other alternative embodiments may include bearings other than mechanical bearings. For example, some alternative embodiments may include magnetic bearings, such as the axial active magnetic bearing 140 or the radial magnetic bearings of the roll-stabilizer apparatus 108 described above.

### Bearing Preloading

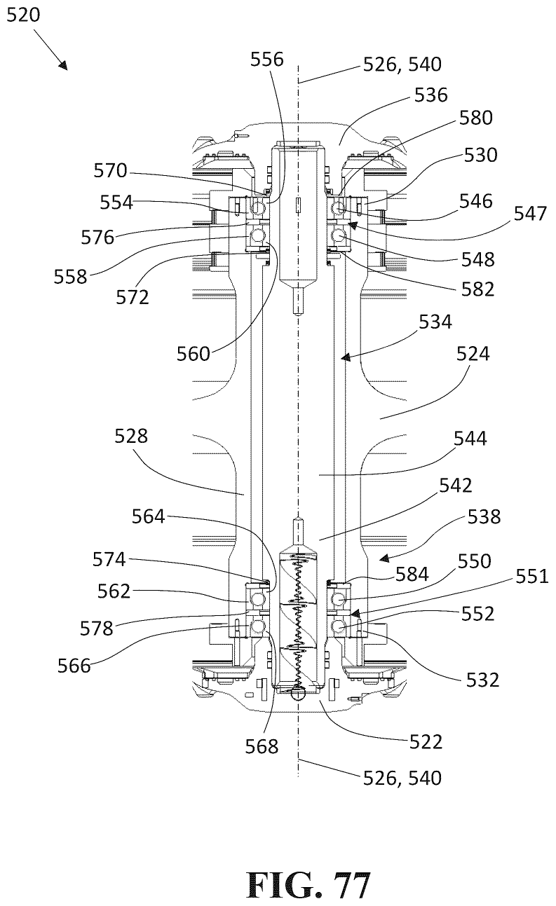

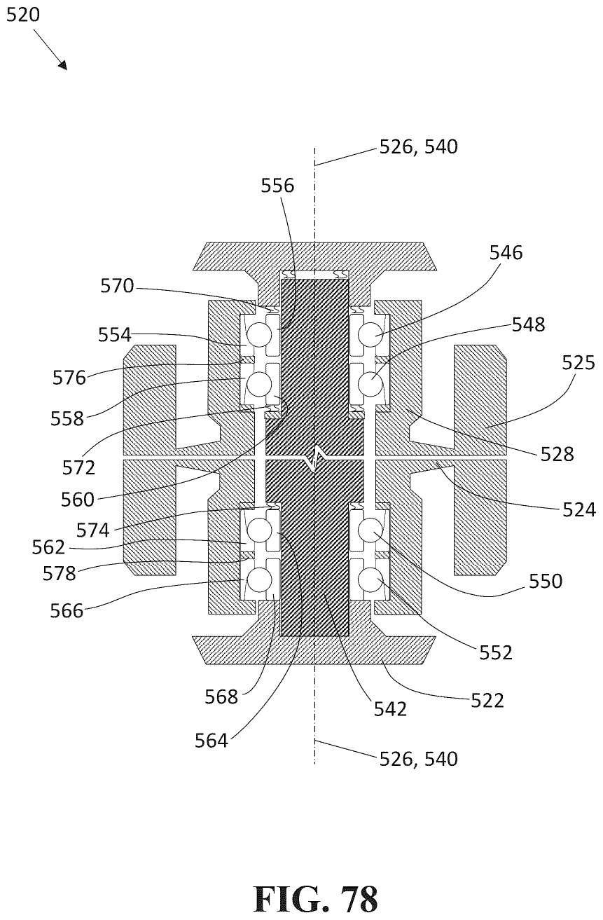

Referring now to FIGS. 77 and 78, a flywheel apparatus according to another embodiment is shown generally at 520 and includes a flywheel-support body 522 and a flywheel body 524 inside the flywheel-support body 522. The flywheel apparatus 520 may be used with a mounting body, such as the mounting body 236, in a roll-stabilizer apparatus, such as the roll-stabilizer apparatus 233.

The flywheel body 524 may generally be similar to the flywheel body 235. That is, the flywheel body 524 may be generally symmetrical about a spin axis of rotation 526, and includes a shaft 528 extending along the spin axis of rotation 526 between a first end, shown generally at 530, and a second end, shown generally at 532, of the shaft 528. The spin axis of rotation 526 may be through a center of mass of the flywheel body 235 and through centers of the first and second ends 530 and 532, although the flywheel body does not necessarily have to spin around the spin axis of rotation 526. The shaft 528 defines an axial through hole, shown generally at 534, extending along the spin axis of rotation 526 from the first end 530 to the second end 532. The flywheel body 524 also includes a wheel portion 525 surrounding the shaft 528 and the spin axis of rotation 526, with much of the wheel portion spaced apart from the spin axis of rotation 526 to increase a moment of inertia of the flywheel body 524.

Similarly, the flywheel-support body 522 may generally be similar to the flywheel-support body 234. That is, the flywheel-support body 522 includes a housing 536 that defines an internal cavity, shown generally at 538. The housing 536 surrounds and houses the flywheel body 524 within the internal cavity 538. That is, the flywheel body 524 is located entirely within the internal cavity 538. In some embodiments, the flywheel-support body 522 may include a central-rotation axis 540, which may extend through a center of the housing 536, and which may be colinear with the spin axis of rotation 526 of the flywheel body 524.

The flywheel-support body 522 also includes a rotation-support body 542 extending within the internal cavity 538 of the housing 536. The rotation-support body 542 is generally centered along the spin axis of rotation 526 of the flywheel body 524 (and/or the central-rotation axis 540 of the flywheel-support body 522) and extends through the axial through hole 534 of the flywheel body 524, such that an enclosed portion 544 of the rotation-support body 542 is positioned through the axial through hole 534. That is, the flywheel body 524 surrounds the enclosed portion 544 of the rotation-support body 542.

In the embodiment shown in FIG. 77, the flywheel-support body 522 also includes bearings 546, 548, 550, and 552 disposed along the enclosed portion 544 of the rotation-support body 542 within the axial through hole 534 of the flywheel body 524. More specifically, the bearings 546, 548, 550, and 552 are arranged in two groups: in a first bearing group 547, the bearings 546 and 548 are positioned in the axial through hole 534 axially adjacent to one another along the central-rotation axis 540 of the flywheel-support body 522 near the first end 530 of the shaft 528, and in a second bearing group 551 the bearings 550 and 552 are positioned in the axial through hole 534 axially adjacent to one another along the central-rotation axis 540 of the flywheel-support body 522 near the second end 532 of the shaft 528. In the embodiment shown, each of the bearing groups 547 and 551 includes a pair of bearings (i.e., the bearings 546 and 548 and the bearings 550 and 552, respectively), but in alternative embodiments such bearing groups may include more than two bearings. Further, in some alternative embodiments one or more of such bearing groups may include only a single bearing.

The bearings 546, 548, 550, and 552 interface with the flywheel body 524 and are operable to support rotation of the flywheel body 524 relative to the rotation-support body 542, as well as axial loads between the flywheel body 524 and the flywheel-support body 522 (e.g., in some embodiments, between the flywheel body 524 and the rotation-support body 524 of the flywheel-support body 522). More specifically, the bearings 546, 548, 550, and 552 are operable to support the flywheel body 524 on the rotation-support body 542 such that the flywheel body 524 is rotatable within and relative to the flywheel-support body 522 around the spin axis of rotation 526, and such that the flywheel body 524 is maintained aligned with the flywheel-support body 522. In the embodiment shown, the bearings 546, 548, 550, and 552 and the rotation-support body 542 generally maintain the flywheel body 524 positioned relative to the flywheel-support body 522 such that the spin axis of rotation 526 of the flywheel body 524 is colinear with the central-rotation axis 540 of the flywheel-support body 522.

The bearings 546, 548, 550, and 552 in the embodiment shown are mechanical bearings. More specifically, the bearings 546, 548, 550, and 552 are ball bearings. Even more specifically, the bearings 546, 548, 550, and 552 are angular contact bearings. Each of the bearings 546, 548, 550, and 552 includes a respective outer race and a respective inner race. More specifically, the bearing 546 includes an outer race 554 and an inner race 556; the bearing 548 includes an outer race 558 and an inner race 560; the bearing 550 includes an outer race 562 and an inner race 564; and the bearing 552 includes an outer race 566 and an inner race 568.

In the embodiment shown, the outer races 554, 558, 562, and 566 are fixed to the shaft 528 of the flywheel body 524, while the inner races 556, 560, 564, and 568 interface with the rotation-support body 542. Also in the embodiment shown, the inner races 556, 560, 564, and 568 are “floating” inner races, movable axially along the rotation-support body 542 (i.e., along the central-rotation axis 540 of the flywheel-support body 522). As explained above, a “floating” inner race may be required to accommodate thermal expansion in some embodiments. The outer races 554, 558, 562, and 566 are generally operable to rotate relative to their respective inner races 556, 560, 564, and 568 and relative to the rotation-support body 542 and thus the flywheel-support body 522. That is, the outer race 554 is operable to rotate relative to the inner race 556 and relative to the flywheel-support body 522, the outer race 558 is operable to rotate relative to the inner race 560 and relative to the flywheel-support body 522, the outer race 562 is operable to rotate relative to the inner race 564 and relative to the flywheel-support body 522, and the outer race 566 is operable to rotate relative to the inner race 568 and relative to the flywheel-support body 522. As such, each of the bearings 546, 548, 550, and 552 includes an outer body (i.e., the outer races 554, 558, 562, and 566 of the bearings 546, 548, 550, and 552, respectively) that is rotatable relative to the flywheel-support body 522, and rotation of these outer bodies enables the flywheel body 524 to rotate relative to the flywheel-support body 522. However, alternative embodiments may include mechanical bearings which include inner races fixed to the flywheel body and outer races interfacing with the flywheel-support body. In such alternative embodiments, the inner races may generally be operable to rotate relative to their respective outer races and relative to the flywheel-support body.

The flywheel-support body 522 also includes resilient bodies 570, 572, and 574, and spacers 576 and 578. In general, the resilient bodies 570, 572, and 574 are axially adjacent the bearing groups 547 and 551 along the central-rotation axis 540 of the flywheel-support body 522. More specifically, the resilient body 570 is axially adjacent the bearing 546 along the central-rotation axis 540 of the flywheel-support body 522, the resilient body 572 is axially adjacent the bearing 548 along the central-rotation axis 540 of the flywheel-support body 522, and the resilient body 574 is axially adjacent the bearing 550 along the central-rotation axis 540 of the flywheel-support body 522. That is, the resilient body 570 is axially adjacent to the bearing group 547 at a first axial end 580 of the bearing group 547 along the central-rotation axis 540 of the flywheel-support body 522, the resilient body 572 is axially adjacent to the bearing group 547 at a second axial end 582 of the bearing group 547 along the central-rotation axis 540 of the flywheel-support body 522, and the resilient body 574 is axially adjacent to the bearing group 547 at a first axial end 584 of the bearing group 551 along the central-rotation axis 540 of the flywheel-support body 522. The resilient bodies 570, 572, and 574 may be, for example, springs. More specifically, resilient bodies 570, 572, and 574 may be, for example, wave springs.

In general, the resilient bodies 570, 572, and 574 are configured to resiliently urge together, along the central-rotation axis 540 of the flywheel-support body 522, individual bearings of the bearing groups 547 and 551. More specifically, the resilient body 570 is configured to resiliently urge the inner race 556 of the bearing 546 towards the bearing 548 along the central-rotation axis 540 of the flywheel-support body 522, the resilient body 572 is configured to resiliently urge the inner race 560 of the bearing 548 towards the bearing 546 along the central-rotation axis 540 of the flywheel-support body 522, and the resilient body 574 is configured to resiliently urge the inner race 564 of the bearing 550 towards the bearing 552 along the central-rotation axis 540 of the flywheel-support body 522. The inner race 568 of the bearing 552 may be urged towards the bearing 550 along the central-rotation axis 540 of the flywheel-support body 522 by support from the housing 536 of the flywheel-support body 522 as gravity pulls the flywheel body 524—and, as a result, the bearing group 551—downward and/or as the resilient body 570 urges the flywheel assembly downward.

In general, the spacers 576 and 578 are positioned between outer races of adjacent bearings of the bearing group 547 and the bearing group 551, respectively, to maintain axial separation, along the central-rotation axis 540 of the flywheel-support body 522, between those outer races. More specifically, the spacer 576 is between the outer race 554 of the bearing 546 and the outer race 560 of the bearing 548 and maintains axial separation, along the central-rotation axis 540 of the flywheel-support body 522, between the outer race 554 and the outer race 560. Similarly, the spacer 578 is between the outer race 564 of the bearing 550 and the outer race 568 of the bearing 552 and maintains axial separation, along the central-rotation axis 540 of the flywheel-support body 522, between the outer race 564 and the outer race 568. In some alternative embodiments, instead of the spacers, the outer race of one or more of the bearings may be larger in an axial dimension along the along the central-rotation axis 540 of the flywheel-support body 522 than the inner race, such that outer races of adjacent bearings are in contact while the inner races remain separate.

By resiliently urging the inner races 556 and 558 of the bearings 546 and 548 together while the respective outer races 554 and 560 are separated by the spacer 576, as described herein, the resilient bodies 570 and 572 may preload the bearings 546 and 548. Similarly, by resiliently urging the inner races 558 and 566 of the bearings 550 and 552 together while the respective outer races 564 and 568 are separated by the spacer 578, the resilient body 574 may preload the bearings 550 and 552. As used herein, the term “preloading” may refer to bearing balls of the bearings 546, 548, 550, and 552 being under compressive loading (e.g., axial and radial compressive loading in the embodiment shown). Preloading may maintain positions of the bearing balls between the inner and outer races of the bearings 546, 548, 550, and 552, which may avoid damage from the bearing balls moving out of position during operation—that is, preloading may remove any internal clearance (i.e., space for bearing balls to move radially between the races) of the bearings 546, 548, 550, and 552.

Of course, the embodiment shown is an example only, and alternative embodiments may differ. For example, in some alternative embodiments where bearings include inner races fixed to the flywheel body and outer races interfacing with the flywheel-support body, the resilient bodies may be configured to resiliently urge together the outer races of individual bearings to preload the bearings, rather than the inner races as described above. In such alternative embodiments, axial separation of the inner races of adjacent bearings—rather than the outer races as described above—may be maintained by spacers, or, instead of the spacers, by the inner race of one or more of the bearings being larger in an axial dimension along the along the central-rotation axis 540 of the flywheel-support body 522 than the outer race, such that inner races of adjacent bearings are in contact while the outer races remain separate.

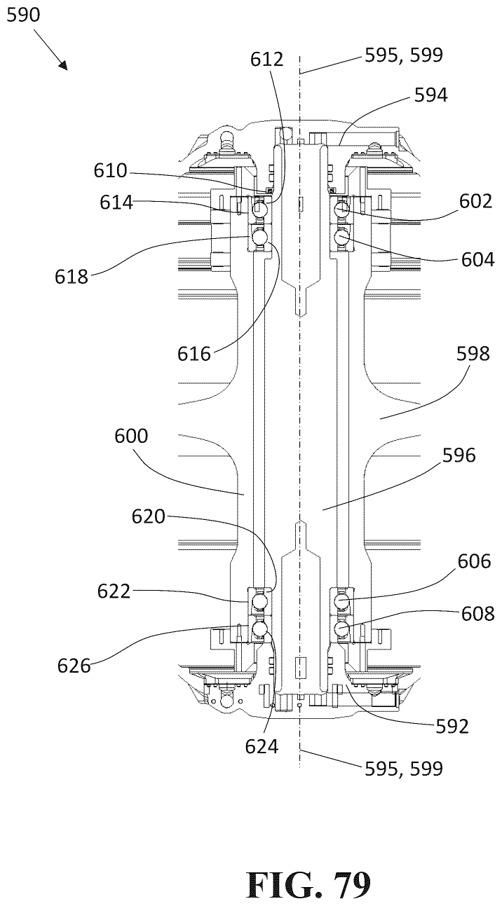

Referring now to FIG. 79, a flywheel apparatus according to another embodiment is shown generally at 590. The flywheel apparatus 590 is generally similar to the flywheel apparatus 520 and includes a flywheel-support body 592 similar to the flywheel-support body 522, including a housing 594 similar to the housing 536, a central-rotation axis 595 similar to the central-rotation axis 540, and a rotation-support body 596, similar to the rotation-support body 542, extending within the housing 594 and centered along the central-rotation axis 595; a flywheel body 598 similar to the flywheel body 524, including a spin axis of rotation 599 similar to the spin axis of rotation 526 and a shaft 600 similar to the shaft 528; bearings 602, 604, 606, and 608 generally similar to the bearings 546, 548, 550, and 552; and a resilient body 610 similar to the resilient bodies 570, 572, and 574.

Like the bearings 546, 548, 550, and 552, each of the bearings 602, 604, 606, and 608 includes a respective inner race and a respective outer race operable to rotate relative to the inner race and relative to the flywheel-support body 592. More specifically, the bearing 602 includes an inner race 612 and an outer race 614 operable to rotate relative to the inner race 612 and relative to the flywheel-support body 592; the bearing 604 includes an inner race 616 and an outer race 618 operable to rotate relative to the inner race 616 and relative to the flywheel-support body 592; the bearing 606 includes an inner race 620 and an outer race 622 operable to rotate relative to the inner race 620 and relative to the flywheel-support body 592; and the bearing 608 includes an inner race 624 and an outer race 626 operable to rotate relative to the inner race 624 and relative to the flywheel-support body 592.

However, unlike the bearings 546, 548, 550, and 552, the bearings 602, 604, 606, and 608 are arranged without any axial separation along the central-rotation axis 595 of the flywheel-support body 592. That is, the inner race 612 of the bearing 602 is in contact with the inner race 616 of the bearing 604, the outer race 614 of the bearing 602 is in contact with the outer race 618 of the bearing 604, the inner race 620 of the bearing 606 is in contact with the inner race 624 of the bearing 608, and the outer race 622 of the bearing 606 is in contact with the outer race 626 of the bearing 608. Moreover, the bearings 602, 604, 606, and 608 are arranged in tandem such that a bearing ball contact angle (i.e., contact between a respective inner race and a bearing ball, and between the bearing ball and a respective outer race) is the same for each of the bearings 602 and 604, and is the same for each of the bearings 606 and 608. As such, the resilient body 610 alone is configured to preload all four of the bearings 602, 604, 606, and 608. That is, the resilient body 610 applies a resilient force, in a direction along the central-rotation axis 595 of the flywheel-support body 592, to the inner race 612 of the bearing 602 to resiliently urge the inner race 612 of the bearing 602 toward the bearing 604 along the central-rotation axis 595 of the flywheel-support body 592. This force is transferred to the inner race 616 of the bearing 604 through contact between the inner races 612 and 616, and to the outer race 614 of the bearing 602 and the outer race 618 of the bearing 604 through bearings balls of the bearings 602 and 604 (thus preloading the bearings 602 and 604). The force is then transferred through the shaft 600 of the flywheel body 598 to the outer race 622 of the bearing 606 and, through contact between the outer race 622 and the outer race 626 of the bearing 608, to the outer race 626 of the bearing 608. Finally, the force is transferred through bearings balls of the bearings 606 and 608 to the inner races 620 and 624 of the bearings 606 and 608, respectively, which are supported by the housing 594 of the flywheel-support body 592.

### Cooling System

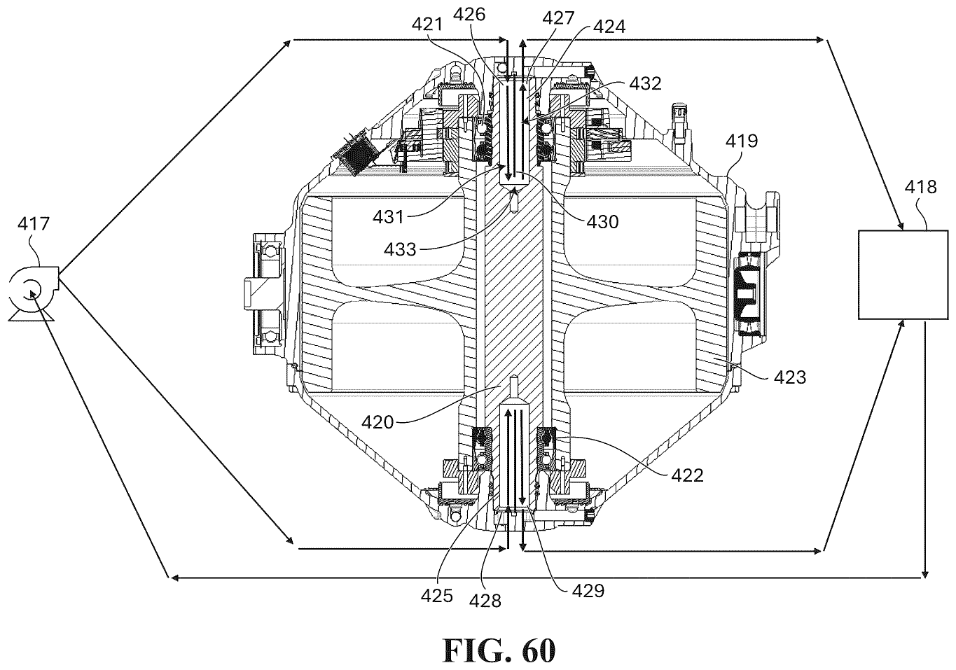

FIG. 60 illustrates a cooling system for a roll-stabilizer apparatus according to one embodiment. In FIG. 60, a coolant source (such as a coolant pump) 417 is operable to pump cooling fluid to a coolant destination 418, which may include a coolant reservoir, a heat exchanger or both. Also in FIG. 60, a roll-stabilizer apparatus 419 includes a rotation-support body 420 that may function similarly to the rotation-support body 250. For example, the roll-stabilizer apparatus 419 includes bearings 421 and 422 that may function similarly to the bearings 252 and 253. The bearing 421 includes an inner race 495. The roll-stabilizer apparatus 419 also includes a flywheel body 423 that may be similar to a flywheel body as described herein for example.

However, the rotation-support body 420 defines a first internal fluid conduit 424 on a first side of the flywheel body 423 and a second internal fluid conduit 425 on a second side of the flywheel body 423 opposite the first side. The first internal fluid conduit 424 extends only on the first side of the flywheel body 423, and the second internal fluid conduit 425 extends only on the second side of the flywheel body 423, although alternative embodiments may differ. The first internal fluid conduit 424 has first and second openings shown generally at 426 and 427 on the first side of the flywheel body 423, and the second internal fluid conduit 425 has third and fourth openings shown generally at 428 and 429 on the second side of the flywheel body 423.

The first internal fluid conduit 424 includes a separator body 430 separating first and second portions shown generally at 431 and 432 of the first internal fluid conduit 424. The first portion 431 is in fluid communication with the first opening 426. The second portion 432 is in fluid communication with the second opening 427. A transition portion shown generally at 433 is in fluid communication with the first and second portions 431 and 432. As a result, cooling fluid from the coolant source 417 may be directed into the first opening 426, from the first opening 426 through the first portion 431 to the transition portion 433, from the transition portion 433 through the second portion 432, and from the second portion 432 out the second opening 427. The second internal fluid conduit 425 also includes a first portion in fluid communication with the third opening 428, a second portion in fluid communication with the fourth opening 429, and a transition portion in fluid communication with the first and second portions so that cooling fluid from the coolant source 417 may be directed into the third opening 428, through the second internal fluid conduit 425, and out the fourth opening 429 as described above with respect to the first internal fluid conduit 424.

The first internal fluid conduit 424 is surrounded by and positioned near the bearing 421, and the second internal fluid conduit 425 is surrounded by and positioned near the bearing 422. Therefore, cooling fluid passing through the first and second internal fluid conduits 424 and 425 may cool the bearings 421 and 422 respectively. Because the first internal fluid conduit 424 extends only on the first side of the flywheel body 423 and the second internal fluid conduit 425 extends only on the second side of the flywheel body 423, cooling may be focused on the bearings 421 and 422, although alternative embodiments may differ.

In the embodiment of FIG. 60, cooling fluid from the coolant source 417 is directed through the first and second internal fluid conduits 424 and 425 in parallel because a portion of cooling fluid from the coolant source 417 is directed through the first internal fluid conduit 424 to the coolant destination 418, and a different portion of cooling fluid from the coolant source 417 is directed through the second internal fluid conduit 425 to the coolant destination 418. However, in an alternative embodiment, cooling fluid from the coolant source 417 may be directed through the first and second internal fluid conduits 424 and 425 in series because at least some cooling fluid from the coolant source 417 may be directed through the first internal fluid conduit 424 and then through the second internal fluid conduit 425 to the coolant destination 418, or through the second internal fluid conduit 425 and then through the first internal fluid conduit 424 to the coolant destination 418.

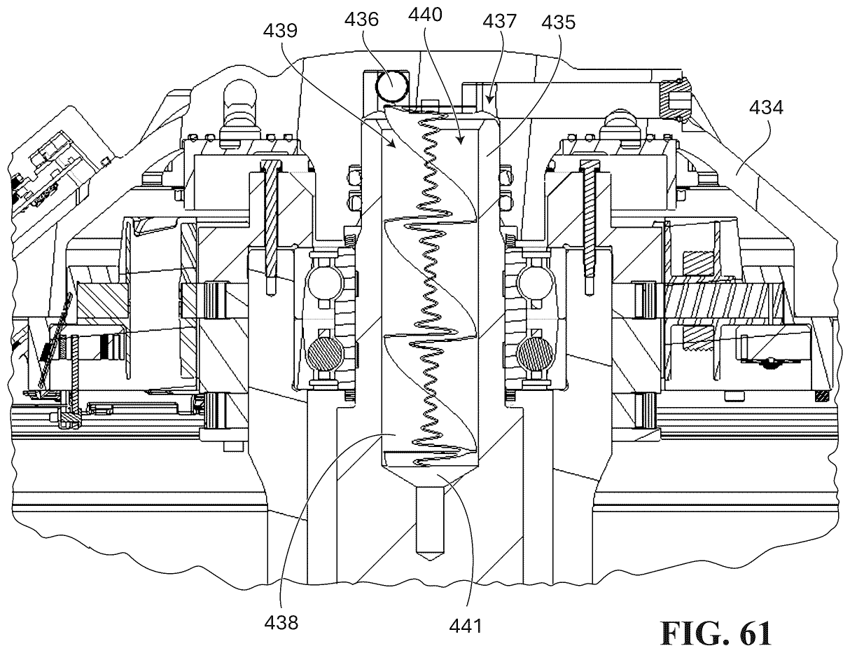

FIG. 61 illustrates a roll-stabilizer apparatus 434 according to another embodiment. The roll-stabilizer apparatus 434 may be similar to the roll-stabilizer apparatus 419 and includes a first internal fluid conduit 435 that may be similar to the first internal fluid conduit 424. The first internal fluid conduit 435 has first and second openings shown generally at 436 and 437 and includes a separator body 438 separating first and second portions shown generally at 439 and 440 of the first internal fluid conduit 435. The first portion 439 is in fluid communication with the first opening 436. The second portion 440 is in fluid communication with the second opening 437. A transition portion shown generally at 441 is in fluid communication with the first and second portions 439 and 440. As a result, cooling fluid from the coolant source 417 may be directed into the first opening 436, from the first opening 436 through the first portion 439 to the transition portion 441, from the transition portion 441 through the second portion 440, and from the second portion 440 out the second opening 437. However, unlike the separator body 430, the separator body 438 is twisted and may include a turbulator, for example.

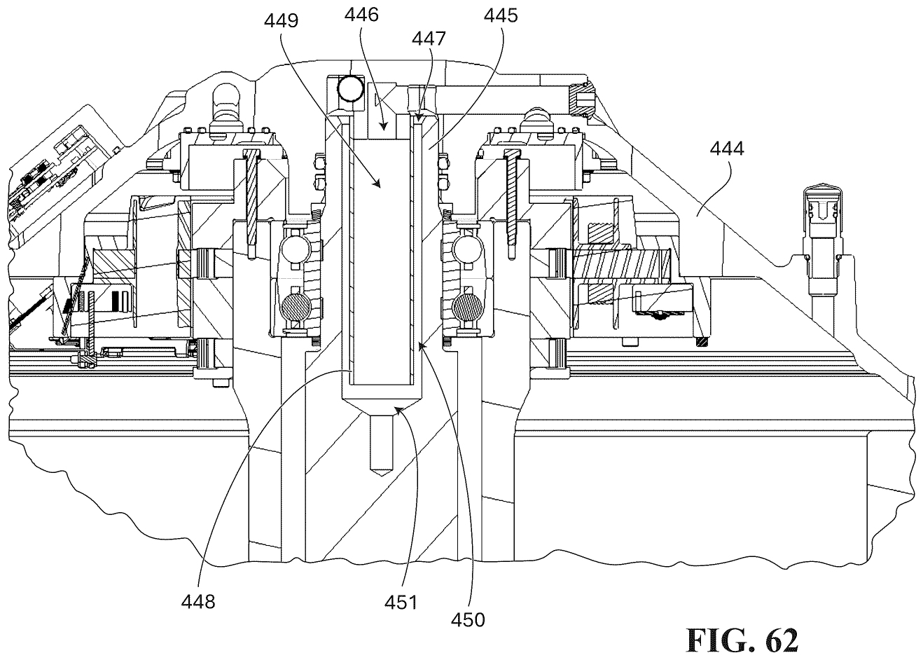

FIG. 62 illustrates a roll-stabilizer apparatus 444 according to another embodiment.

The roll-stabilizer apparatus 444 may be similar to the roll-stabilizer apparatus 419 and includes a first internal fluid conduit 445 that may be similar to the first internal fluid conduit 424. The first internal fluid conduit 445 has first and second openings shown generally at 446 and 447 and includes a separator body 448 separating first and second portions shown generally at 449 and 450 of the first internal fluid conduit 445. The first portion 449 is in fluid communication with the first opening 446. The second portion 450 is in fluid communication with the second opening 447. A transition portion shown generally at 451 is in fluid communication with the first and second portions 449 and 450. As a result, cooling fluid from the coolant source 417 may be directed into the first opening 446, from the first opening 446 through the first portion 449 to the transition portion 451, from the transition portion 451 through the second portion 450, and from the second portion 450 out the second opening 447. However, unlike the separator body 430, the separator body 448 is tubular such that the first and second portions 449 and 450 may be concentric, for example.

In general, the second internal fluid conduit 425, or other second internal fluid conduits as described herein for example, may include separator bodies such as the separator body 438 or 448.

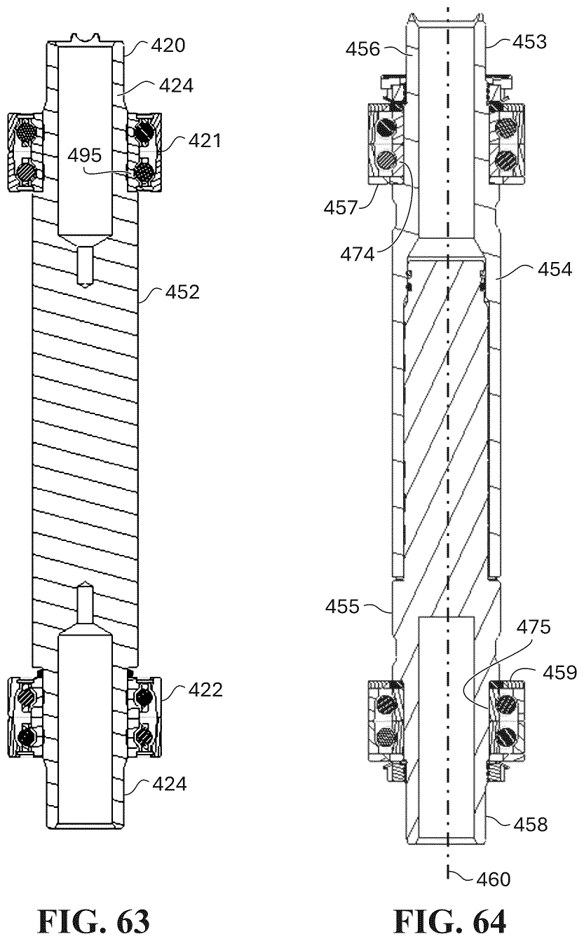

FIG. 63 illustrates the rotation-support body 420 including a unitary body 452 including the first and second internal fluid conduits 424 and 425.

FIG. 64 illustrates a rotation-support body 453 according to another embodiment. The rotation-support body 453 may function similarly to the rotation-support body 420 but includes first and second rotation-support-body portions 454 and 455. The first rotation-support-body portion 454 includes a first internal fluid conduit 456 that may be similar to the first internal fluid conduit 424, 435, or 445, for example. The first rotation-support-body portion 454 is attached or fixed to a bearing 457 that may function similarly to the bearing 252 or 421, for example. The second rotation-support-body portion 455 includes a second internal fluid conduit 458 that may be similar to the second internal fluid conduit 425, for example. The second rotation-support-body portion 455 is attached or fixed to a bearing 459 that may function similarly to the bearing 253 or 422, for example.

The first and second rotation-support-body portions 454 and 455 are slidable relative to each other along a central-rotation axis 460 of the rotation-support body 453, which may also be a central-rotation axis of a flywheel-support body (such as the flywheel-support body 234) including the rotation-support body 453. In the embodiment shown, portions of the first and second rotation-support-body portions 454 and 455 are telescopically slidable, but alternative embodiments may differ. Such sliding of the first and second rotation-support-body portions 454 and 455 are slidable relative to each other may accommodate differential thermal expansion and contraction without requiring the bearing 457 or 459 to slide relative to a unitary body such as the unitary body 452.

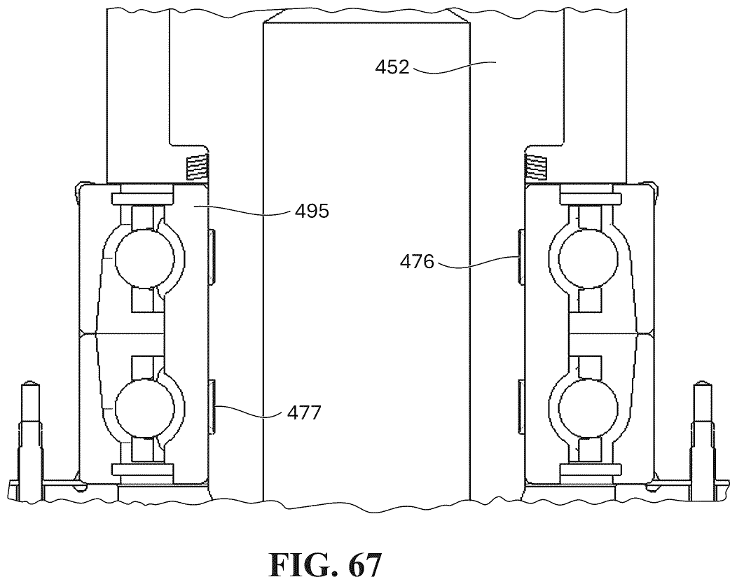

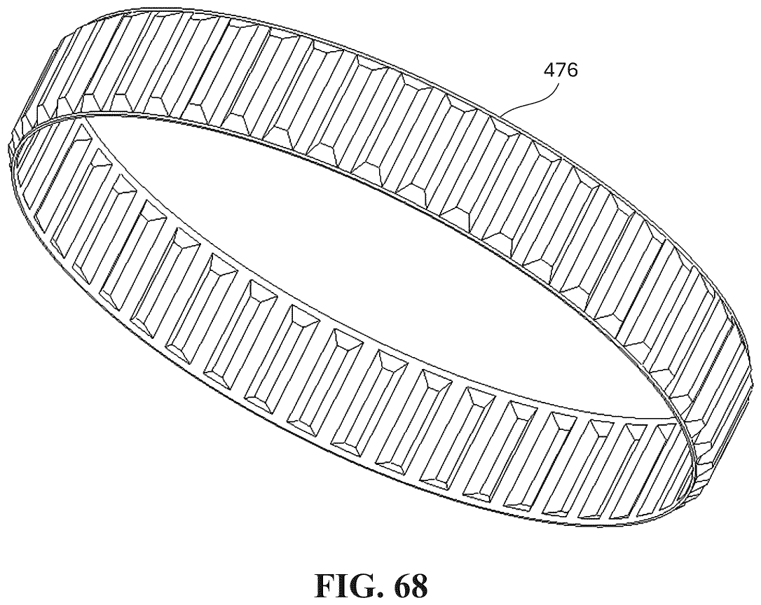

Because sliding of the first and second rotation-support-body portions 454 and 455 relative to each other may accommodate differential thermal expansion and contraction without requiring the bearing 457 or 459 to slide relative to a unitary body such as the unitary body 452, an inner race 474 of the bearing 457 may be fixed to the first rotation-support-body portion 454 and an inner race 475 of the bearing 459 may be fixed to the second rotation-support-body portion 455, for example by interference press-fitting. Because the inner race 474 may be fixed to the first rotation-support-body portion 454 and the inner race 475 may be fixed to the second rotation-support-body portion 455, one or more compressible bodies may be positioned between the inner race 474 and the first rotation-support-body portion 454 and between the inner race 475 and the second rotation-support-body portion 455. For example, FIG. 67 illustrates two compressible bodies 476 and 477 between the inner race 495 and the unitary body 452. Such a compressible body may include a tolerance ring as shown in FIG. 68.

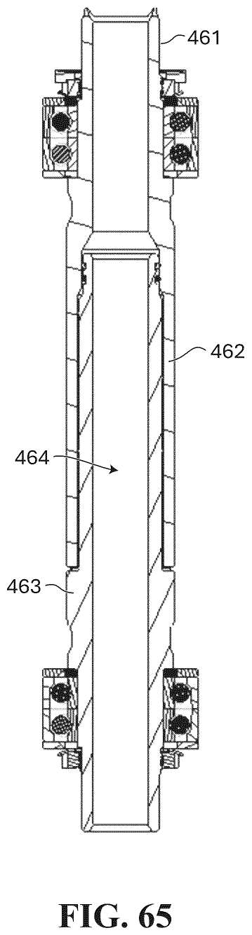

FIG. 65 illustrates a rotation-support body 461 according to another embodiment. The rotation-support body 453 includes first and second rotation-support-body portions 462 and 463 may function similarly to the rotation-support body 453, although the rotation-support body 461 defines an internal fluid conduit shown generally at 464 that, like the internal fluid conduit 254, extends to opposite sides of the rotation-support body 461 and to opposite sides of a flywheel body supported by the rotation-support body 461.

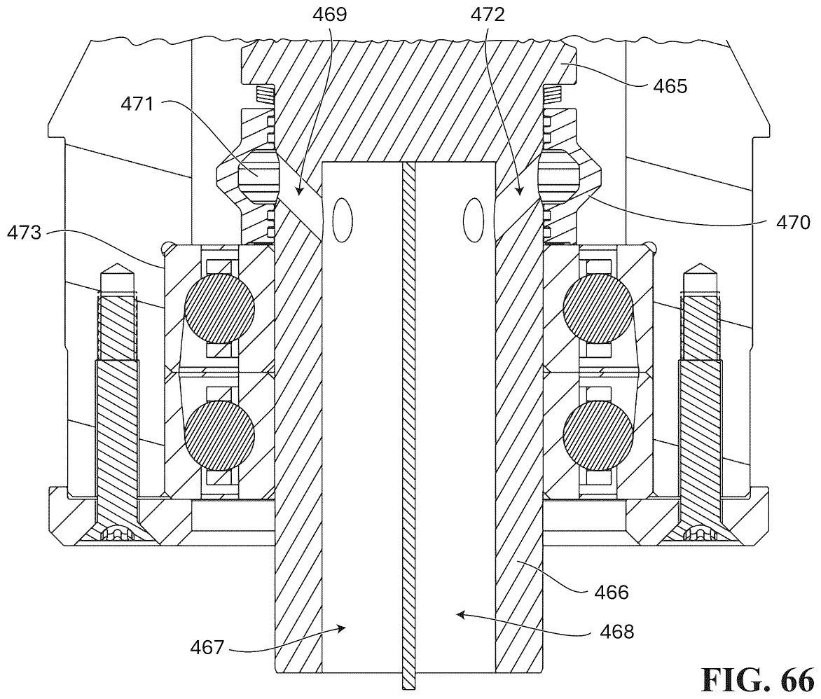

FIG. 66 illustrates a rotation-support body 465 according to another embodiment. The rotation-support body 465 may be similar to other rotation-support bodies as described herein and includes an internal fluid conduit 466 including first and second portions shown generally at 467 and 468. The first portion 467 may receive a cooling fluid as described above with reference to the first portion of the second internal fluid conduit 425. However, instead of passing cooling fluid from the first portion 467 to a transition portion such as the transition portion 433, 441, or 451, cooling fluid from the first portion 467 passes through a through-opening shown generally at 469 in the rotation-support body 465 to a heat-transfer body 470 that may surround a portion of the rotation-support body 465. The heat-transfer body 470 defines a fluid channel shown generally at 471 in fluid communication with the through-opening 469. The fluid channel 471 extends within the heat-transfer body 470 partly around the rotation-support body 465 and is in fluid communication with a through-opening shown generally at 472 in the rotation-support body 465 and in fluid communication with the second portion 468.

Therefore, cooling fluid received at an opening (such as the third opening 428) may enter the first portion 467 from such an opening and pass through the first portion 467, from the first portion 467 through the through-opening 469 to the fluid channel 471, through the fluid channel 471 to the through-opening 472, through the through-opening 472 to the second portion 468, through the second portion 468 to an opening (such as the fourth opening 429), and out such an opening. As a result, such cooling fluid may cool at least the heat-transfer body 470.

The heat-transfer body 470 is positioned thermally coupled to a bearing 473 that may be similar to the bearing 253 or 422 so that cooling the heat-transfer body 470 may cool the bearing 473. The heat-transfer body 470 may be thermally coupled to the bearing 473 by direct contact or indirect contact through one or more heat-conducting bodies, a heat-conducting pad, a heat-conducting paste, or two or more thereof. At least some thermal contact between the heat-transfer body 470 and bearing 473 is independent of the rotation-support body 465. At least some thermal contact between the heat-transfer body 470 and bearing 473 is radially outward from the rotation-support body 465. At least a portion of the heat-transfer body 470 overlaps radially with at least a portion of bearing 473. At least a portion of the fluid channel is radially outward from the rotation-support body 465. At least a portion of the fluid channel overlaps radially with at least a portion of bearing 473.

### Rotary Coolant Coupling

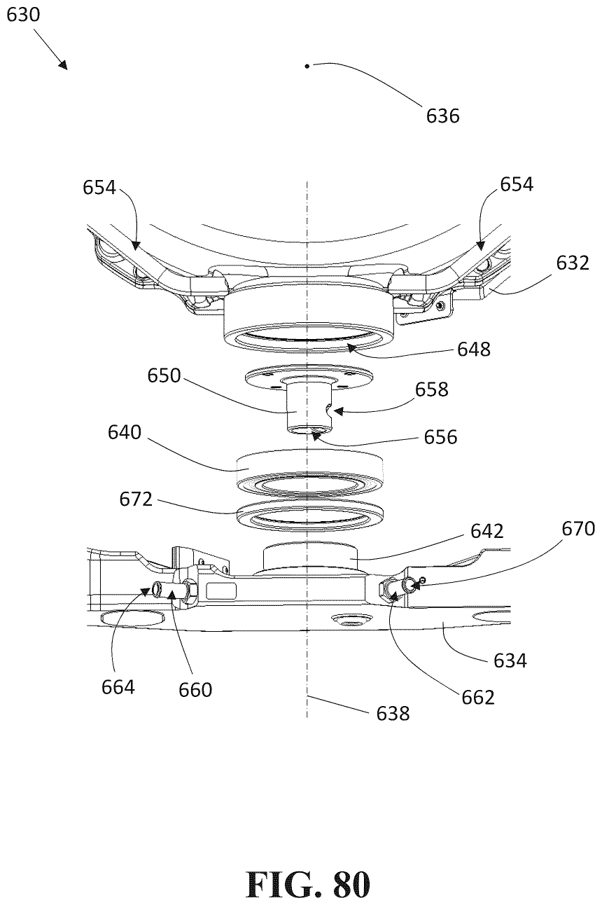

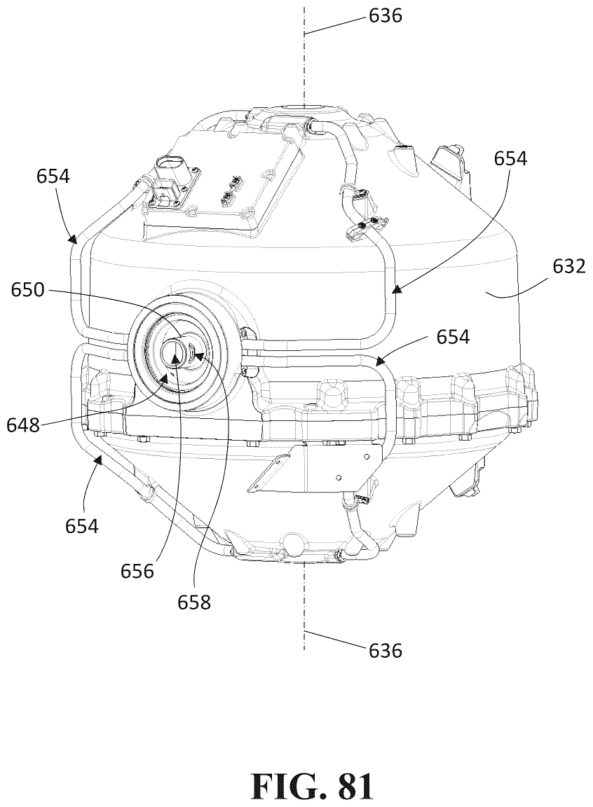

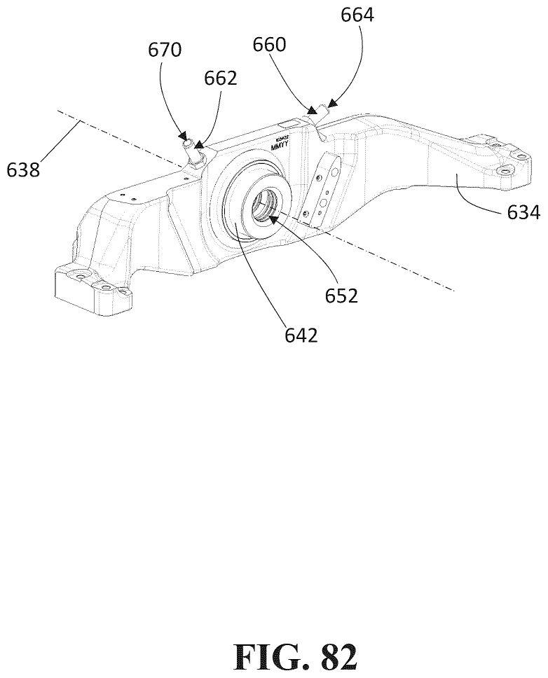

FIGS. 80 to 83 show a coolant coupling for a roll-stabilizer apparatus 630 according to one embodiment. The roll-stabilizer apparatus 630 includes a flywheel body (not shown) similar to the flywheel body 235 and to the flywheel body 423, a flywheel-support body 632 generally similar to the flywheel-support body 234 and to the flywheel-support body of the roll-stabilizer apparatus 419, and a mounting body 634 generally similar to the mounting body 236. In general, the flywheel-support body 632 supports the flywheel body and permits rotation of the flywheel body relative to the flywheel-support body 632 around at least one axis of rotation, such as a spin axis of rotation of the flywheel body and/or a central-rotation axis 636 of the flywheel-support body 632. The mounting body 634 generally supports the flywheel-support body 632 and permits rotation of the flywheel-support body 632 relative to the mounting body 634 around a precession axis 638 non-parallel to the at least one axis of rotation. The roll-stabilizer apparatus 630 also includes a precession bearing 640 which may function similarly to the precession bearings 267 and 268. That is, the precession bearing 640 is mounted on a precession bearing mount 642 of the mounting body 634, interfaces with the flywheel-support body 632, and is operable to support rotation of the flywheel-support body 632 relative to the mounting body 634 around the precession axis 638. The roll-stabilizer apparatus 630 may also include a cooling system such as the cooling system of the embodiments of FIGS. 60 to 66.

The precession bearing 640 includes an outer precession race 644 and an inner precession race 646. The outer precession race 644 surrounds the inner precession race 646 and is fixed to the flywheel-support body 632 within a precession bearing socket 648, while the inner precession race 646 interfaces with the precession bearing mount 642 of the mounting body 634. In some embodiments, the inner precession race 646 may be fixed to the precession bearing mount 642. However, in other embodiments, the inner precession race 646 may be a “floating” inner precession race, movable axially along the precession bearing mount 642 (i.e., along the precession axis 638). A “floating” inner race may be required to accommodate thermal expansion. The outer precession race 644 is operable to rotate relative to the inner precession race 646 and thus relative to the precession bearing mount 642 and, ultimately, the mounting body 634. As such, the precession bearing 640 includes an outer precession body (i.e., the outer precession race 644) that surrounds and is rotatable relative to the mounting body 634, and rotation of this outer precession body enables the flywheel-support body 632 to rotate relative to the mounting body 634.

In the embodiment shown, the flywheel-support body 632 includes a protruding portion 650 which protrudes from the precession bearing socket 648 and which is sized to fit into an opening 652 on the precession bearing mount 642 of the mounting body 634 within the inner precession race 646 of the precession bearing 640 when the flywheel-support body 632 is supported by the precession bearing 640 and the mounting body 634 for rotation relative to the mounting body 634 around the precession axis 638. That is, when the flywheel-support body 632 is supported for rotation by the precession bearing 640 and the mounting body 634, at least a portion of the protruding portion 650 of the flywheel-support body 632 is surrounded by the inner precession race 646 of the precession bearing 640 and by the precession bearing mount 642 of the mounting body 634. In the embodiment shown, the protruding portion 650 of the flywheel-support body 632 is removable from the flywheel-support body 632. However, in alternative embodiments, the protruding portion 650 may integrated with a housing of the flywheel-support body 632.

The flywheel-support body 632 of the embodiment shown in FIGS. 80 to 83 defines a flywheel-support-body fluid channel 654 which includes a first flywheel-support-body opening 656 and a second flywheel-support-body opening 658. More specifically, the protruding portion 650 of the flywheel-support body 632 defines the first flywheel-support-body opening 656 and the second flywheel-support-body opening 658. The flywheel-support-body fluid channel 654 is operable to convey a fluid through at least some of the flywheel-support body 632 between the first flywheel-support-body opening 656 and the second flywheel-support-body opening 658. For example, the flywheel-support-body fluid channel 654 may be operable to convey a coolant or cooling fluid through portions of the flywheel-support body 632, for example, in order to cool one or more operating bearings within the flywheel-support body 632, as described above with reference to the embodiments of FIGS. 60 to 66. For example, cooling fluid may enter the flywheel-support-body fluid channel 654 through the first flywheel-support-body opening 656 at a cold temperature, pass through the flywheel-support-body fluid channel 654, and, in doing so, provide cooling to, for example, one or more operating bearings, motors, and/or controllers within the flywheel-support body 632, and then exit the flywheel-support-body fluid channel 654 through the second flywheel-support-body opening 658 at a warm temperature.

The mounting body 634 defines a first mounting-body fluid channel 660 and a second mounting-body fluid channel 662. The first mounting-body fluid channel 660 includes a first mounting-body opening 664 and a second mounting-body opening 666, and is operable to convey a fluid through at least some of the mounting body 634 between the first mounting-body opening 664 and the second mounting-body opening 666. The second mounting-body fluid channel 662 includes a third mounting-body opening 668 and a fourth mounting-body opening 670, and is operable to convey a fluid through at least some of the mounting body 634 between the third mounting-body opening 668 and the fourth mounting-body opening 670. As described above, the first mounting-body fluid channel 660 and the second mounting-body fluid channel 662 may be operable to convey a coolant or cooling fluid through portions of the mounting body 634. For example, the first mounting-body fluid channel 660 may provide fresh (cold) cooling fluid to the flywheel-support-body fluid channel 654 and the second mounting-body fluid channel 662 may remove spent (warm) cooling fluid from the flywheel-support-body fluid channel 654. In some embodiments, the first mounting-body fluid channel 660 may be in fluid communication, through the first mounting-body opening 664, with a coolant source (not shown) such as a coolant pump to receive the fresh cooling fluid. In some embodiments, the second mounting-body fluid channel 662 may be in fluid communication, through the fourth mounting-body opening 670, with a coolant reservoir to dispose of the spent cooling fluid.

In general, when the flywheel-support body 632 is supported, by the precession bearing 640 and the mounting body 634, for rotation around the precession axis 638 relative to the mounting body 634, such that the outer precession race 644 of the precession bearing 640 is fixed to the flywheel-support body 632 and the inner precession race 646 interfaces with the precession bearing mount 642 of the mounting body 634, and such that at least a portion of the protruding portion 650 of the flywheel-support body 632 is surrounded by the inner precession race 646 and by the precession bearing mount 642, the second mounting-body opening 666 is in fluid communication with the first flywheel-support-body opening 656 and the second flywheel-support-body opening 658 is in fluid communication with the third mounting-body opening 668. Thus, for example, fluid may flow through roll-stabilizer apparatus 630 by passing through the first mounting-body opening 664, the first mounting-body fluid channel 660, the second mounting-body opening 666, the first flywheel-support-body opening 656, flywheel-support-body fluid channel 654, the second flywheel-support-body opening 658, the third mounting-body opening 668, the second mounting-body fluid channel 662, and the fourth mounting-body opening 670, while the flywheel-support body 632 is rotating around the precession axis 638 relative to the mounting body 634 (i.e., while the roll-stabilizer apparatus 630 is operating).

In the embodiment shown, the roll-stabilizer apparatus 630 also includes a bearing seal 672 and internal seal 674, 676, and 678. The bearing seal 672 and the internal seals 674, 676, and 678 may prevent fluid leakage between the flywheel-support body 632, the mounting body 634, and the precession bearing 640.
Also in the embodiment shown, the first flywheel-support-body opening 656 is a first radial distance 680 from the central-rotation axis 636 of the flywheel-support body 632, and the second flywheel-support-body opening 658 is a second radial distance 682 from the central-rotation axis 636 of the flywheel-support body 632, and the first radial distance 680 is different from the second radial distance 682. More specifically, the first radial distance 680 is greater than the second radial distance 682 (i.e., the first flywheel-support-body opening 656 is further away from the central-rotation axis 636 than the second flywheel-support-body opening 658). Accordingly, the second mounting-body opening 666 is also further from the central-rotation axis 636 than the third mounting-body opening 668. Electric Motor/Generator

Referring back to FIGS. 26 and 27, the flywheel-support body 234 also includes electric motor/generator and 259 electrically connected (either directly or indirectly, such as indirectly through the roll-stabilizer controller 109) to the roll-stabilizer energy-storage device 110 (shown in FIG. 1) such that the electric motor/generator 259 may use electric energy stored by the roll-stabilizer energy-storage device 110 to apply a torque to the flywheel body 235 around the spin axis of rotation 237 relative to the flywheel-support body 234. In some embodiments, the electric motor/generator 259 may have multiple different windings to facilitate generating different torque profiles, which may provide higher rates of acceleration or deceleration. As used herein, the term “electric motor/generator” excludes any electrical or other connections, such as wires, studs, or plugs.

Further, the electric motor/generator 259 may convert rotational kinetic energy, from rotation of the flywheel body 235 around the spin axis of rotation 237 relative to the flywheel-support body 234, to electrical energy, and the electric motor/generator 259 is electrically connected to the roll-stabilizer energy-storage device 110 such that the roll-stabilizer energy-storage device 110 may receive and store such electrical energy converted from such rotational kinetic energy. Of course, the embodiment shown is an example only, and alternative embodiments may vary. For example, in some alternative embodiments, the electric motor/generator 259 may be electrically connected to a dedicated roll-stabilizer energy-storage device (not shown) that is external to the roll-stabilizer assembly 107 and distinct from both the main energy-storage device 105 and the roll-stabilizer energy-storage device 110.

In the embodiment shown, the electric motor/generator 259 is located entirely within the internal cavity 247 of the flywheel-support body 234. As such, when the internal cavity 247 contains the flywheel body 235 in an internal environment different than an ambient external environment, the electric motor/generator 259 will also be contained in this internal environment. In such embodiments, electrical connections (not shown) to the electric motor/generator 259 could pass through the housing 246 into the internal cavity 247.

The electric motor/generator 259 is an examples only, and alternative embodiments may differ. For example, an alternative embodiment may include only electric motors, or may include an electric motor and an electric generator separate from the electric motor. Further, an alternative embodiment may include numbers of electric motors, electric generators, or electric motor/generators that may differ from the electric motor/generator 259. Also, alternative embodiments could generate torque in other ways. For example, alternative embodiments may include a hydraulic pump and motor, or could use air power.

### Mounting Body

Referring now to FIGS. 25 to 27 and 29 to 31, the mounting body 236 includes a base 260 attachable to one or more other structures in the roll-stabilizer assembly 107, which may be attached to the hull 101 directly or indirectly to attach mounting body 236, and thus the roll-stabilizer apparatus 233, to the hull 101. However, in alternative embodiments, the roll-stabilizer apparatus 233 may be attached directly or indirectly to the hull 101 in other ways, or the roll-stabilizer apparatus 233 may not be attached to any hull or to any marine vessel. Therefore, in some embodiments, measurements of linear acceleration, of rotational acceleration, of orientation, or a combination of two or more thereof of the hull 101, relative to an inertial frame of reference or another frame of reference, by the inertial measurement unit 111 may indicate such acceleration, orientation, or both of the mounting body 236 relative to such a frame of reference. In other embodiments, the roll-stabilizer apparatus 233 may itself have an onboard inertial measurement unit (not shown), for example attached to the flywheel-support body 234. Therefore, references herein to movement, acceleration, or orientation of the mounting body 236, relative to an inertial frame of reference or another frame of reference, may refer to movement, acceleration, or orientation, relative to such a frame of reference, of the inertial measurement unit 111 or of any other location that may be attached directly or indirectly to the mounting body 236 or that may otherwise move with mounting body 236.

The base 260 includes base structures 261, 262, 263, and 264, which, when assembled together, form the base 260. The base structure 263 includes a precession bearing mount 265, and the base structure 264 includes a precession bearing mount 266. The mounting body 236 further includes precession bearings 267 and 268 mounted on the precession bearing mounts 265 and 266, respectively. The precession bearings 267 and 268 interface with the flywheel-support body 234 and are operable to support rotation of the flywheel-support body 234 relative to the base 260 of the mounting body 236 around a precession axis 269.

The base structures 261, 262, 263, and 264 are spaced apart from each other to define a space between the base structures 261, 262, 263, and 264 to receive the flywheel-support body 234. The space between the base structures 261, 262, 263, and 264 is sized and shaped to permit rotation of the flywheel-support body 234 relative to the mounting body 236 around the precession axis 269. In the embodiment shown, the precession axis 269 is generally perpendicular to the spin axis of rotation 237 of the flywheel body 235. However, in alternative embodiments, the precession axis 269 may be non-parallel to, and not necessarily perpendicular to, the spin axis of rotation 237.

In some embodiments, movement of the flywheel-support body 234 relative to the mounting body 236 may be constrained to rotation of the flywheel-support body 234 relative to the mounting body 236 around the precession axis 269. However, alternative embodiments may differ. For example, in alternative embodiments, the flywheel-support body 234 may be mounted for both translation and rotation relative to the mounting body 236, for example using a linkage such as a four-bar linkage.

### Precession Bearings

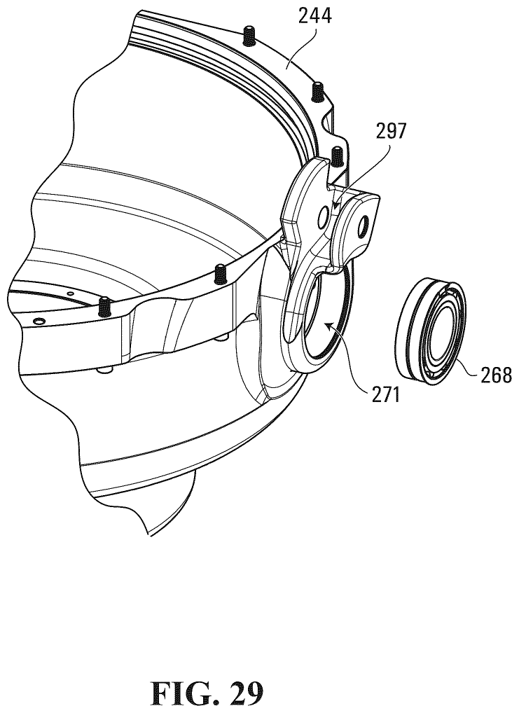

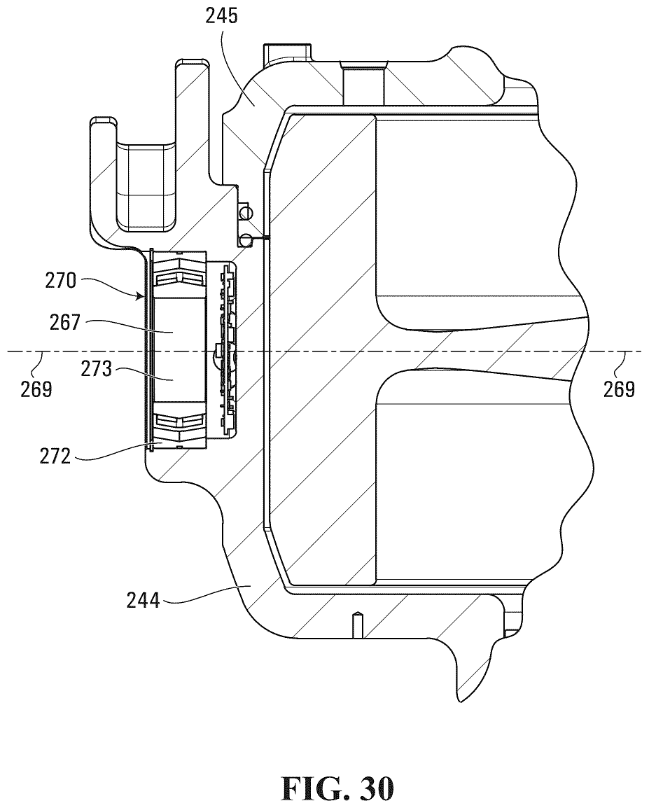

Referring now to FIGS. 26, 27, 29, and 30, in the embodiment shown, the precession bearings 267 and 268 support the flywheel-support body 234 by being positioned in and interfacing with precession bearing sockets, shown generally at 270 and 271, which are integrated directly into the housing body 244 of the flywheel-support body 234. FIG. 29 provides a more detailed view of the precession bearing socket 271 for precession bearing 268. The precession bearings 267 and 268 in the embodiment shown are mechanical bearings. Considering as an example the precession bearing 267 as shown in greater detail in FIG. 30, the precession bearing 267 includes an outer precession race 272 and an inner precession race 273. The outer precession race 272 is fixed to the housing body 244 within the precession bearing socket 270, while the inner precession race 273 interfaces with the precession bearing mount 265 of the base structure 263 of the mounting body 236. In some embodiments, the inner precession race 273 may be fixed to the precession bearing mount 265. However, in other embodiments, the inner precession race 273 may be a “floating” inner precession race, movable axially along the precession bearing mount 265 (i.e., along the precession axis 269). A “floating” inner race may be required to accommodate thermal expansion. The outer precession race 272 is operable to rotate relative to the inner precession race 273 and thus relative to the precession bearing mount 265 and, ultimately, the mounting body 236. As such, each of the precession bearings 267 and 268 includes an outer precession body (i.e., the outer precession race 272 of the precession bearing 267) that is rotatable relative to the mounting body 236, and rotation of these outer precession bodies enables the flywheel-support body 234 to rotate relative to the mounting body 236. Of course, the embodiment shown is an example only, and alternative may differ. For example, alternative embodiments may include a different number of precession bearings. Other alternative embodiments may include bearings other than mechanical bearings.

### Precession-Control Devices

Referring now to FIGS. 25 to 27 and 31 to 35, the mounting body 236 also includes precession-control devices 274 and 275 operable to control rotation of the flywheel-support body 234 relative to the mounting body 236 around the precession axis 269. In general, a precession-control device may include an actuator, which may be a linear actuator or a torsional actuator, and which may be an electromechanical actuator, a screw actuator, a hydraulic actuator, or a pneumatic actuator. Further, a precession-control device may include a shock absorber, a damper, an electric generator, or another device that can apply a resistive torque to the flywheel-support body 234 relative to the mounting body 236 to dampen the rotation of the flywheel-support body 234 relative to the mounting body 236.

The precession-control device 274 includes a linear actuator 276 (such as a screw actuator, for example) and a precession linkage 277. The linear actuator 276 includes a mounting body end 278 and a force-transfer body end 279. The precession linkage 277 includes a first force-transfer body 280 and a second-force transfer body 281. The first force-transfer body 280 includes a flywheel-support body end 282 and an actuator end 283. The second-force transfer body 281 includes a force-transfer linkage end 284 and a constraining end 285. The mounting body end 278 of the linear actuator 276 is rotatably attached to the base structure 263 of the base 260. The flywheel-support body end 282 of the first force-transfer body 280 is rotatably attached to the flywheel-support body 234. The actuator end 283 of the first force-transfer body 280 is rotatably attached to the force-transfer body end 279 of the linear actuator 276 and also to the force-transfer linkage end 284 of the second force-transfer body 281. The constraining end 285 of the second force-transfer body 281 is rotatably attached to the base structure 263 of the base 260. Through the rotatable connections described above, the first force-transfer body 280 is connected to both the linear actuator 276 and the flywheel-support body 234, and is therefore operable to transfer force between the linear actuator 276 and the flywheel-support body 234. Further, the rotatable connection between the first force-transfer body 280 and the flywheel-support body 234 is positioned at a distance away from the precession axis 269, such that linear extension or contraction of the linear actuator 276 may, by transferring force through the first force-transfer body 280, apply a torque to and cause and/or resist rotation of the flywheel-support body 234 around the precession axis 269 relative to the base 260 of the mounting body 236, and, correspondingly, such that rotation of the flywheel-support body 234 around the precession axis 269 relative to the base 260 may cause linear extension or contraction of the linear actuator 276. The rotatable connection between the mounting body end 278 of the linear actuator 276 and the base structure 263, together with the second-force transfer body 281 and its rotatable connections to the first force-transfer body 280 and the base structure 263, constrain a range of motion of the flywheel-support body 234, the linear actuator 276, and the first force-transfer body 280 such that the force transferred through the first force-transfer body 280 may be close to linearly related to the torque applied to the flywheel-support body 234.

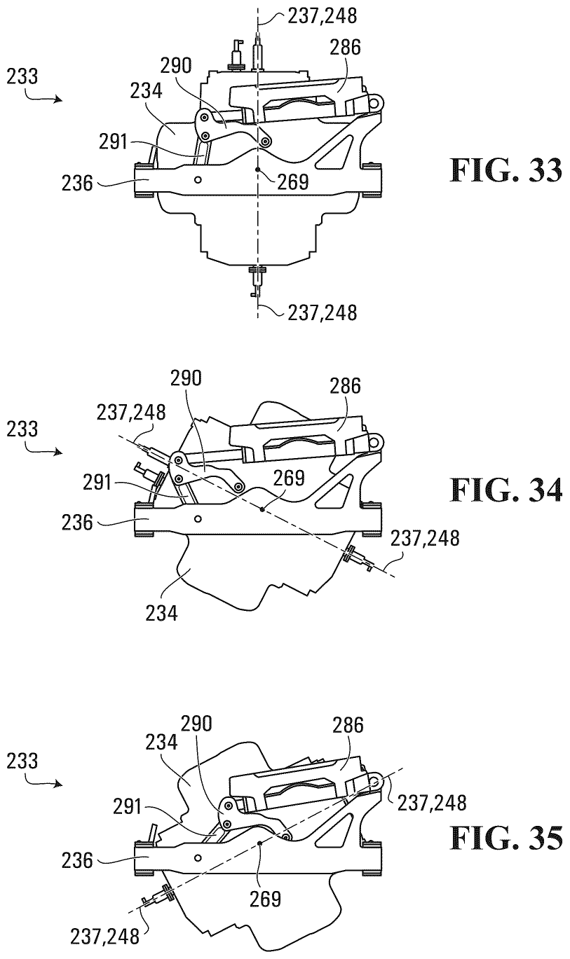

Similarly, the precession-control device 275 includes a linear actuator 286 and a precession linkage 287. The linear actuator 286 includes a mounting body end 288 and a force-transfer body end 289. The precession linkage 287 includes a first force-transfer body 290 and a second force-transfer body 291. The first force-transfer body 290 includes a flywheel-support body end 292 and an actuator end 293. The second force-transfer body 291 includes a force-transfer linkage end 294 and a constraining end 295. The mounting body end 288 of the linear actuator 286 is rotatably attached to the base structure 264 of the base 260. The flywheel-support body end 292 of the first force-transfer body 290 is rotatably attached to the flywheel-support body 234. The actuator end 293 of the first force-transfer body 290 is rotatably attached to the force-transfer body end 289 of the linear actuator 286 and also to the force-transfer linkage end 294 of the second force-transfer body 291. The constraining end 295 of the second force-transfer body 291 is rotatably attached to the base structure 264 of the base 260. Through the rotatable connections described above, the first force-transfer body 290 is connected to both the linear actuator 286 and the flywheel-support body 234, and is therefore operable to transfer force between the linear actuator 286 and the flywheel-support body 234. Further, the rotatable connection between the first force-transfer body 290 and the flywheel-support body 234 is positioned at a distance away from the precession axis 269, such that linear extension or contraction of the linear actuator 286 may, by transferring force through the first force-transfer body 290, apply a torque to and cause rotation of the flywheel-support body 234 around the precession axis 269 relative to the base 260 of the mounting body 236, and, correspondingly, such that rotation of the flywheel-support body 234 around the precession axis 269 relative to the base 260 may cause linear extension or contraction of the linear actuator 286. The rotatable connection between the mounting body end 288 of the linear actuator 286 and the base structure 264, together with the second force-transfer body 291 and its rotatable connections to the first force-transfer body 290 and the base structure 263, constrain a range of motion of the flywheel-support body 234, the linear actuator 286, and the first force-transfer body 290 such that the force transferred through the first force-transfer body 290 may be close to linearly related to the torque applied to the flywheel-support body 234. FIGS. 33 to 35 provide a demonstration of this force-transfer relationship.

In the embodiment shown, each of the rotatable connections between the flywheel-support body 234 and the first force-transfer bodies 280 and 290 of the precession-control devices 274 and 275, respectively, is positioned such that it at least partly overlaps with a width of the precession bearings 267 and 268, respectively, along the precession axis 269. More specifically, as shown in particular in FIG. 27, the housing body 244 of the flywheel-support body 234 includes a linkage socket shown generally at 296 which is positioned such that it at least partly overlaps with a width of the precession bearing 267 along the precession axis 269, and also includes a linkage socket shown generally at 297 which is positioned such that it at least partly overlaps with a width of the precession bearing 268 along the precession axis 269. The flywheel-support body ends 282 and 292 of the first force-transfer bodies 280 and 290, respectively, are rotatably connected to the housing body 244 within the linkage sockets 296 and 297, respectively. Similarly, each of the rotatable connections between the first force transfer bodies 280 and 290 and the second force-transfer bodies 281 and 291, between the first force transfer bodies 280 and 290 and the linear actuators 276 and 286, between the linear actuators 276 and 286 and the base structures 263 and 264, and between the second force-transfer bodies 281 and 291 and the base structures 263 and 264 is positioned such that it at least partly overlaps with a width of the precession bearings 267 and 268 along the precession axis 269.

Thus, each of the precession-control devices 274 and 275 is operable to apply a force at least partly overlapping a width of a respective precession bearing (i.e., the precession bearing 267 or the precession bearing 268, respectively) along the precession axis 269. Furthermore, because the precession bearings 267 and 268 are fixed to the flywheel-support body 234 within the precession bearing sockets 270 and 271, respectively, which are integrated directly into the flywheel-support body 234, the precession-control devices 274 and 275 are operable to apply forces to the flywheel-support body 234 at least partly overlapping a width of the precession bearings along the precession axis 269. Compared to other embodiments that have linkages occupying space between the mounting body 236 and the flywheel-support body 234 (and thus requiring a gap along the precession axis 269 between the mounting body 236 and the flywheel-support body 234), the configuration of the embodiment shown may permit a larger allowable size of the flywheel body 235 for a given size of the roll-stabilizer apparatus 233.

For example, with reference to FIG. 25, the size of the roll-stabilizer apparatus 233 may be considered to be represented by a width W of the base 260 of the mounting body 236 along the precession axis 269, extending from an outermost surface of the base structure 263 to an outermost surface of the base structure 264. Similarly, with reference to FIG. 27, the size of the flywheel body 235 may be considered to be represented by a diameter D of the flywheel body 235. Using these definitions, the configuration of the embodiment shown may allow a ratio of the diameter D to the width W to be greater than 62%. For example, in the embodiment shown, the ratio D:W may be about 63%, about 64%, about 65%, about 66%, about 67%, about 68%, about 69%, about 70%, about 71%, about 72%, about 73%, or about 74%. A larger flywheel body (i.e., with a larger radius) may generally allow a greater moment of inertia. Because of this, larger flywheel bodies may generally require a lower rotation speed to achieve a given angular momentum for roll stabilization. Lower operational rotation speeds may be advantageous because they can correspond to longer bearing life and lower power draw. Additionally, at lower speeds, there is less energy stored in the flywheel, which corresponds to shorter spin-up/spin-down times, as well as greater safety.

The description above refers to widths of precession bearings along the precession axis 269 and refers to a width W of the base 260 along the precession axis 269. Such widths may describe embodiments in which the precession axis 269 extends horizontally and perpendicular to the longitudinal axis 106, namely transversely relative to the hull 101. However, references to widths of precession bearings and to a width W of a base may be understood more generally as references to dimensions that may be but are not necessarily widths. For example, in an embodiment in which a precession axis is vertical, generally vertical, or normal to or otherwise outside of a plane including longitudinal and transverse axes of at least one hull, references to widths of precession bearings and to a width W of a base may be understood as references to vertical or other dimensions that are not necessarily widths.

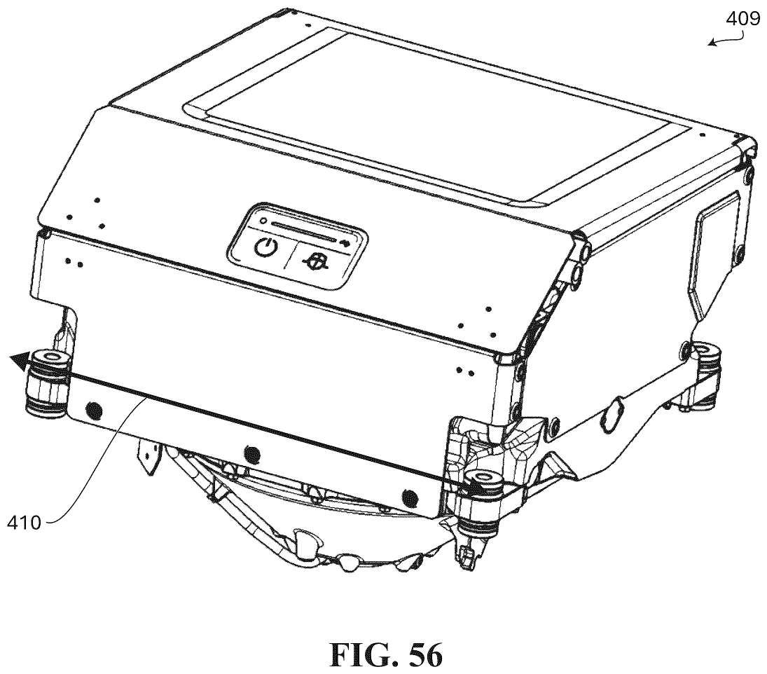

FIG. 56 illustrates a roll-stabilizer assembly shown generally at 409 that may be similar to the roll-stabilizer assembly 107 or that may include a different roll-stabilizer apparatus such as a roll-stabilizer apparatus as described herein for example. The roll-stabilizer apparatus of the roll-stabilizer assembly 409 includes a flywheel body such as one of the flywheel bodies described herein for example, and the flywheel body has a mass m and a moment of inertia I. The roll-stabilizer apparatus of the roll-stabilizer assembly 409 also includes a flywheel-support body such as one of the flywheel-support bodies described herein for example, and the flywheel-support body has a central-rotation axis such as the central-rotation axis 141 or 248, for example. The roll-stabilizer assembly 409 has a largest transverse dimension 410 (or w) transverse to the central-rotation axis of the flywheel-support body of the roll-stabilizer apparatus of the roll-stabilizer assembly 409.

In some embodiments, a ratio of I/mw² is greater than 0.34, greater than 0.35, greater than 0.36, greater than 0.37, greater than 0.38, greater than 0.39, greater than 0.40, greater than 0.41, greater than 0.42, greater than 0.43, greater than 0.44, greater than 0.45, greater than 0.46, greater than 0.47, greater than 0.48, greater than 0.49, greater than 0.50, greater than 0.51, greater than 0.52, greater than 0.54, or greater than 0.54.

### Flywheel Controller

Referring now to FIGS. 25 and 26, in the embodiment shown, the flywheel-support body 234 includes a flywheel controller 298 in communication with the roll-stabilizer controller 109 (shown in FIG. 1) and with the electric motor/generator 259. The flywheel controller 298 may receive one or more control signals from the roll-stabilizer controller 109, and the flywheel controller 298 may in turn send one or more control signals to the electric motor/generator 259 to control the torque applied by the electric motor/generator 259 to the flywheel body 235 around the spin axis of rotation 237, and/or the speed of rotation of the flywheel body 235 around the spin axis of rotation 237. Mounting of the flywheel controller 298 directly on the flywheel-support body 234 may minimize an amount of wiring required to provide control of the electric motor/generator 259. In some embodiments, the flywheel controller 298 may send one or more control signals to the electric motor/generator 259 to control the electric motor/generator 259 to vary the speed at which the flywheel body 235 rotates around the spin axis of rotation 237 depending on sea conditions. For example, the flywheel controller 298 may send control signals to the electric motor/generator 259 to cause the flywheel body 235 to rotate slowly in calm seas, which may save energy, and may send control signals to the electric motor/generator 259 to cause the flywheel body 235 to rotate quickly in rough seas, thus providing greater stabilization. This variable rotation speed control of the flywheel body 235 provided by the flywheel controller 298 may include multiple flywheel body 235 rotation speeds, or a continuous range of flywheel body 235 rotation speeds.

### Brake Circuit

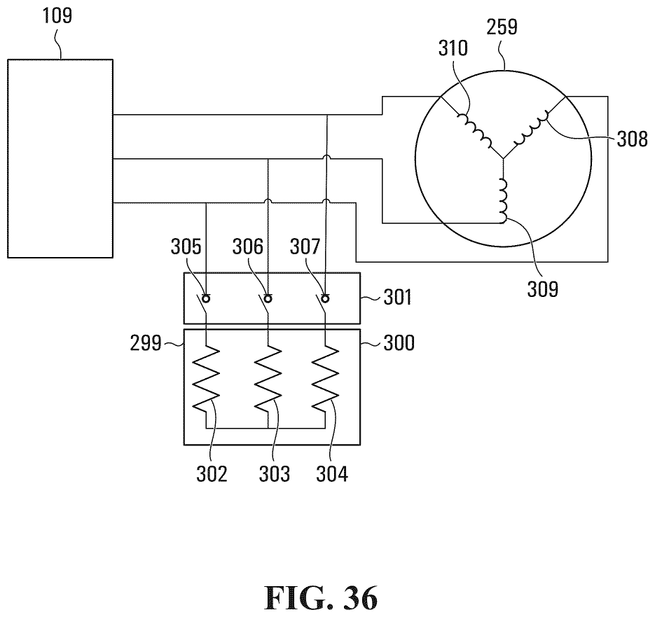

Referring now to FIG. 36, in some embodiments, the electric motor/generator 259 may also be in electrical communication with a brake circuit such as brake circuit 299. The brake circuit 299 includes a resistor bank 300 and a switch bank 301. In the embodiment shown, the resistor bank 300 includes resistors 302, 303, and 304, and the switch bank 301 includes switches 305, 306, and 307. The switches 305, 306, and 307 are operable to reversibly electrically connect the electric motor/generator 259 to the resistors 302, 303, and 304. Connection of the electric motor/generator 259 to the resistors 302, 303, and 304 may short circuit phase windings 308, 309, and 310 of the electric motor/generator 259 and may thus cause the electric motor/generator 259 to apply a resistive torque to the flywheel body 235 relative to the flywheel-support body 234 to dampen the rotation of the flywheel body 235 relative to the flywheel-support body 234. In the embodiment shown in FIG. 36, the brake circuit 299 is in communication with the roll-stabilizer controller 109 to receive one or more control signals from the roll-stabilizer controller 109. For example, the roll-stabilizer controller 109 may be operable to provide braking signals to the brake circuit 299. In response to these braking signals, the switches 305, 306, and 307 of the brake circuit 299 may be configured to connect the electric motor/generator 259 to the resistors 302, 303, and 304. The switches 305, 306, and 307 may also be configured to connect the electric motor/generator 259 to the resistors 302, 303, and 304 in response to, for example, a failure of the roll-stabilizer controller 109.

### Operation

Each of the precession-control devices 274 and 275 is also in communication with the roll-stabilizer controller 109 to receive one or more control signals from the roll-stabilizer controller 109. The one or more control signals received from the roll-stabilizer controller 109 may be used to control the precession-control devices 274 and 275, as described above with respect to the precession-control devices 120 and 121 of the roll-stabilizer apparatus 108. Further, each of the precession-control devices 274 and 275 is an electromechanical actuator operable to extend and contract to apply a torque to, and to rotate, the flywheel-support body 234 around the precession axis 269 relative to the base 260 in response to, at least, one or more control signals from the roll-stabilizer controller 109. Such a torque applied by the precession-control devices 274 and 275 may differ from a resistive torque because, for example, a torque applied by the precession-control devices 274 and 275 may cause rotation of the flywheel-support body 234 around the precession axis 269 relative to the base 260 in a same direction as the applied torque, and the applied torque may be independent of rotation of the flywheel-support body 234 around the precession axis 269 relative to the base 260.

Further, each of the precession-control devices 274 and 275 is operable to generate electrical energy from rotation of the flywheel-support body 234 around the precession axis 269 relative to the base 260 and thereby dampen precession of the flywheel-support body 234 around the precession axis 269 relative to the base 260. The precession-control devices 274 and 275 are electrically connected to the roll-stabilizer energy-storage device 110 such that electrical energy generated by the precession-control devices 274 and 275 may be stored by the roll-stabilizer energy-storage device 110.

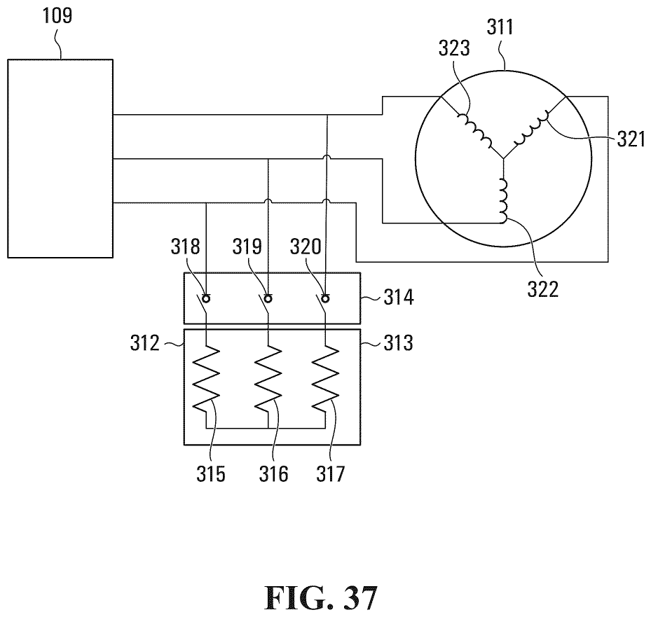

Referring now to FIG. 37, in some embodiments, each of the linear actuators 276 and 286 of the precession-control devices 274 and 275 may have an actuator motor, such as actuator motor 311. The actuator motor 311 may be in electrical communication with a damping circuit such as damping circuit 312. The damping circuit 312 includes a resistor bank 313 and a switch bank 314. In the embodiment shown, the resistor bank 313 includes resistors 315, 316, and 317, and the switch bank 314 includes switches 318, 319, and 320. The switches 318, 319, and 320 are operable to reversibly electrically connect the actuator motor 311 to the resistors 315, 316, and 317. Connection of the actuator motor 311 to the resistors 315, 316, and 317 may short circuit phase windings 321, 322, and 323 of the actuator motor 311 and may thus cause the actuator motor 311 to apply a resistive torque to the flywheel-support body 234 relative to the mounting body 236 to dampen the rotation of the flywheel-support body 234 relative to the mounting body 236. In some embodiments, the damping circuit 312 may be in communication with the roll-stabilizer controller 109 to receive one or more control signals from the roll-stabilizer controller 109. For example, the roll-stabilizer controller 109 may be operable to provide damping signals to the damping circuit 312. In response to these damping signals, the switches 318, 319, and 320 may be configured to connect the actuator motor 311 to the resistors 315, 316, and 317. The switches 318, 319, and 320 may also be configured to connect the actuator motor 311 to the resistors 315, 316, and 317 in response to, for example, a failure of the roll-stabilizer controller 109 or a loss of power.

In some embodiments, minimizing backlash or lost motion between the flywheel-support body 234 and the precession-control devices 274 and 275, or between the mounting body 236 and the precession-control devices 274 and 275, may be important for controlling stability.

However, alternative embodiments may differ. For example, alternative embodiments may include more or fewer precession-control devices that may differ from the precession-control devices 274 and 275. For example, a precession-control device according to an alternative embodiment may include a different electromechanical actuator, a different electric generator, or both, and some embodiments may omit such precession-control devices. Further, alternative embodiments may differ and may include hydraulic actuators, torsional actuators, or both, for example. Also, precession-control devices of alternative embodiments need not be actuators, but could apply only resistive forces or torques that simply resist or dampen movement of the flywheel-support body 234 relative to the mounting body 236.

### Other Precession-Control Devices

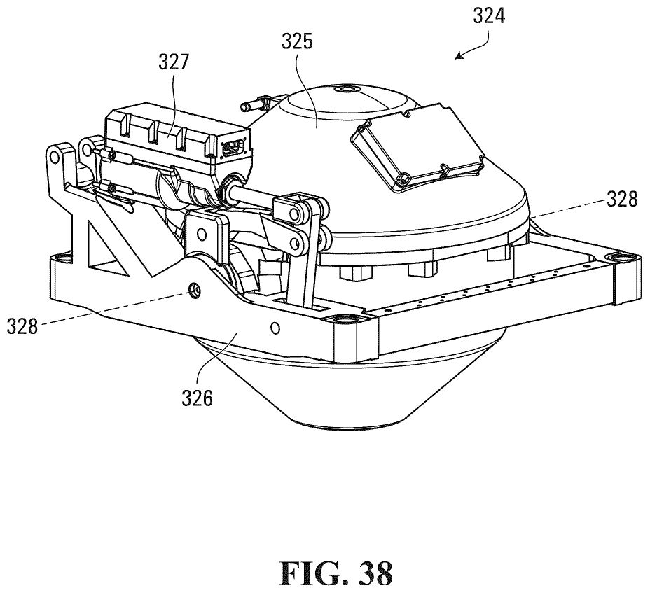

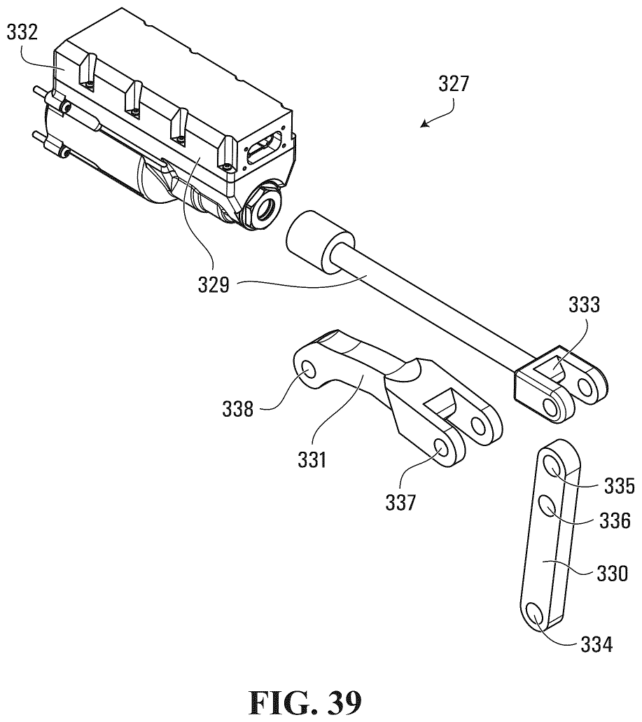

One example of an alternative embodiment with a different precession-control device is provided in FIGS. 38 and 39. In FIG. 38, a roll-stabilizer apparatus according to this alternative embodiment is shown generally at 324 and, similar to the roll-stabilizer apparatus 233, includes a flywheel-support body 325, a flywheel body (not shown) inside the flywheel-support body 325, a mounting body 326, and a precession-control device 327. The precession-control device 327 of the roll-stabilizer apparatus 324 is similar to the precession-control devices 274 and 275 of the roll-stabilizer apparatus 233, and is operable to control rotation of the flywheel-support body 325 relative to the mounting body 326 around a precession axis 328.

As with the precession axis of rotation 119 and the precession axis 269, the precession axis 328 in some embodiments may extend horizontally and perpendicular to the longitudinal axis 106, namely transversely relative to the hull 101. However, alternative embodiments may differ. For example, in some embodiments, the precession axis 328 may extend vertically or in another direction that is not parallel (and that may be perpendicular) to the longitudinal axis 106 of the marine vessel 100.

However, as shown in greater detail in FIG. 39, the precession-control device 327 has a different configuration than the precession-control devices 274 and 275. More specifically, the precession-control device 327 includes an actuator 329 (such as a screw actuator, for example), a first force-transfer body 330, and a second force-transfer body 331. The actuator 329 includes a mounting body end 332 and a force-transfer body end 333; the first force-transfer body 330 includes a constraining end 334, an actuator end 335, and a force-transfer linkage portion 336; and the second force-transfer body 331 includes a force-transfer linkage end 337 and a flywheel-support body end 338. The mounting body end 332 of the actuator 329 is rotatably attached to the mounting body 326. The constraining end 334 of the first force-transfer body 330 is also rotatably attached to the mounting body 326. The actuator end 335 of the first force-transfer body 330 is rotatably attached to the force-transfer body end 333 of the actuator 329. The force-transfer linkage end 337 of the second force-transfer body 331 is rotatably attached to the force-transfer linkage portion 336 of the first force-transfer body 330. The flywheel-support body end 338 of the second force-transfer body 331 is rotatably attached to the flywheel-support body 325. Through the rotatable connections described above, the first force-transfer body 330 and the second force-transfer body 331 are operable to transfer force between the actuator 329 and the flywheel-support body 325. Further, the rotatable connection between the second force-transfer body 331 and the flywheel-support body 325 is positioned at a distance away from the precession axis 328, such that linear extension or contraction of the actuator 329 may, by transferring force through the first force-transfer body 330 and the second force-transfer body 331, apply a torque to and cause and/or resist rotation of the flywheel-support body 325 around the precession axis 328 relative to the mounting body 326, and, correspondingly, such that rotation of the flywheel-support body 325 around the precession axis 328 relative to the mounting body 326 may cause linear extension or contraction of the actuator 329.

### Precession Linkage Bearings

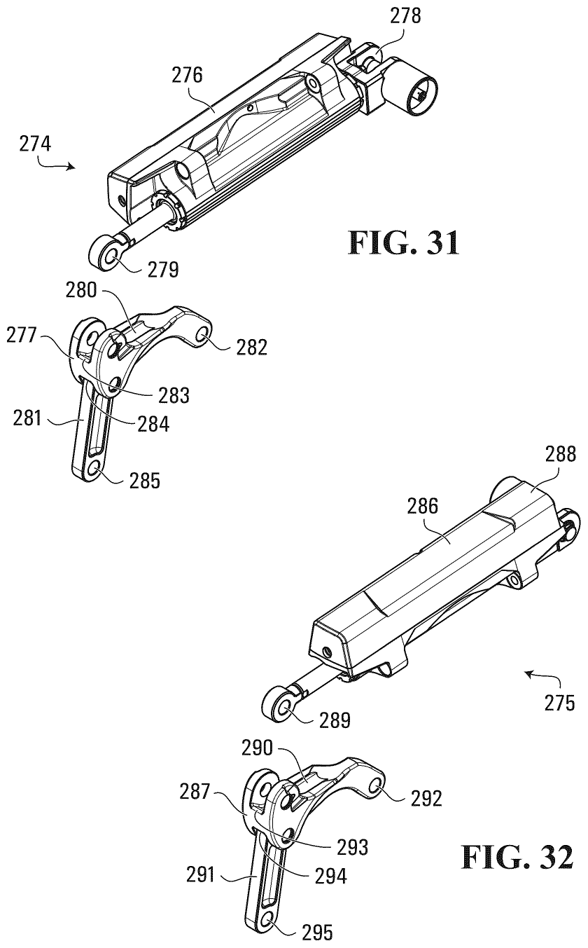

In some embodiments, such as embodiments of the roll-stabilizer apparatus 233 and/or embodiments of the roll-stabilizer apparatus 324, the precession-control devices, such as the precession-control devices 274, 275, and 327, may include one or more bearings, such as one or more roller bearings. For example, with reference FIG. 31, the precession-control device 274 of the roll-stabilizer 233 may include one or more bearings as part of the precession linkage 277.

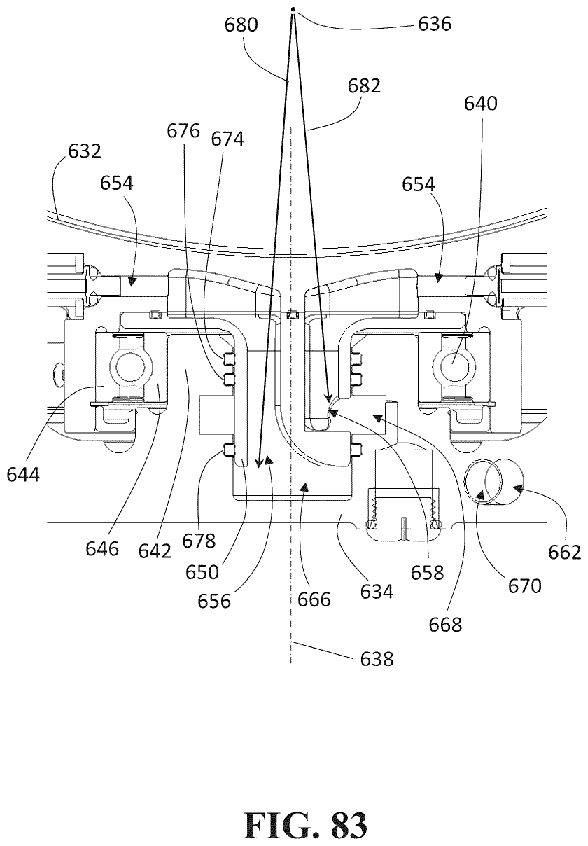

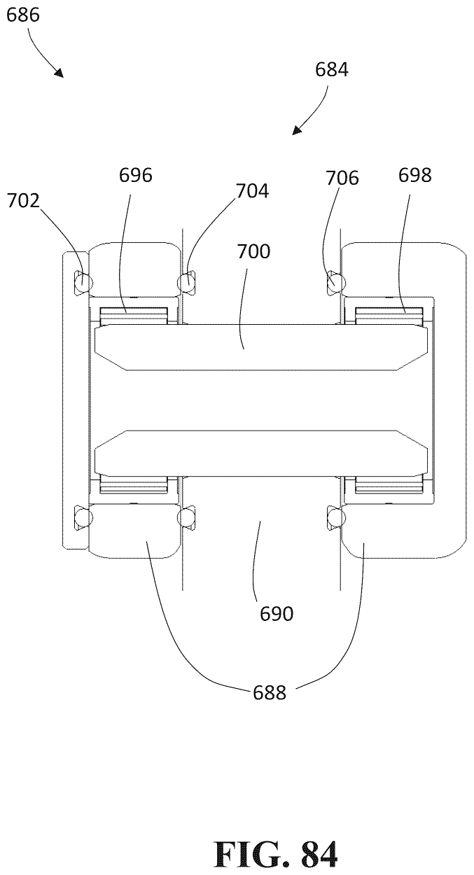

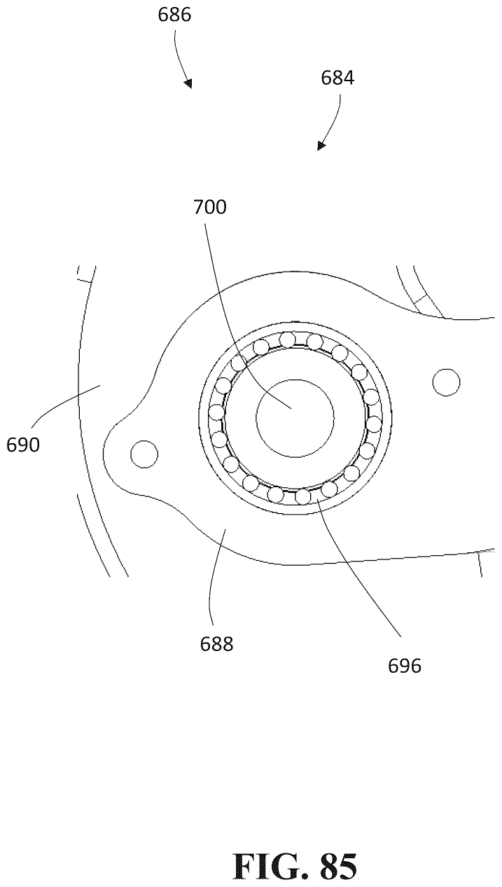

As a more specific example, FIGS. 83 and 84 show a precession linkage 684 of a precession-control device 686 according to another embodiment. The precession-control device 686 may be similar to the precession-control device 274 and may be used in place of the precession-control device 274 in the roll-stabilizer apparatus 233. The precession linkage 686 may be similar to the precession linkage 277 and may generally transfer forces at least between a mounting body and a flywheel-support body of a roll-stabilizer apparatus as described herein. The precession linkage 686 includes a first force-transfer body 688 similar to the first force-transfer body 280 and a second force transfer body 690 similar to the second force-transfer body 281. An actuator end 692 of the first force-transfer body 688 is rotatably attached to a force-transfer linkage end 694 of the second force transfer body 690, such that at least some of the force transferred by the precession linkage 684 between the mounting body and the flywheel-support body is transferred between the first force-transfer body 688 and the second force-transfer body 690.

The precession linkage 684 of the precession-control device 686 includes bearings 696 and 698 between the actuator end 692 of the first force-transfer body 688 and the force-transfer linkage end 694 of the second force-transfer body 690 (i.e., where the first force-transfer body 688 is rotatably attached to the second force-transfer body 692). The bearings 696 and 698 are supported in place by a pin 700. In general, the bearings 696 and 698 are operable to support the first force-transfer body 688 for rotation relative to the second force-transfer body 690. The bearings 696 and 698 may effectively preload the pin 700 in order to prevent or minimize any backlash (i.e., relative non-rotational movement between the pin 700 and one or both of the first and second force-transfer bodies 688 and 690) caused when the precession linkage 684 transfer forces, for example, between the mounting body and the flywheel-support body.

In the embodiment shown, the precession linkage 684 also includes seals 702, 704, and 706. The seals 702, 704, and 706 provide a fluid-tight seal between the first force-transfer body 688 and the second force-transfer body 690 around the bearings 696 and 698. The seals 702, 704, and 706 thus isolate the bearings 696 and 698 from an external operating environment, which may be, for example, a marine environment.

### Mounting Feet

In the embodiment shown in FIGS. 25 and 26, the base 260 of the mounting body 236 also includes mounting feet, such as mounting foot 339 and mounting foot 340 attached to the base structure 264. The mounting feet 339 and 340 are operable to mount the base 260, and thus the mounting body 236, to at least one hull of a vessel, such as the hull 101 of the marine vessel 100. In some embodiments, the mounting feet 339 and 340 may be interchangeable with other mounting feet to allow for different mounting configurations. For example, the mounting feet of some embodiments may allow for adjustable mounting or for mounting to non-flat surfaces.

The mounting feet 339 and 340 are examples only, and alternative embodiments may differ. For example, alternative embodiments may include openings, which may be threaded, to receive bolts or other structures that may mount the base 260, and thus the mounting body 236, to at least one hull of a vessel. Other embodiments may include clamps, connectable support bodies, or other structures that may be interchangeable and that may mount the base 260, and thus the mounting body 236, to at least one hull of a vessel.

As with the precession axis of rotation 119, the precession axis 269 in some embodiments may extend horizontally and perpendicular to the longitudinal axis 106, namely transversely relative to the hull 101. However, alternative embodiments may differ. For example, in some embodiments, the precession axis 269 may extend vertically or in another direction that is not parallel (and that may be perpendicular) to the longitudinal axis 106 of the marine vessel 100.

The mounting feet 339 and 340, or other structures such as those described above for example, may be positioned, orientated, or both such that the mounting body 236 is configured to be attached to at least one hull of a marine vessel such that the precession axis 269 extends transversely relative to the at least one hull. Other mounting bodies, such as the mounting bodies 114 and 326, may include similar mounting feet or other structures that as those described above to mount the mounting bodies to at least one hull of a vessel.

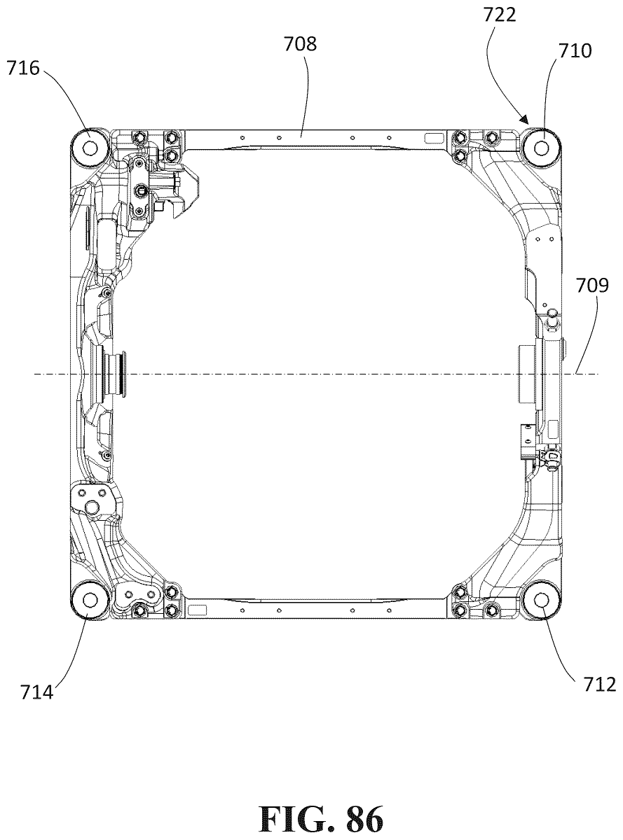

For example, FIGS. 86 to 90 show a mounting body 708 for a roll-stabilizer apparatus according to another embodiment. The mounting body 708 may generally be similar to the mounting body 236 and/or the mounting body 326 and may be used, for example, in place of the mounting body 236 in the roll-stabilizer apparatus 233 and/or the mounting body 326 in the roll-stabilizer apparatus 324. That is, in general, the mounting body 708 may support a flywheel-support body and permit rotation of the flywheel-support body relative to the mounting body 708 around a precession axis 709 of the mounting body 708.

The mounting body 708 includes mounting feet 710, 712, 714, and 716, which may generally function similarly to the mounting feet 339 and 340. That is, the mounting feet 710, 712, 714, and 716 are operable to mount the mounting body 708 to at least one hull of a vessel, such as the hull 101 of the marine vessel 100. Also, in the embodiment shown, each of the mounting feet 710, 712, 714, and 716 is removably attached to the mounting body 708.

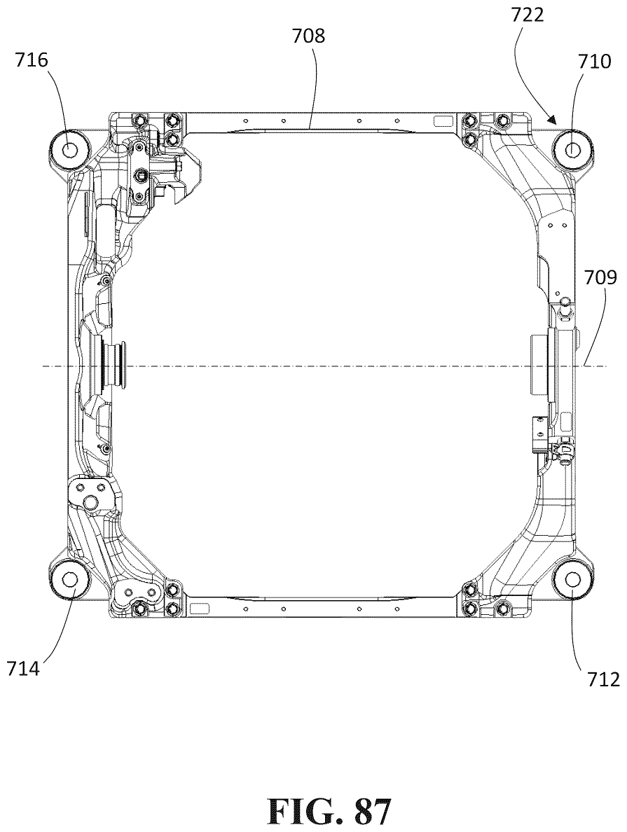

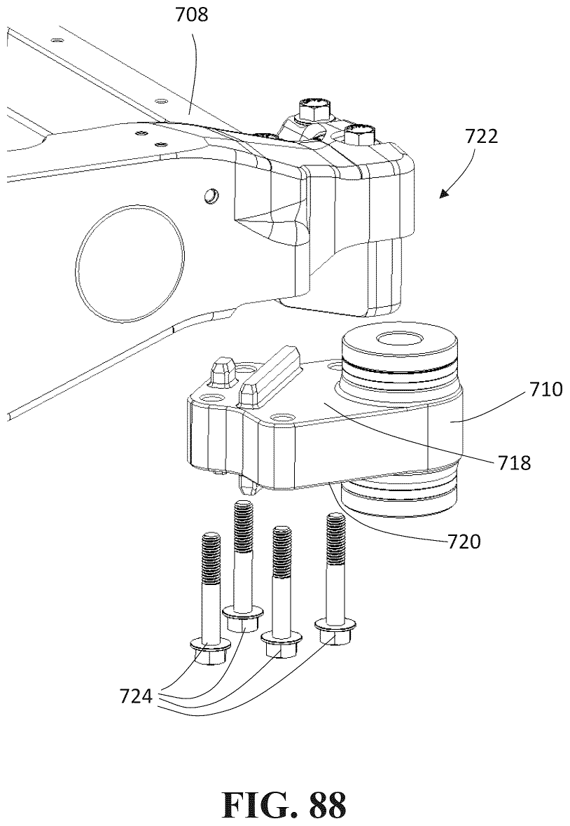

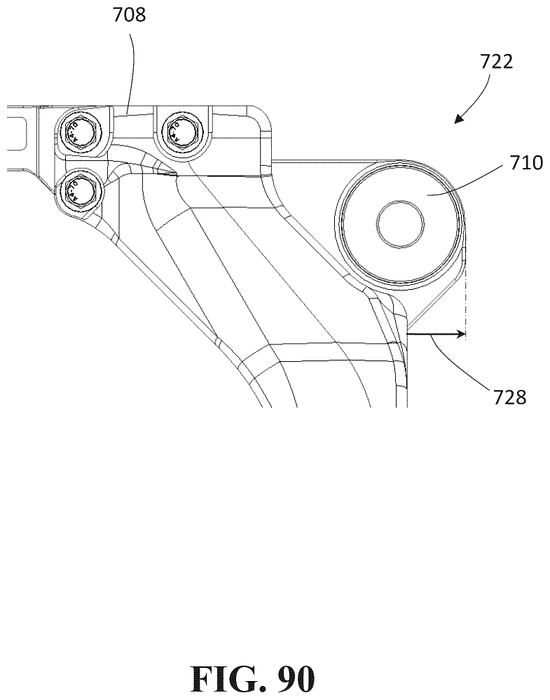

Considering as an example the mounting foot 710, as shown in greater detail in FIGS. 88 to 90, the mounting foot 710 is removably attached to the mounting body 708 at a mounting position shown generally at 722. In the embodiment shown, the mounting foot 710 includes a first side 718 and a second side 720 opposite the first side 718. In general, the mounting foot 710 is removably attachable to the mounting body 708 at the mounting position 722 in a first orientation relative to the mounting body 708, with the first side 718 of the mounting foot 710 facing the mounting body 708, as shown in FIGS. 86, 88, and 89. More specifically, when the mounting foot 710 is attached to the mounting body 708 at the mounting position 722 in the first orientation, at least a portion of the first side 718 of the mounting foot 710 is in contact with the mounting body 708. The mounting foot 710 is also removably attachable to the mounting body 708 at the mounting position 722 in a second orientation relative to the mounting body 708 which is different from the first orientation. As shown in FIGS. 87 and 90, in the second orientation, the mounting foot 710 is removably attachable to the mounting body 708 with the second side 720 of the mounting foot 710 facing the mounting body 708. More specifically, when the mounting foot 710 is attached to the mounting body 708 at the mounting position 722 in the second orientation, at least a portion of the second side 720 of the mounting foot 710 is in contact with the mounting body 708. Thus, the mounting foot 710 may be attached to the mounting body 708 at the mounting position 722 in either the first orientation or the second orientation.

The mounting foot 710 may be operable to mount the mounting body 708 to a hull of a vessel when attached to the mounting body 708 at the mounting position 722 in the first orientation, or when attached to the mounting body 708 at the mounting position 722 in the second orientation, or when attached to the mounting body 708 at the mounting position 722 in the first or second orientation. That is, for mounting to some vessels, the mounting foot 710 may need to be in the first orientation, while for mounting to other vessels, the mounting 710 may need to be in the second orientation, and for mounting to yet other vessels, the mounting 710 may be in either orientation.

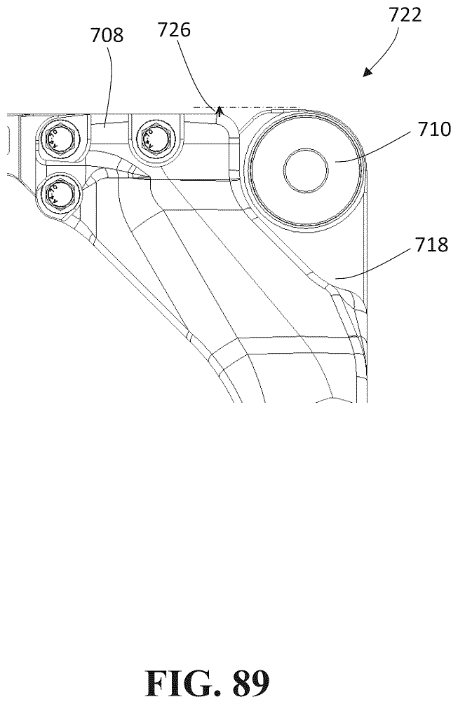

In the embodiment shown, when the mounting foot 710 is attached to the mounting body 708 at the mounting position 722 in the first orientation, the mounting foot 710 protrudes from the mounting body 708 a first distance 726. When the mounting foot 710 is attached to the mounting body 708 at the mounting position 722 in the second orientation, the mounting foot 710 protrudes from the mounting body 708 a second distance 728. As shown in particular in FIGS. 89 and 90, the second distance 728 is greater than the first distance 726. However, in alternative embodiments, a mounting foot may not necessarily protrude different distances when attached to the mounting body 708 in different orientations. For example, in some alternative embodiments, the mounting foot may protrude the same distance from the mounting body 708 when attached in different orientations, but may protrude in different directions. More generally, in some embodiments, a mounting foot may mount the mounting body 708 to a vessel at a first position on the vessel when attached to the mounting body 708 in a first orientation, and may mount the mounting body 708 to the vessel at a second position on the vessel when attached to the mounting body 708 in a second orientation different from the first orientation.

In the embodiment shown, the first side 718 of the mounting foot 710 is opposite the second side 720 of the mounting foot 710, such that, when the mounting foot 710 is in the first orientation, rotation of the mounting foot 710 by about 180° orients mounting foot 710 in the second orientation. That is, the mounting foot 710 is reversibly mountable to the mounting body 708. However, alternative embodiments may differ, and may include mounting feet which may be reoriented from one orientation to another by rotations other than 180°. Also, in some embodiments, a mounting foot may be removably attachable to its mounting position on the mounting body 708 in two orientations in which the same side of the mounting foot faces and is in contact with the mounting body 708.

In the embodiment shown, the mounting foot 710 is removably attachable to the mounting body 708 at the mounting position 722 with a plurality of fasteners 724. More specifically, the plurality of fasteners 724 include four bolts. However, alternative embodiments may differ. For example, in some alternative embodiments, a mounting foot may be removably attachable to the mounting body 708 using a different number of fasteners (e.g., two fasteners) and/or different type of fastener. In some alternative embodiments, a mounting foot may be removably attachable to the mounting body 708 without using any fasteners. Additionally, in some embodiments, one or more of the mounting feet 710, 712, 714, and 716 may include an integrated isolation damper configured to vibrationally isolate the mounting body 708 from a vessel to which it is mounted vessel when the mounting feet 710, 712, 714, and 716 mount the mounting body 708 to the vessel.

### Roll-Stabilizer Housing

In some embodiments, a roll-stabilizer apparatus such as those described herein may include an outer housing surrounding some or all of the roll-stabilizer apparatus. For example,

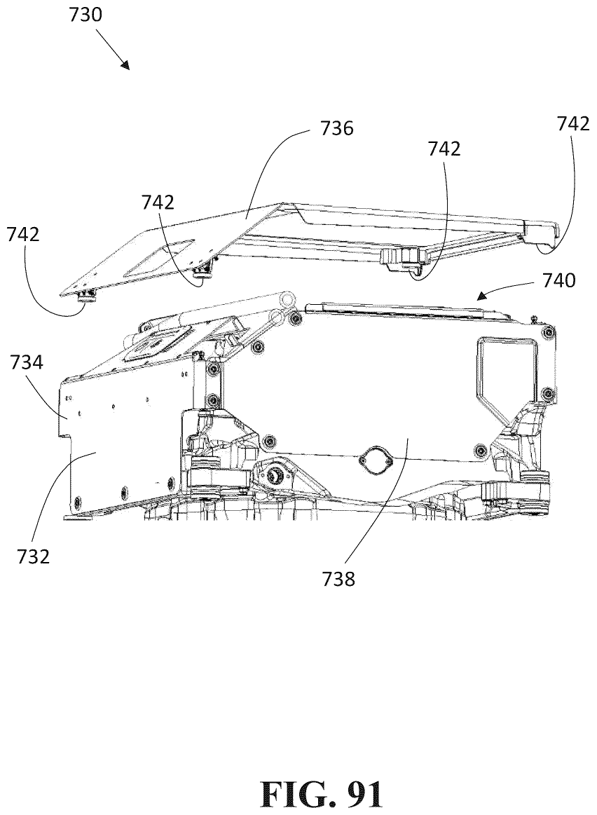

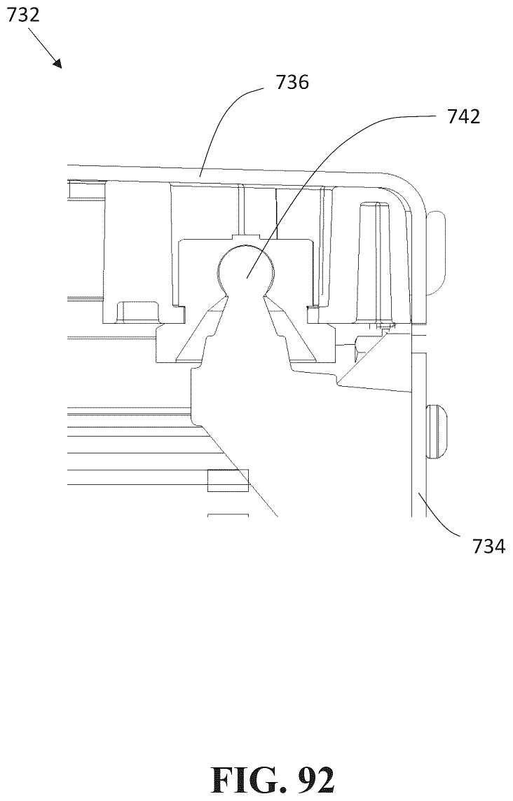

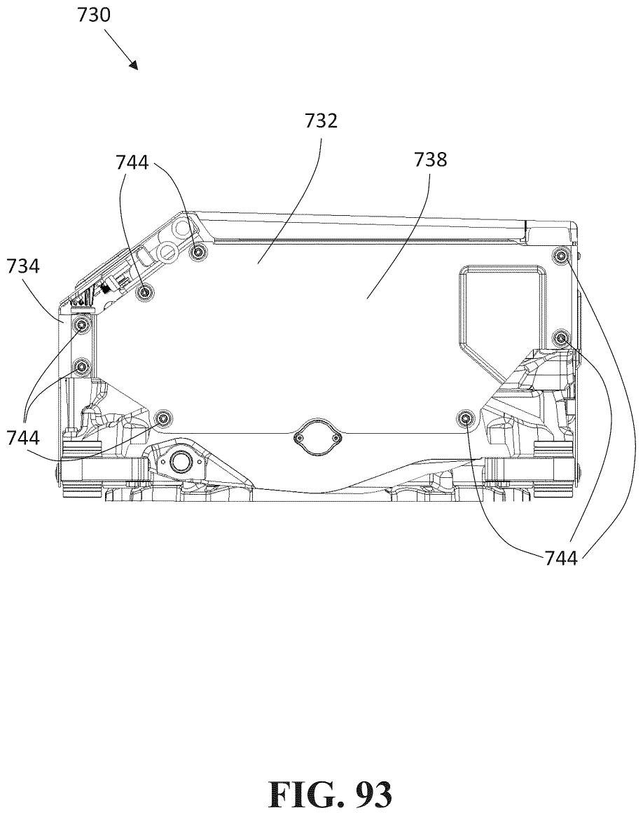

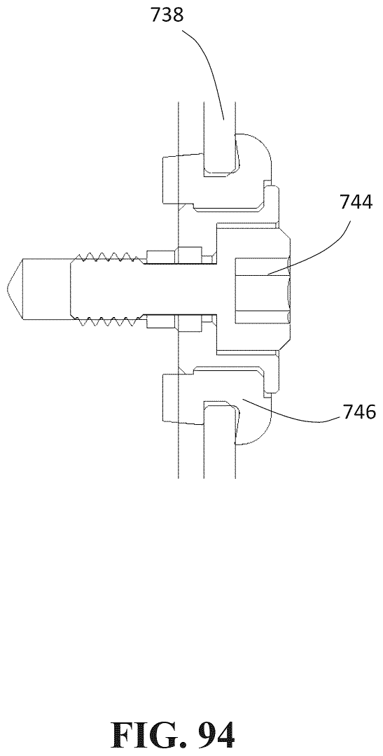

FIGS. 91 to 94 show a roll-stabilizer apparatus 730 which may be similar to and/or interchangeable with any one of the roll-stabilizer apparatuses 108, 233, 324, 374, 419, 434, and/or 444. The roll stabilizer apparatus 730 includes an outer housing 732 which surrounds at least a portion of a flywheel support body (not shown) of the roll stabilizer apparatus 730, while permitting rotation of the flywheel-support body relative to a mounting body (not shown) of the roll stabilizer apparatus 730 around a precession axis of the mounting body. In some embodiments, the outer housing 732 surrounds at least one third of the flywheel-support body. In some embodiments the outer housing 732 surrounds at least one half of the flywheel-support body.

The outer housing 732 of the embodiment shown includes a main shell portion 734 and removable portions 736 and 738. Each of the removable portions 736 and 738 may be, for example, an access panel and/or a cover. Each of the removable portions 736 and 738 is removably attachable to the main shell portion 734 over one or more access openings defined by the main shell portion. For example, the removable portion 736 is removably attachable to the main shell portion 734 over an access opening shown generally at 740.

The removable portion 736 is removably attached to the main shell portion 734 by tool-free mounts 742. In general, the tool-free mounts 742 permit tool-less attachment and removal of the removable portion 736 to and from the main shell portion 734. In the embodiment shown, the tool-free mounts 742 are ball-and-socket mounts. Also in the embodiment shown, each of the tool-free mounts 742 is configured to release the removable portion 736 from the main shell portion 734 at least when a separation force urges the removable portion 736 away from the main shell portion 734. In some embodiments, one or more of the tool-free mounts 742 may be or may include a vibration isolation mount configured to vibrationally isolate the removable portion 736 from the main shell portion 734.

The removable portion 738 is removably attached to the main shell portion 734 by captive fasteners 744. Each of the captive fasteners 744 is non-removably retained by the removable portion 738. In the embodiment shown, the removable portion 738 retains the captive fasteners while permitting rotation of the each of captive fasteners 744 relative to the removable portion 738. Also in the embodiment shown, the captive fasteners 744 include captive screws. Also in the embodiment shown, the removable portion 738 includes resilient bodies 746 retaining each of captive fasteners 744. More specifically, in the embodiment shown, the resilient body 746 are rubber isolators.

### Interchangeability of Embodiments

Elements of embodiments as described above may be interchangeably used in other embodiments described above. For example, the flywheel assembly 115, the stators 138 and 139, and the axial active magnetic bearing 140 of the roll-stabilizer apparatus 108 may be interchangeable with the flywheel body 235, the rotation-support body 250, and the bearings 252 and 253 of the roll-stabilizer apparatus 233. Similarly, the precession-control devices 274 and 275, and/or the precession bearings 267 and 268, of the roll-stabilizer apparatus 233 may be used to control and support rotation of the flywheel-support body 113 around the precession axis of rotation 119 in the roll-stabilizer apparatus 108. The mounting feet 339 and 340 of the mounting body 236 of the roll-stabilizer apparatus 233 may also be used to mount the mounting body 114 of the roll-stabilizer apparatus 108 to the hull 101.

### CONCLUSION

Roll-stabilization apparatuses such as those described herein, for example, may be for marine vessels and may be preferable to other roll-stabilization apparatuses. For example, other active magnetic bearings may not have sufficient strength or controllability, or may be too large, for practical applications in roll stabilization.

Although specific embodiments have been described and illustrated, such embodiments should be considered illustrative only and not as limiting the invention as construed according to the accompanying claims.

1. A flywheel apparatus comprising:
a flywheel body;
a flywheel-support body supporting the flywheel body and permitting rotation of the flywheel body relative to the flywheel-support body around at least one axis of rotation comprising a spin axis of rotation of the flywheel body and a central-rotation axis of the flywheel-support body;
at least one plurality of bearings operable to support the flywheel body for rotation relative to the flywheel-support body around the at least one axis of rotation; and
at least one resilient body configured to resiliently urge together, along the central-rotation axis of the flywheel-support body, individual bearings of the at least one plurality of bearings.

2. The apparatus of claim 1 wherein the individual bearings of the at least one plurality of bearings are axially adjacent to one another along the central-rotation axis of the flywheel-support body.

3. The apparatus of claim 1 wherein the at least one resilient body preloads at least one of the individual bearings of the at least one plurality of bearings.

4. The apparatus of claim 3 wherein the at least one resilient body preloads each of the individual bearings of the at least one plurality of bearings.

5. The apparatus of claim 1 wherein each of the individual bearings of the at least one plurality of bearings is a mechanical bearing comprising an inner race and an outer race operable to rotate relative to the inner race and relative to the flywheel-support body.

6. The apparatus of claim 5 wherein the at least one resilient body is configured to resiliently urge the inner race of at least one of the individual bearings of the at least one plurality of bearings towards another one of the individual bearings of the at least one plurality of bearings.

7. The apparatus of claim 5 further comprising at least one spacer between outer races of adjacent ones of the at least one plurality of bearings, the at least one spacer maintaining axial separation, along the central-rotation axis of the flywheel-support body, between the outer races of the adjacent ones of the at least one plurality of bearings.

8. The apparatus of claim 5 wherein an outer race of one or more of the at least one plurality of bearings is larger in an axial dimension along the central-rotation axis of the flywheel-support body than an inner race of the one or more of the at least one plurality of bearings.

9. (canceled)

10. The apparatus of claim 1 wherein each of the individual bearings of the at least one plurality of bearings is a mechanical bearing comprising an outer race and an inner race operable to rotate relative to the outer race and relative to the flywheel-support body.

11. The apparatus of claim 10 wherein the at least one resilient body is configured to resiliently urge the outer race of at least one of the individual bearings of the at least one plurality of bearings towards another one of the individual bearings of the at least one plurality of bearings.

12. The apparatus of claim 10 further comprising at least one spacer between inner races of adjacent ones of the at least one plurality of bearings, the at least one spacer maintaining axial separation, along the central-rotation axis of the flywheel-support body, between the inner races of the adjacent ones of the at least one plurality of bearings.

13. The apparatus of claim 10 wherein an inner race of one or more of the at least one plurality of bearings is larger in an axial dimension along the central-rotation axis of the flywheel-support body than an outer race of the one or more of the at least one plurality of bearings.

14. (canceled)

15. (canceled)

16. The apparatus of claim 1 wherein the at least one resilient body is axially adjacent to the at least one plurality of bearings along the central-rotation axis of the flywheel-support body.

17. The apparatus of claim 1 wherein the at least one resilient body comprises a first resilient body and a second resilient body, the first resilient body axially adjacent to the at least one plurality of bearings along the central-rotation axis of the flywheel-support body at a first axial end of the at least one plurality of bearings, and the second resilient body axially adjacent to the at least one plurality of bearings along the central-rotation axis of the flywheel-support body at a second axial end of the at least one plurality of bearings.

18. The apparatus of claim 1 wherein the at least one resilient body comprises at least one spring.

19. (canceled)

20. The apparatus of claim 1 wherein the at least one plurality of bearings comprises a pair of bearings.

21-110. (canceled)

111. A roll-stabilizer apparatus comprising:
a flywheel body;
a flywheel-support body supporting the flywheel body and permitting rotation of the flywheel body relative to the flywheel-support body around at least one axis of rotation comprising a spin axis of rotation of the flywheel body and a central-rotation axis of the flywheel-support body, the flywheel-support body defining at least one flywheel-support-body fluid channel comprising a first flywheel-support-body opening and a second flywheel-support-body opening, the at least one flywheel-support-body fluid channel operable to convey a fluid through at least some of the flywheel-support body between the first flywheel-support-body opening and the second flywheel-support-body opening; and
a mounting body supporting the flywheel-support body and permitting rotation of the flywheel-support body relative to the mounting body around a precession axis non-parallel to the at least one axis of rotation, the mounting body defining at least a first mounting-body fluid channel and a second mounting-body fluid channel, the first mounting-body fluid channel comprising a first mounting-body opening and a second mounting-body opening and operable to convey the fluid through at least some of the mounting body between the first mounting-body opening and the second mounting-body opening, the second mounting-body fluid channel comprising a third mounting-body opening and a fourth mounting-body opening and operable to convey the fluid through at least some of the mounting body between the third mounting-body opening and the fourth mounting-body opening;
wherein the second mounting-body opening is in fluid communication with the first flywheel-support-body opening, and wherein the second flywheel-support-body opening is in fluid communication with the third mounting-body opening.

112. The apparatus of claim 110 further comprising at least one precession bearing operable to support the flywheel-support body for rotation relative to the mounting body around the precession axis, the at least one precession bearing comprising an outer precession body surrounding an inner precession body, the outer precession body rotatable relative to the inner precession body and relative to the mounting body, wherein the flywheel-support body comprises a protruding portion defining the first flywheel-support-body opening and the second flywheel-support-body opening, and wherein at least a portion of the protruding portion is surrounded by the inner precession body of the at least one precession bearing.

113. (canceled)

114. (canceled)

115. The apparatus of claim 110 wherein the first flywheel-support-body opening is a first radial distance from the central-rotation axis of the flywheel-support body and the second flywheel-support-body opening is a second radial distance from the central-rotation axis of the flywheel-support body, the first radial distance different from the second radial distance.

116. The apparatus of claim 110 wherein the second mounting-body opening is a first distance from the central-rotation axis of the flywheel-support body and the third mounting-body opening is a second distance from the central-rotation axis of the flywheel-support body, first distance different from the second distance.

117-346. (canceled)
